(19) United States
(12) Patent Application Publication
(10) Pub. No.: US 2025/0266964 A1
(43) Pub. Date: Aug. 21, 2025

(54) METHOD AND DEVICE FOR TRANSMITTING CHANNEL STATE INFORMATION OF TERMINAL IN WIRELESS COMMUNICATION SYSTEM

(71) Applicant: SAMSUNG ELECTRONICS CO., LTD., Suwon-si (KR)

(72) Inventors: Youngrok JANG, Suwon-si (KR); Younsun KIM, Suwon-si (KR); Sungjin PARK, Suwon-si (KR); Seongmok LIM, Suwon-si (KR); Hyoungju JI, Suwon-si (KR); Kyungjun CHOI, Suwon-si (KR)

(21) Appl. No.: 19/054,512

(22) Filed: Feb. 14, 2025

(30) Foreign Application Priority Data
Feb. 15, 2024 (KR) 10-2024-0022078

(51) Int. Cl. H04L 5/00; H04W 72/21; H04W 72/23

(52) U.S. Cl. CPC H04L 5/0053; H04W 72/21; H04W 72/23

(57) ABSTRACT

The disclosure relates to a 5G or 6G communication system for supporting higher data transmission rates. The disclosure relates to operations of a terminal and a base station in a wireless communication system, and more specifically, the disclosure relates to a method of transmitting and receiving channel state information between a terminal and a base station in a wireless communication system and a device capable of performing the same. The disclosure provides a device and method capable of effectively providing a service in a mobile communication system.

### CROSS-REFERENCE TO RELATED APPLICATION

This application is based on and claims priority under 35 U.S.C. § 119 to Korean Patent Application No. 10-2024-0022078, filed on Feb. 15, 2024, in the Korean Intellectual Property Office, the disclosures of which are herein incorporated by reference in their entireties.

### BACKGROUND

### 1. Field

The disclosure relates to operations of a terminal and a base station in a wireless communication system. Specifically, the disclosure relates to a method of transmitting channel state information of a terminal in a wireless communication system and a device capable of performing the same.

### 2. Description of Related Art

5^{th} generation (5G) mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The disclosed embodiment provides a device and method capable of effectively providing a service in a mobile communication system.

In accordance with an aspect of the disclosure, a method performed by a user equipment (UE) in a communication system is provided. The method comprises transmitting, to a base station, a first uplink (UL) channel to request a resource for a second UL channel to carry beam report, receiving, from the base station, downlink control information (DCI) indicating a resource for the second UL channel, and transmitting, to the base station, the second UL channel including the beam report.

In accordance with another aspect of the disclosure, a method performed by a base station in a communication system is provided. The method comprises receiving, from a user equipment (UE), a first uplink (UL) channel to request a resource for a second UL channel to carry beam report, transmitting, to the UE, downlink control information (DCI) indicating a resource for the second UL channel, and receiving, from the UE, the second UL channel including the beam report.

In accordance with another aspect of the disclosure, a user equipment (UE) in a communication system is provided. The UE comprises a transceiver, and a controller configured to transmit, to a base station, a first uplink (UL) channel to request a resource for a second UL channel to carry beam report, receive, from the base station, downlink control information (DCI) indicating a resource for the second UL channel, and transmit, to the base station, the second UL channel including the beam report.

In accordance with another aspect of the disclosure, a base station in a communication system is provided. The base station comprises a transceiver, and a controller configured to receive, from a user equipment (UE), a first uplink (UL) channel to request a resource for a second UL channel to carry beam report, transmit, to the UE, downlink control information (DCI) indicating a resource for the second UL channel, and receive, from the UE, the second UL channel including the beam report.

The disclosed embodiment provides a device and method capable of effectively providing a service in a mobile communication system.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts.

In the drawings, the same or similar reference numerals may be used for the same or similar components.

FIG. 1 illustrates a basic structure of a time-frequency domain in a wireless communication system according to an embodiment of the disclosure.

FIG. 2 illustrates a frame, subframe, and slot structure in a wireless communication system according to an embodiment of the disclosure.

FIG. 3 illustrates an example of a bandwidth part configuration in a wireless communication system according to an embodiment of the disclosure.

FIG. 4 illustrates a wireless protocol structure of a base station and a terminal in a single cell, carrier aggregation, and dual connectivity situation in a wireless communication system according to an embodiment of the disclosure.

FIG. 5 illustrates a beam application time that may be considered in the case of using a unified TCI scheme in a wireless communication system according to an embodiment of the disclosure.

FIG. 6 illustrates another MAC-CE structure for activating and indicating a joint TCI state or a separate DL or UL TCI state in a wireless communication system according to an embodiment of the disclosure.

FIG. 7 illustrates an example of an aperiodic CSI reporting method according to an embodiment of the disclosure.

FIG. 8 illustrates an example of a control area configuration of a downlink control channel in a wireless communication system according to an embodiment of the disclosure.

FIG. 9 illustrates a structure of a downlink control channel in a wireless communication system according to an embodiment of the disclosure.

FIG. 10 illustrates a channel measurement and channel state reporting method according to a configuration and instruction of a base station according to an embodiment of the disclosure.

FIG. 11 illustrates an operation process of a terminal and a base station for a CSI report initiated by a terminal using one or more PUCCH resources according to an embodiment of the disclosure.

FIG. 12 illustrates an operation process of a terminal and a base station for a CSI report initiated by a terminal using a PUCCH resource that triggers a CSI report according to an embodiment of the disclosure.

FIG. 13 illustrates an operation process of a terminal and a base station for a CSI report initiated by a terminal using a PUCCH resource based on a scheduling request according to an embodiment of the disclosure.

FIG. 14 illustrates an operation process of a terminal and a base station for a CSI report initiated by a terminal using a pair of reserved PUCCH resource and PUSCH transmission according to an embodiment of the disclosure.

FIG. 15 illustrates an operation process of a terminal and a base station for a CSI report initiated by a terminal using a reserved PUCCH resource or reserved PUSCH transmission according to an embodiment of the disclosure.

FIG. 16 illustrates a structure of a terminal in a wireless communication system according to an embodiment of the disclosure.

FIG. 17 illustrates a structure of a base station in a wireless communication system according to an embodiment of the disclosure.

### DETAILED DESCRIPTION

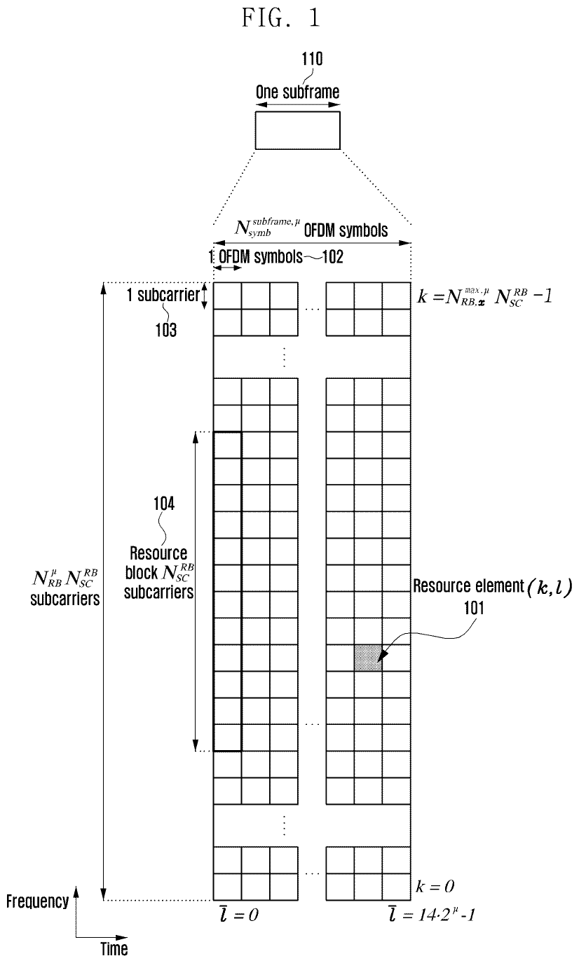

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing embodiments, descriptions of technical contents that are well known in the technical field to which the disclosure pertains and that are not directly related to the disclosure will be omitted. This is to more clearly convey the gist of the disclosure without obscuring the gist of the disclosure by omitting unnecessary description.

For the same reason, some components are exaggerated, omitted, or schematically illustrated in the accompanying drawings. Further, the size of each component does not fully reflect the actual size. In each drawing, the same reference numerals are given to the same or corresponding components.

Advantages and features of the disclosure, and a method of achieving them will become apparent with reference to the embodiments described below in detail in conjunction with the accompanying drawings. However, the disclosure is not limited to the embodiments disclosed below, but may be implemented in various different forms, and only embodiments of the disclosure enable the disclosure to be complete, and are provided to fully inform the scope of the disclosure to those of ordinary skill in the art to which the disclosure belongs, and the disclosure is only defined by the scope of the claims. Like reference numerals refer to like components throughout the specification. Further, in describing the disclosure, in the case that it is determined that a detailed description of a related function or constitution may unnecessarily obscure the gist of the disclosure, a detailed description thereof will be omitted. Terms described below are terms defined in consideration of functions in the disclosure, which may vary according to intentions or customs of users and operators. Therefore, the definition should be made based on the content throughout this specification.

Hereinafter, a base station is a subject performing resource allocation of a terminal, and may be at least one of a gNode B, an eNode B, a node B, a base station (BS), a radio access unit, a base station controller, or a node on a network. The terminal may include a user equipment (UE), a mobile station (MS), a cellular phone, a smart phone, a computer, or a multimedia system capable of performing a communication function. In the disclosure, a downlink (DL) is a wireless transmission path of a signal transmitted from a base station to a terminal, and an uplink (UL) is a wireless transmission path of a signal transmitted from a terminal to a base station. Hereinafter, although LTE or LTE-A system may be described as an example, embodiments of the disclosure may be applied to other communication systems having a similar technical background or channel type. For example, 5G mobile communication technology (5G, new radio (NR)) developed after LTE-A may be included therein, and the following 5G may be a concept including existing LTE, LTE-A and other similar services. Further, the disclosure may be applied to other communication systems through some modifications within a range that does not significantly deviate from the scope of the disclosure by the determination of a person having skilled technical knowledge.

In this case, it will be understood that each block of flowcharts and combinations of the flowcharts may be performed by computer program instructions. Because these computer program instructions may be mounted in a processor of a general purpose computer, a special purpose computer, or other programmable data processing equipment, instructions performed by a processor of a computer or other programmable data processing equipment generate a means that performs functions described in the flowchart block(s). Because these computer program instructions may be stored in a computer usable or computer readable memory that may direct a computer or other programmable data processing equipment in order to implement a function in a particular manner, the instructions stored in the computer usable or computer readable memory may produce a production article containing instruction means for performing the function described in the flowchart block(s). Because the computer program instructions may be mounted on a computer or other programmable data processing equipment, a series of operation steps are performed on the computer or other programmable data processing equipment to generate a computer-executed process; thus, instructions for performing the computer or other programmable data processing equipment may provide steps for performing functions described in the flowchart block(s).

Further, each block may represent a portion of a module, a segment, or a code including one or more executable instructions for executing a specified logical function(s). Further, it should be noted that in some alternative implementations, functions recited in the blocks may occur out of order. For example, two blocks illustrated one after another may in fact be performed substantially simultaneously, or the blocks may be sometimes performed in the reverse order according to the corresponding function.

In this case, a term “-unit” used in this embodiment means software or hardware components such as a field programmable gate array (FPGA) or an application specific integrated circuit (ASIC), and “-unit” performs certain roles. However, “-unit” is not limited to software or hardware. “-unit” may be constituted to reside in an addressable storage medium or may be constituted to reproduce one or more processors. Therefore, as an example, “-unit” includes components such as software components, object-oriented software components, class components, and task components, processes, functions, properties, procedures, subroutines, segments of program code, drivers, firmware, microcode, circuit, data, databases, data structures, tables, arrays, and variables. Functions provided in the components and “-units” may be combined into a smaller number of components and “-units” or may be further separated into additional components and “-units.” Further, components and “-units” may be implemented to reproduce one or more CPUs in a device or secure multimedia card. Further, in an embodiment, “-unit” may include one or more processors.

A wireless communication system is evolving from providing voice-oriented services in the early days to a broadband wireless communication system that provides high-speed and high-quality packet data services as in communication standards such as high speed packet access (HSPA), long term evolution (LTE) or evolved universal terrestrial radio access (E-UTRA), LTE-Advanced (LTE-A), and LTE-Pro of 3GPP, high rate packet data (HRPD) and ultra mobile broadband (UMB) of 3GPP2, and IEEE 802.16e.

An LTE system, which is a representative example of the broadband wireless communication system, employs an orthogonal frequency division multiplexing (OFDM) scheme in a downlink (DL) and a single carrier frequency division multiple access (SC-FDMA) scheme in an uplink. The uplink means a radio link in which a user equipment (UE) or a mobile station (MS) transmits data or control signals to an eNode B (eNB) or a base station (BS), and the downlink means a radio link in which a base station transmits data or control signals to a terminal. The above-described multiple access method enables data or control information of each user to distinguish by allocating and operating data or control information so that time-frequency resources to carry data or control information for each user in general do not overlap each other, that is, so that orthogonality is established.

A 5G communication system, which is a future communication system after LTE, should support services that simultaneously satisfy various requirements so that various requirements of users and service providers may be freely reflected. Services considered for the 5G communication system include enhanced mobile broadband (eMBB), massive machine type communication (mMTC), ultra reliability low latency communication (URLLC), and the like.

The eMBB aims to provide a more improved data rate than a data rate supported by existing LTE, LTE-A, or LTE-Pro. For example, in the 5G communication system, the eMBB should be able to provide a peak data rate of 20 Gbps in a downlink and a peak data rate of 10 Gbps in an uplink from the viewpoint of one base station. Further, the 5G communication system should provide an increased user perceived data rate of a terminal while providing a peak data rate. In order to satisfy such requirements, it is required to improve various transmission and reception technologies, including more advanced multi input and multi output (MIMO) transmission technology. Further, the LTE system transmits a signal using a transmission bandwidth of maximum 20 MHz in the 2 GHz band, whereas the 5G communication system may satisfy a data rate required by the same by using a frequency bandwidth wider than 20 MHz in a frequency band of 3 to 6 GHz or 6 GHz or more.

At the same time, in the 5G communication system, mMTC is being considered to support application services such as Internet of Thing (IoT). In order to efficiently provide IoT, mMTC requires access support for large-scale terminals within a cell, improvement of coverage of terminals, an improved battery time, and cost reduction of terminals. Because the IoT is attached to various sensors and various devices to provide communication functions, it should be able to support a large number of terminals (e.g., 1,000,000 terminals/km2) within a cell. Further, because a terminal supporting mMTC is likely to be located in a shaded area that a cell cannot cover, such as the basement of a building, due to the nature of the service, the terminal may require wider coverage compared to other services provided by the 5G communication system. The terminal supporting mMTC should be composed of a low cost terminal, and because it is difficult to frequently exchange a battery of the terminal, a very long battery lifetime such as 10 to 15 years may be required.

Finally, URLLC is a cellular-based wireless communication service used for mission-critical. For example, a service used for remote control of a robot or machinery, industrial automation, unmanned aerial vehicle, remote health care, emergency alert, and the like may be considered. Therefore, communication provided by URLLC should provide very low latency and very high reliability. For example, a service supporting URLLC should satisfy air interface latency smaller than 0.5 milliseconds and simultaneously has the requirement of a packet error rate of 10-5 or less. Therefore, for a service supporting URLLC, the 5G system may require design requirements that should provide a transmit time interval (TTI) smaller than that of other services and that should simultaneously allocate a wide resource in a frequency band in order to secure reliability of a communication link.

Three services, i.e., eMBB, URLLC, and mMTC of 5G may be multiplexed and transmitted in a single system. In this case, in order to satisfy different requirements of each service, different transmission and reception techniques and transmission and reception parameters may be used between services. 5G is not limited to the above-described three services.

Hereinafter, a/b may be understood as at least one of a or b.

### [NR Time-Frequency Resource]

Hereinafter, a frame structure of a 5G system will be described in more detail with reference to the drawings.

FIG. 1 illustrates a basic structure of a time-frequency domain, which is a radio resource domain in which a data or control channel is transmitted in a 5G system, according to an embodiment of the present disclosure.

A horizontal axis of FIG. 1 represents a time domain, and a vertical axis of FIG. 1 represents a frequency domain. A basic unit of resources in the time and frequency domains is a resource element (RE) 101 and may be defined to 1 orthogonal frequency division multiplexing (OFDM) symbol 102 in the time axis and 1 subcarrier 103 in the frequency axis. In the frequency domain, the N_{SC}^{RB} (e.g., 12) number of consecutive REs may constitute one resource block (RB) 104. In the time axis, one subframe 110 may include a plurality of OFDM symbols 102. For example, a length of one subframe may be 1 ms.

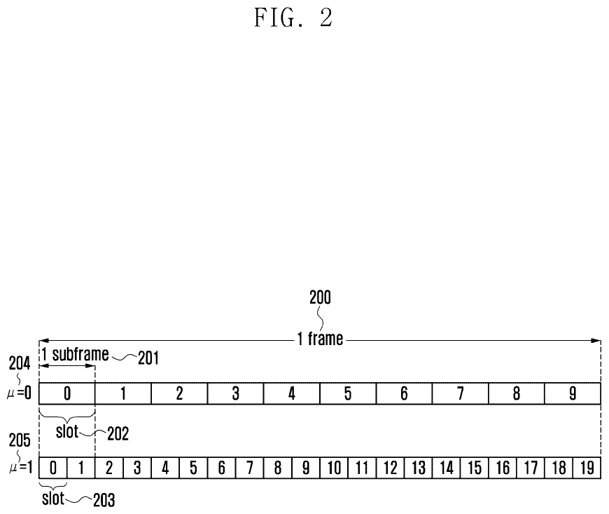

FIG. 2 illustrates a frame, subframe, and slot structure in a wireless communication system according to an embodiment of the disclosure.

FIG. 2 illustrates an example of a structure of a frame 200, a subframe 201, and a slot 202. 1 frame 200 may be defined to 10 ms. 1 subframe 201 may be defined to 1 ms; thus, 1 frame 200 may be composed of total 10 subframes 201. 1 slots 202 and 203 may be defined to 14 OFDM symbols (i.e., the number N_{symb}^{slot} of symbols per slot is 14). 1 subframe 201 may be composed of one or a plurality of slots 202 and 203, and the number of slots 202 and 203 per subframe 201 may vary according to configuration values μ 204 and 205 for subcarrier spacing. In an example of FIG. 2, the case that μ=0, 204 and the case that μ=1, 205 are illustrated as the subcarrier spacing configuration value. In the case that μ=0, 204, 1 subframe 201 may be composed of 1 slot 202, and in the case that μ=1, 205, 1 subframe 201 may be composed of 2 slots 203. That is, the number Nₛₗₒₜ^{subframe,μ} of slots per subframe may vary according to the configuration value μ for the subcarrier spacing; thus, the number Nₛₗₒₜ^{frame,μ} slot of slots per frame may vary. Nₛₗₒₜ^{subframe,μ} and Nₛₗₒₜ^{frame,μ} slot according to each subcarrier spacing configuration μ may be defined in Table 1.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Hereinafter, a bandwidth part (BWP) configuration in a 5G communication system will be described in detail with reference to the drawings.

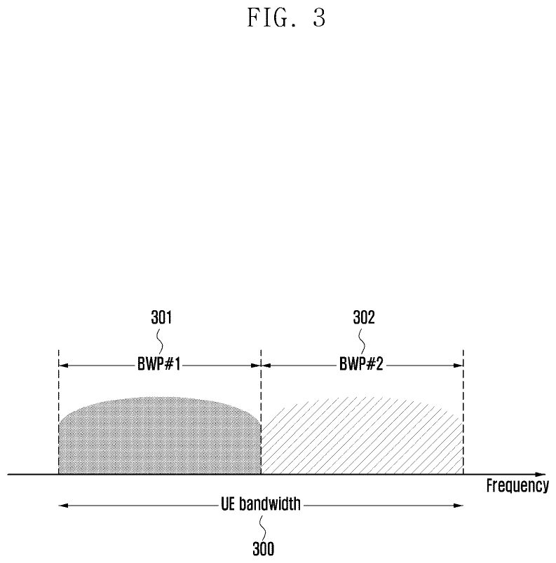

FIG. 3 illustrates an example of a bandwidth part configuration in a wireless communication system according to an embodiment of the disclosure.

FIG. 3 illustrates an example in which a UE bandwidth 300 is configured to two bandwidth parts (BWPs), that is, a BWP #1, 301 and a BWP #2, 302. The base station may configure one or a plurality of bandwidth parts to the UE and configure information of Table 2 for each bandwidth part.

TABLE 2

| | |
|---|---|
| BWP ::= | SEQUENCE { |
| bwp-Id | BWP-Id, |

(bandwidth part identifier)

| | |
|---|---|
| locationAndBandwidth | INTEGER (1..65536), |

(bandwidth part location)

| | |
|---|---|
| subcarrierSpacing | ENUMERATED {n0, n1, n2, n3, n4, n5}, |

(subcarrier spacing)

| | |
|---|---|
| cyclicPrefix | ENUMERATED { extended } |

(cyclic prefix)
}

The disclosure is not limited to the above example, and various parameters related to the bandwidth part in addition to the configuration information may be configured to the UE. The information may be transmitted by the base station to the UE through higher layer signaling, for example, RRC signaling. At least one bandwidth part among one or a plurality of configured bandwidth parts may be activated. Whether the configured bandwidth part is activated may be semi-statically transmitted from the base station to the UE through RRC signaling or may be dynamically transmitted from the base station to the UE through downlink control information (DCI).

According to some embodiments, the UE before RRC connection may receive a configuration of an initial BWP for initial access from the base station through a master information block (MIB). More specifically, in an initial access step, the UE may receive configuration information on a search space and a control resource set (CORESET) in which a PDCCH for receiving system information (may correspond to remaining system information (RMSI) or system information block 1 (SIB1)) necessary for initial access may be transmitted through the MIB. The CORESET and search space configured by the MIB may be regarded as an identity (ID) 0, respectively. The base station may notify the UE of configuration information such as frequency allocation information, time allocation information, and numerology for the CORESET #0 through the MIB. Further, the base station may notify the UE of configuration information on a monitoring period and monitoring occasion for the CORESET #0, that is, configuration information on a search space #0 through the MIB. The UE may regard a frequency domain configured to the CORESET #0 acquired from the MIB as an initial bandwidth part for initial access. In this case, an identifier (ID) of the initial bandwidth part may be regarded as 0.

A configuration for the bandwidth part supported in the 5G may be used for various purposes.

According to some embodiments, in the case that a bandwidth supported by the UE is smaller than the system bandwidth, this may be supported through the bandwidth part configuration. For example, as the base station configures a frequency location (configuration information 2) of the bandwidth part to the UE, the UE may transmit and receive data at a specific frequency location within the system bandwidth.

Further, according to some embodiments, for the purpose of supporting different numerologies, the base station may configure a plurality of bandwidth parts to the UE. For example, in order to support both data transmission and reception using subcarrier spacing of 15 kHz and subcarrier spacing of 30 kHz to a certain UE, the base station may configure two bandwidth parts to subcarrier spacings of 15 kHz and 30 kHz, respectively. Different bandwidth parts may be frequency division multiplexed, and in the case that data is to be transmitted and received at specific subcarrier spacing, a bandwidth part configured at corresponding subcarrier spacing may be activated.

Further, according to some embodiments, for the purpose of reducing power consumption of the UE, the base station may configure bandwidth parts having different sizes of bandwidth to the UE. For example, in the case that the UE supports a very large bandwidth, for example, a bandwidth of 100 MHz and always transmits and receives data with the corresponding bandwidth, very large power consumption may occur. In particular, monitoring an unnecessary downlink control channel with a large bandwidth of 100 MHz in a situation in which there is no traffic may be very inefficient in terms of power consumption. For the purpose of reducing power consumption of the UE, the base station may configure a bandwidth part of a relatively small bandwidth, for example, a bandwidth part of 20 MHz to the UE. In a situation in which there is no traffic, the UE may perform a monitoring operation in the bandwidth part of 20 MHz, and in the case that data is generated, the UE may transmit and receive data with the bandwidth part of 100 MHz according to the instruction of the base station.

In a method of configuring the bandwidth part, UEs before RRC connection may receive configuration information on the initial bandwidth part through an MIB in an initial access step. More specifically, the UE may receive a configuration of a control resource set (CORESET) for a downlink control channel in which DCI scheduling a system information block (SIB) may be transmitted from the MIB of a physical broadcast channel (PBCH). A bandwidth of the CORESET configured by the MIB may be regarded as an initial bandwidth part, and the UE may receive a physical downlink shared channel (PDSCH) in which the SIB is transmitted through the configured initial bandwidth part. The initial bandwidth part may be used for other system information (OSI), paging, and random access in addition to the use of receiving the SIB.

### [Bandwidth Part (BWP) Change]

In the case that one or more bandwidth parts are configured to the UE, the base station may instruct the UE to change (or switch, transition) the bandwidth part using a BWP indicator field in DCI. For example, in FIG. 3, in the case that the currently activated BWP of the UE is a BWP #1, 301, the base station may indicate a BWP #2, 302 with a BWP indicator in the DCI to the UE, and the UE may perform the BWP change with the BWP #2, 302 indicated by the BWP indicator in the received DCI.

As described above, because the DCI-based bandwidth part change may be indicated by DCI scheduling the PDSCH or PUSCH, in the case that the UE receives a bandwidth part change request, the UE may be able to receive or transmit the PDSCH or PUSCH scheduled by the corresponding DCI in the changed bandwidth part without difficulty. To this end, the standard stipulates the requirements for a delay time TBWP required when changing the bandwidth part, and may be defined, for example, as in Table 3.

TABLE 3

BWP switch delay T_{BWP} (slots)

| μ | NR Slot length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}
Depends on UE capability.
Note 2:
If the BWP switch involves changing of SCS, the BWP switch delay is determined by the larger one between the SCS before BWP switch and the SCS after BWP switch.

The requirement for a bandwidth part change delay time supports a type 1 or type 2 according to a capability of the UE. The UE may report a supportable bandwidth part delay time type to the base station.

According to the requirement for the bandwidth part change delay time, in the case that the UE receives DCI including a bandwidth part change indicator in a slot n, the UE may complete the change to a new bandwidth part indicated by the bandwidth part change indicator at a time point not later than a slot n+TBWP and perform transmission and reception for a data channel scheduled by the corresponding DCI in the changed new bandwidth part. In the case that the base station wants to schedule a data channel with a new bandwidth part, the base station may determine time domain resource assignment for the data channel in consideration of the bandwidth part change delay time TBWP of the UE. That is, when scheduling a data channel with a new bandwidth part, in a method of determining time domain resource assignment for the data channel, the base station may schedule the corresponding data channel after the bandwidth part change delay time. Accordingly, the UE may not expect that DCI indicating the bandwidth part change indicates a slot offset value (K0 or K2) smaller than the bandwidth part change delay time TBWP.

When the UE receives DCI (e.g., DCI format 1_1 or 0_1) indicating a change in bandwidth part, the UE may not perform any transmission or reception during a corresponding time duration from a third symbol of a slot that receives a PDCCH including the corresponding DCI to a start point of a slot indicated by a slot offset value (K0 or K2) indicated by a time domain resource assignment indicator field in the corresponding DCI. For example, when the UE received DCI indicating a bandwidth part change in a slot n, and a slot offset value indicated by the corresponding DCI is K, the UE may not perform any transmission or reception from a third symbol of the slot n to the previous symbol of a slot n+K (i.e., a last symbol of a slot n+K−1).

### [Related to CA/DC]

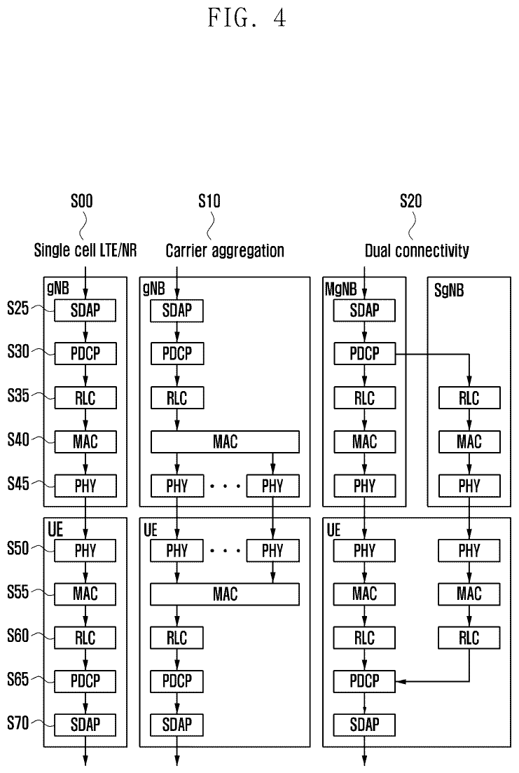

FIG. 4 illustrates a radio protocol structure of a base station and a UE in a single cell, carrier aggregation, and dual connectivity situation according to an embodiment of the disclosure.

With reference to FIG. 4, radio protocols of a next generation mobile communication system include NR service data adaptation protocols (SDAPs) S25 and S70, NR packet data convergence protocols (PDCPs) S30 and S65, NR radio link controls (RLCs) S35 and S60, and NR medium access controls (MACs) S40 and S55 in the UE and the NR base station, respectively.

Main functions of the NR SDAPs S25 and S70 may include some of the following functions:
Transfer of user plane data;
Mapping between a QoS flow and a DRB for both DL and UL;
Marking QoS flow ID in both DL and UL packets; and/or
Reflective QoS flow to DRB mapping for the UL SDAP PDUs.

For the SDAP layer device, the UE may receive a configuration on whether to use a header of the SDAP layer device or whether to use a function of the SDAP layer device for each PDCP layer device, each bearer, or each logical channel with a radio resource control (RRC) message, and in the case that the SDAP header is configured, the UE may instruct non-access stratum (NAS) reflective quality of service (QOS) and access stratum (AS) reflective QoS of the SDAP header to update or reconfigure mapping information on uplink and downlink QoS flows and data bearers. The SDAP header may include QoS flow ID information indicating a QoS. The QoS information may be used as a data processing priority and scheduling information for supporting a smooth service.

Main functions of the NR PDCPs S30 and S65 may include some of the following functions:
Header compression and decompression: ROHC only;
Transfer of user data;
In-sequence delivery of upper layer PDUs;
Out-of-sequence delivery of upper layer PDUs;
PDCP PDU reordering for reception;
Duplicate detection of lower layer SDUs;
Retransmission of PDCP SDUs;
Ciphering and deciphering; and/or
Timer-based SDU discard in uplink.

In the above description, reordering of the NR PDCP device may refer to a function of reordering PDCP PDUs received from a lower layer based on a PDCP sequence number (SN) and include a function of transferring data to a higher layer in the rearranged order. Alternatively, the reordering of the NR PDCP device may include a function of directly transferring data without considering the order, a function of rearranging the order and recording lost PDCP PDUs, a function of reporting a status of lost PDCP PDUs to the transmitting side, and a function of requesting retransmission of lost PDCP PDUs.

Main functions of the NR RLCs S35 and S60 may include some of the following functions:
Transfer of upper layer PDUs;
In-sequence delivery of upper layer PDUs;
Out-of-sequence delivery of upper layer PDUs;
Error Correction through ARQ;
Concatenation, segmentation and reassembly of RLC SDUs;
Re-segmentation of RLC data PDUs;
Reordering of RLC data PDUs;
Duplicate detection;
Protocol error detection;
RLC SDU discard; and/or
RLC re-establishment.

In the above description, in-sequence delivery of the NR RLC device may mean a function of sequentially transferring RLC SDUs received from a lower layer to a higher layer. In-sequence delivery of the NR RLC device may include a function of reassembling and transferring several RLC SDUs in the case that an original RLC SDU is divided into several RLC SDUs and received, a function of rearranging received RLC PDUs based on an RLC sequence number (SN) or a PDCP sequence number (SN), a function of rearranging the order and recording lost RLC PDUs, a function of reporting a status of lost RLC PDUs to the transmitting side, and a function of requesting retransmission of lost RLC PDUs. In-sequence delivery of the NR RLC device may include a function of sequentially transferring, in the case that there is a lost RLC SDU, only RLC SDUs before the lost RLC SDU to a higher layer or a function of sequentially transferring all RLC SDUs received before the timer starts to the higher layer, when a predetermined timer has expired even if there is a lost RLC SDU. Alternatively, in-sequence delivery of the NR RLC device may include a function of sequentially transferring all RLC SDUs received so far to the higher layer, when a predetermined timer has expired even if there is a lost RLC SDU. Further, the RLC PDUs may be processed in the order of reception (regardless of order of serial numbers and sequence numbers, in order of arrival) and transferred to the PDCP device regardless of order (out-of sequence delivery), and in the case of a segment, the NR RLC device may receive segments stored in a buffer or to be received later, reconstitute segments into one complete RLC PDU, and then transfer the one complete RLC PDU to the NR PDCP device. The NR RLC layer may not include a concatenation function, and the NR MAC layer may perform the concatenation function or the concatenation function may be replaced with a multiplexing function of the NR MAC layer.

In the above description, out-of-sequence delivery of the NR RLC device may mean a function of directly transferring RLC SDUs received from a lower layer to a higher layer regardless of order and may include a function of reassembling and transferring several RLC SDUs in the case that an original RLC SDU is divided into several RLC SDUs and received and a function of storing RLC SNs or PDCP sequence numbers (SNs) of received RLC PDUs, arranging the order, and recording lost RLC PDUs.

The NR MACs S40 and S55 may be connected to several NR RLC layer devices constituted in one UE, and main functions of the NR MAC may include some of the following functions:
Mapping between logical channels and transport channels;
Multiplexing/demultiplexing of MAC SDUs;
Scheduling information reporting;
Error correction through HARQ;
Priority handling between logical channels of one UE;
Priority handling between UEs by means of dynamic scheduling;
MBMS service identification;
Transport format selection; and/or
Padding.

NR PHY layers S45 and S50 may perform operations of channel-coding and modulating higher layer data, making the higher layer data into OFDM symbols and transmitting the OFDM symbols through a radio channel, or demodulating OFDM symbols received through a radio channel, channel-decoding the OFDM symbols, and transferring the OFDM symbols to a higher layer.

A detailed structure of the radio protocol structure may be variously changed according to a carrier (or cell) operation method. For example, in the case that the base station transmits data to the UE based on a single carrier (or cell), the base station and the UE use a protocol structure having a single structure for each layer, as in S00. However, in the case that the base station transmits data to the UE based on carrier aggregation (CA) using multiple carriers in a single TRP, the base station and the UE have a single structure up to RLC, as in S10, but use a protocol structure for multiplexing the PHY layer through the MAC layer. As another example, in the case that the base station transmits data to the UE based on dual connectivity (DC) using multiple carriers in multiple TRPs, the base station and the UE have a single structure up to RLC, as in S20, but use a protocol structure for multiplexing the PHY layer through the MAC layer.

### [Unified TCI State]

Hereinafter, a single TCI state indication and activation method based on a unified TCI scheme is described. The unified TCI scheme may mean a method of unifying and managing transmission and reception beam management schemes distinguished into a TCI state scheme used in downlink reception of the UE and a spatial relation info scheme used in uplink transmission in the existing Rel-15 and 16, into a TCI state. Therefore, in the case that the UE is instructed by the base station based on the unified TCI scheme, the UE may perform beam management using the TCI state even for uplink transmission. If the UE is configured with a TCI-State, which is upper layer signaling having tci-stateId-r17, which is upper layer signaling, from the base station, the UE may perform an operation based on the unified TCI scheme using the corresponding TCI-State. The TCI-State may exist in two forms of a joint TCI state or a separate TCI state.

A first form is a joint TCI state, and the UE may receive an instruction of both TCI states to be applied to uplink transmission and downlink reception through a single TCI-State from the base station. If the UE is instructed with a TCI-State based on the joint TCI state, the UE may be instructed with a parameter to be used for downlink channel estimation using an RS corresponding to qcl-Type1 in the TCI-State based on the corresponding joint TCI state, and a parameter to be used as a downlink reception beam or reception filter using an RS corresponding to qcl-Type2. If the UE is instructed with a TCI-State based on the joint TCI state, the UE may be instructed with a parameter to be used as an uplink transmission beam or transmission filter using an RS corresponding to qcl-Type2 in the joint DL/UL TCI state-based TCI-State. In this case, in the case that the UE is instructed with a joint TCI state, the UE may apply the same beam to both uplink transmission and downlink reception.

A second form is a separate TCI state, and the UE may individually receive an instruction of a UL TCI state to be applied to uplink transmission and a DL TCI state to be applied to downlink reception from the base station. If the UE is instructed with the UL TCI state, the UE may be instructed with parameters to be used as an uplink transmission beam or a transmission filter using a reference RS or source RS configured in the corresponding UL TCI state. If the UE is instructed with the DL TCI state, the UE may be instructed with a parameter to be used for downlink channel estimation using an RS corresponding to qcl-Type1 configured in the corresponding DL TCI state, and a parameter to be used as a downlink reception beam or a reception filter using an RS corresponding to qcl-Type2.

If the UE is instructed with both the DL TCI state and the UL TCI state, the UE may be instructed with parameters to be used as an uplink transmission beam or a transmission filter using a reference RS or source RS configured in the corresponding UL TCI state, and be instructed with a parameter to be used for downlink channel estimation using an RS corresponding to qcl-Type1 configured in the corresponding DL TCI state, and a parameter to be used as a downlink reception beam or a reception filter using an RS corresponding to qcl-Type2. In this case, in the case that the reference RS or source RS configured in UL TCI state and the DL TCI state in which the UE receives an instruction are different, the UE may individually apply beams to uplink transmission and downlink reception, respectively, based on the instructed UL TCI state and DL TCI state.

The UE may receive a configuration of maximum 128 joint TCI states for each specific bandwidth part in a specific cell from the base station through upper layer signaling and receive a configuration of maximum 64 or 128 DL TCI states among separate TCI states for each specific bandwidth part in a specific cell through upper layer signaling based on UE capability reporting, and a DL TCI state and a joint TCI state among separate TCI states may use the same upper layer signaling structure. For example, if 128 joint TCI states are configured and 64 DL TCI states among separate TCI states are configured, 64 DL TCI states may be included in the 128 joint TCI states.

Maximum 32 or 64 UL TCI state among separate TCI states may be configured for each specific bandwidth part within a specific cell through upper layer signaling based on the UE capability report, and as in the relationship between the DL TCI state and the joint TCI state among separate TCI states, the UL TCI state and the joint TCI state among the separate TCI may also use the same upper layer signaling structure, and the UL TCI state among separate TCI may use different upper layer signaling structures from that of the DL TCI state among the joint TCI state and the separate TCI state.

The use of such different or identical upper layer signaling structures may be defined in the specification, or may be distinguished through another upper layer signaling established by the base station based on a UE capability report containing information on two use schemes in which the UE may support.

The UE may receive transmission and reception beam-related instructions in a unified TCI scheme using one of the joint TCI state and separate TCI state configured by the base station. The UE may be configured by the base station through upper layer signaling as to whether to use one of the joint TCI state and separate TCI state.

The UE receives transmission and reception beam-related instructions using one scheme selected from the joint TCI state and the separate TCI state through upper layer signaling, and in this case, there may be two transmission and reception beam instruction methods from the base station: a MAC-CE-based instruction method and a MAC-CE-based activation and DCI-based instruction method.

In the case that the UE receives an instruction related to a transmission and reception beam using a joint TCI state method through upper layer signaling, the UE may receive a MAC-CE indicating the joint TCI state from the base station to perform a transmission and reception beam application operation, and the base station may schedule reception of a PDSCH including the corresponding MAC-CE through a PDCCH to the UE. If the MAC-CE includes one joint TCI state, the UE may determine a uplink transmission beam or transmission filter and a downlink reception beam or reception filter using the indicated joint TCI state from 3 ms after PUCCH transmission including HARQ-ACK information indicating whether reception of a PDSCH including the corresponding MAC-CE was successful, and if the MAC-CE includes two or more joint TCI states, the UE may identify that multiple joint TCI states indicated by the MAC-CE correspond to each code point of the TCI state field of the DCI format 1_1 or 1_2 from 3 ms after PUCCH transmission including HARQ-ACK information indicating whether reception of a PDSCH including the corresponding MAC-CE was successful, and activate the indicated joint TCI state. Thereafter, the UE may receive the DCI format 1_1 or 1_2 and apply one joint TCI state indicated by the TCI state field in the corresponding DCI to uplink transmission and downlink reception beams. In this case, the DCI format 1_1 or 1_2 may include (with DL assignment) or may not include (without DL assignment) downlink data channel scheduling information.

In the case that the UE receives an instruction related to a transmission and reception beam using a separate TCI state method through upper layer signaling, the UE may receive a MAC-CE indicating a separate TCI state from the base station to perform a transmission and reception beam application operation, and the base station may schedule the UE to receive a PDSCH including the corresponding MAC-CE through a PDCCH. If the MAC-CE includes one set of separate TCI states, the UE may determine an uplink transmission beam or transmission filter and a downlink reception beam or reception filter using separate TCI states included in the indicated separate TCI state set from 3 ms after transmitting a PUCCH including HARQ-ACK information indicating whether reception of the corresponding PDSCH was successful. In this case, a separate TCI state set may mean single or multiple separate TCI states in which one code point of the TCI state field in the DCI format 1_1 or 1_2 may have, and one separate TCI state set may include one DL TCI state, one UL TCI state, or one DL TCI state and one UL TCI state. If the MAC-CE includes two or more separate TCI state sets, the UE may identify that multiple separate TCI state sets indicated by the MAC-CE correspond to each code point of the TCI state field of the DCI format 1_1 or 1_2 from 3 ms after PUCCH transmission including HARQ-ACK information indicating whether reception of the corresponding PDSCH was successful, and activate the indicated separate TCI state set. In this case, each code point of the TCI state field of the DCI format 1_1 or 1_2 may indicate one DL TCI state, one UL TCI state, or each of one DL TCI state and one UL TCI state. The UE may receive a DCI format 1_1 or 1_2 and apply a set of separate TCI states indicated by the TCI state field in the corresponding DCI to uplink transmission and downlink reception beams. In this case, the DCI format 1_1 or 1_2 may include (with DL assignment) or may not include (without DL assignment) downlink data channel scheduling information.

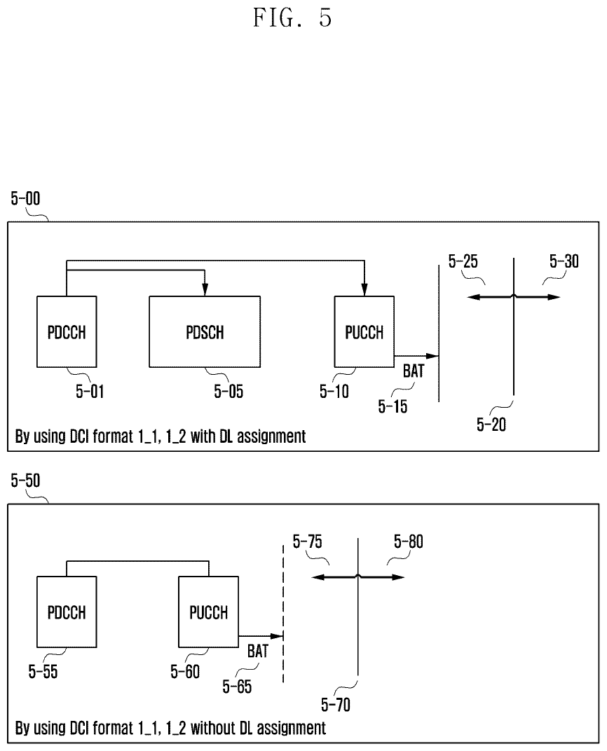

FIG. 5 illustrates a beam application time that may be considered in the case of using a unified TCI scheme in a wireless communication system according to an embodiment of the disclosure. As described above, the UE may receive a DCI format 1_1 or 1_2 including (with DL assignment) or not including (without DL assignment) downlink data channel scheduling information from the base station and apply one joint TCI state or separate TCI state set indicated by a TCI state field in the corresponding DCI to uplink transmission and downlink reception beams.
DCI format 1_1 or 1_2 with DL assignment (5-00): In the case that the UE receives a DCI format 1_1 or 1_2 including downlink data channel scheduling information from the base station (5-01) and indicates one joint TCI state or separate TCI state set based on the unified TCI scheme, the UE receives a PDSCH scheduled based on the received DCI (5-05), and transmit a PUCCH including an HARQ-ACK indicating whether reception of the DCI and the PDSCH was successful (5-10). In this case, the HARQ-ACK may include a meaning of whether reception of the DCI and the PDSCH was successful, and in the case that at least one of the DCI or the PDSCH is not received, the UE may transmit NACK, and if reception of both is successful, the UE may transmit ACK.
DCI format 1_1 or 1_2 without DL assignment (5-50): In the case that the UE receives a DCI format 1_1 or 1_2 that does not include downlink data channel scheduling information from the base station (5-55) and indicates one joint TCI state or separate TCI state set based on the unified TCI scheme, the UE may assume at least one combination of the following for the corresponding DCI.

Includes scrambled CRC using CS-RNTI.

All bits assigned to all fields used as a redundancy version (RV) field have a value of 1.

All bits assigned to all fields used as a modulation and coding scheme (MCS) field have a value of 1.

All bits assigned to all fields used as a new data indication (NDI) field have a value of 0.

In the case of frequency domain resource assignment (FDRA) type 0, all bits assigned to an FDRA field have a value of 0, and in the case of FDRA type 1, all bits assigned to the FDRA field have a value of 1, and in the case that the FDRA scheme is dynamicSwitch, all bits assigned to the FDRA field have a value of 0.

The UE may transmit a PUCCH including a HARQ-ACK indicating whether reception of the DCI format 1_1 or 1_2 assuming the above-described matters was successful (5-60).
For both the DCI format 1_1 or 1_2 with DL assignment (5-00) and without DL assignment (5-50), if a new TCI state indicated through DCI 5-01 and 5-55 is the same as a TCI state that has already been indicated and applied to an uplink transmission and downlink reception beam, the UE may maintain the previously applied TCI state, and if a new TCI state is different from the previously indicated TCI state, the UE may determine an application time point of a joint TCI state or separate TCI state set that may be indicated from the TCI state field included in the DCI as 5-30 and 5-80 after first slots 5-20 and 5-70 after a time equivalent to beam application times (BAT) 5-15 and 5-65 after PUCCH transmission and use the previously indicated TCI-state until 5-25 and 5-75 before the corresponding slots 5-20 and 5-70.
For both DCI format 1_1 or 1_2 with DL assignment (5-00) and without DL assignment (5-50), the BAT may be configured by upper layer signaling based on UE capability report information as a specific number of OFDM symbols, and numerology for the BAT and a first slot after the BAT may be determined based on the smallest numerology among all cells to which a joint TCI state or separate TCI state set indicated through DCI is applied.

The UE may apply one joint TCI state indicated through an MAC-CE or DCI to reception of control resource sets connected to all UE-specific search spaces, reception of a PDSCH scheduled with a PDCCH transmitted from the corresponding control resource set, transmission of the PUSCH, and transmission of all PUCCH resources.

In the case that one separate TCI state set indicated through an MAC-CE or DCI includes one DL TCI state, the UE may apply one separate TCI state set to reception of control resource sets connected to all UE-specific search space and reception of a PDSCH scheduled with a PDCCH transmitted from the corresponding control resource set, and apply to all PUSCH and PUCCH resources based on the previously indicated UL TCI state.

In the case that one separate TCI state set indicated through an MAC-CE or DCI includes one UL TCI state, the UE may apply the TCI set to all PUSCH and PUCCH resources and apply the TCI set to reception of control resource sets connected to all UE-specific search spaces based on previously indicated DL TCI states and reception of a PDSCH scheduled with a PDCCH transmitted from the corresponding control resource set.

In the case that one separate TCI state set indicated through an MAC-CE or DCI includes one DL TCI state and one UL TCI state, the UE may apply the DL TCI state to reception of control resource sets connected to all UE-specific search spaces and reception of a PDSCH scheduled with a PDCCH transmitted from the corresponding control resource sets, and apply the UL TCI state to all PUSCH and PUCCH resources.

### [Unified TCI State MAC-CE]

Hereinafter, a single TCI state indication and activation method based on a unified TCI scheme is described. The UE may be scheduled with a PDSCH including the following MAC-CE from the base station, and interpret each code point of the TCI state field in the DCI format 1_1 or 1_2 based on information in the MAC-CE received from the base station from 3 slots after transmitting a HARQ-ACK for the corresponding PDSCH to the base station. That is, the UE may activate each entry of the MAC-CE received from the base station to each code point of the TCI state field in the DCI format 1_1 or 1_2.

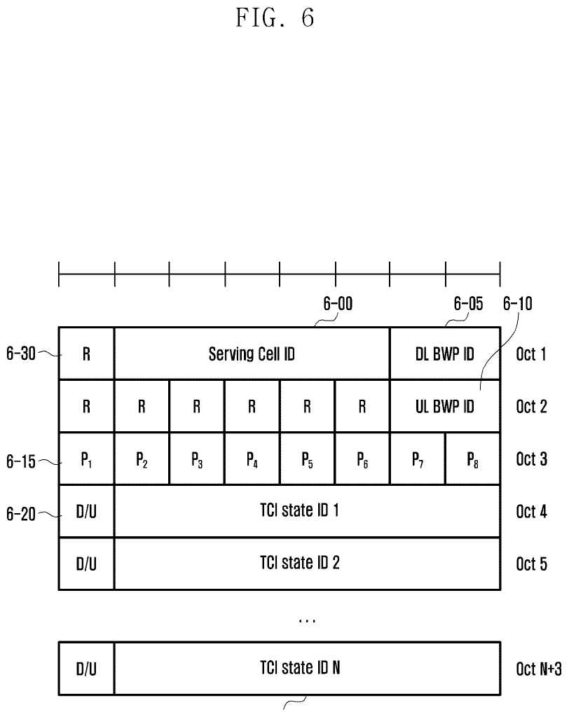

FIG. 6 illustrates another MAC-CE structure for activating and indicating a joint TCI state or a separate DL or UL TCI state in a wireless communication system according to an embodiment of the disclosure. The meaning of each field in the corresponding MAC-CE structure may be as follows.
Serving Cell ID 6-00: This field may indicate to which serving cell the corresponding MAC-CE is to be applied. A length of this field may be 5 bits. If a serving cell indicated by this field is included in one or more of upper layer signaling simultaneousU-TCI-UpdateList1, simultaneousU-TCI-UpdateList2, simultaneousU-TCI-UpdateList3, or simultaneousU-TCI-UpdateList4, the corresponding MAC-CE may be applied to all serving cells included in one or more lists of simultaneousU-TCI-UpdateList1, simultaneousU-TCI-UpdateList2, simultaneousU-TCI-UpdateList3, and simultaneousU-TCI-UpdateList4 including a serving cell indicated by this field.
DL BWP ID 6-05: This field may indicate to which DL BWP the corresponding MAC-CE is to be applied, and the meaning of each code point of this field may correspond to each code point of a bandwidth part indicator in the DCI. A length of this field may be 2 bits.
UL BWP ID 6-10: This field may indicate to which UL BWP the corresponding MAC-CE is to be applied, and the meaning of each code point of this field may correspond to each code point of a bandwidth part indicator in the DCI. A length of this field may be 2 bits.
Pi 6-15: This field may indicate whether each code point of the TCI state field in the DCI format 1_1 or 1_2 has multiple TCI states or a single TCI state. If a value of Pi is 1, it means that the corresponding i-th code point has multiple TCI states, which may mean that the corresponding code point may include a separate DL TCI state and a separate UL TCI state. If a value of Pi is 0, it means that the corresponding i-th code point has a single TCI state, which may mean that the corresponding code point may include either a joint TCI state, a separate DCI TCI state, or a separate UL TCI state.
D/U 6-20: This field may indicate whether a TCI state ID field in the same octet is a joint TCI state, a separate DL TCI state, or a separate UL TCI state. If this field is 1, the TCI state ID field in the same octet may be a joint TCI state or a separate DL TCI state, and if this field is 0, the TCI state ID field in the same octet may be a separate UL TCI state.
TCI state ID 6-25: This field may indicate a TCI state that may be identified by TCI-StateId, which is upper layer signaling. In the case that the D/U field is configured to 1, this field may be used for expressing a TCI-StateId that may be expressed in 7 bits. In the case that the D/U field is configured to 0, a most significant bit (MSB) of this field may be regarded as a reserved bit, and the remaining 6 bits may be used for expressing UL-TCIState-Id, which is upper layer signaling. The number of TCI states that may be activated to the maximum may be 8 in the case of a joint TCI state and 16 in the case of a separate DL or UL TCI state.
R 6-30: Indicates reserved bits and may be configured to 0.

For the MAC-CE structure of FIG. 6 described above, the UE may include a 3rd octet including P1, P2, . . . , P8 fields in FIG. 6 in the corresponding MAC-CE structure regardless of whether unifiedTCI-StateType-r17 in MIMOparam-r17 in ServingCellConfig, which is upper layer signaling, is configured to joint or separate. In this case, the UE may perform TCI state activation using a fixed MAC-CE structure regardless of upper layer signaling configured by the base station. As another example, for the MAC-CE structure of FIG. 6 described above, in the case that unifiedTCI-StateType-r17 in MIMOparam-r17 in ServingCellConfig, which is upper layer signaling, is configured to joint, the UE may omit the 3rd octet including the P1, P2, . . . , P8 fields in FIG. 6. In this case, the UE may save maximum 8 bits of a payload of the corresponding MAC-CE according to upper layer signaling configured by the base station. Further, all D/U fields located at a first bit from a fourth octet in FIG. 6 may be regarded as R fields, and all the corresponding R fields may be configured to 0 bits.

### [CSI Resource Configuration]

NR has a CSI framework for instructing the base station to measure and report channel state information (CSI) of the UE. The NR CSI framework may be composed of at least two elements of a resource setting and a report setting, and the report setting may have a connection relationship with each other with reference to at least one ID of the resource setting.

According to an embodiment of the disclosure, the resource setting may include information related to a reference signal (RS) for measuring channel state information by the UE. The base station may configure at least one resource setting to the UE. For example, the base station and the UE may exchange signaling information such as [Table 4] in order to transmit information on the resource setting.

```
TABLE 4
-- ASN1START
-- TAG-CSI-RESOURCECONFIG-START
CSI-ResourceConfig ::= SEQUENCE {
  csi-ResourceConfigId CSI-ResourceConfigId,
  csi-RS-ResourceSetList CHOICE {
  nzp-CSI-RS-SSB SEQUENCE {
  nzp-CSI-RS-ResourceSetList SEQUENCE (SIZE
(1..maxNrofNZP-CSI-RS-ResourceSetsPerConfig)) OF
NZP-CSI-RS-ResourceSetId
    OPTIONAL, -- Need R
  csi-SSB-ResourceSetList SEQUENCE (SIZE (1..maxNrofCSI-SSB-
ResourceSetsPerConfig)) OF CSI-SSB-ResourceSetId
    OPTIONAL -- Need R
  },
  csi-IM-ResourceSetList SEQUENCE (SIZE (1..maxNrofCSI-IM-
ResourceSetsPerConfig)) OF CSI-IM-ResourceSetId
  },
bwp-Id BWP-Id,
resourceType ENUMERATED { aperiodic, semiPersistent, periodic },
...
}
-- TAG-CSI-RESOURCECONFIG-STOP
-- ASN1STOP
```

In [Table 4], signaling information CSI-ResourceConfig includes information on each resource setting. According to the signaling information, each resource setting may include a resource setting index (csi-ResourceConfigId), a BWP index (bwp-ID), a time axis transmission configuration (resourceType) of a resource, or a resource set list (csi-RS-ResourceSetList) including at least one resource set. A time axis transmission configuration of the resource may be configured to aperiodic transmission, semi-persistent transmission, or periodic transmission. A resource set list may be a set including a resource set for channel measurement or a set including a resource set for interference measurement. In the case that the resource set list is a set including resource sets for channel measurement, each resource set may include at least one resource, which may be an index of a synchronization/broadcast channel block (SS/PBCH block (SSB)) or a CSI reference signal (CSI-RS) resource. In the case that the resource set list is a set including resource sets for interference measurement, each resource set may include at least one interference measurement resource (CSI interference measurement (CSI-IM)).

For example, in the case that the resource set includes a CSI-RS, the base station and the UE may exchange signaling information such as [Table 5] in order to transmit information on the resource set.

```
TABLE 5
-- ASN1START
-- TAG-NZP-CSI-RS-RESOURCESET-START
NZP-CSI-RS-ResourceSet ::= SEQUENCE {
  nzp-CSI-ResourceSetId NZP-CSI-RS-ResourceSetId,
  nzp-CSI-RS-Resources SEQUENCE (SIZE
(1..maxNrofNZP-CSI-RS-ResourcesPerSet)) OF NZP-CSI-RS-ResourceId,
  repetition ENUMERATED { on, off } OPTIONAL, -- Need S
  aperiodicTriggeringOffset INTEGER(0..6) OPTIONAL, -- Need S
  trs-Info ENUMERATED {true} OPTIONAL, -- Need R
  ...
}
-- TAG-NZP-CSI-RS-RESOURCESET-STOP
-- ASN1STOP
```

In [Table 5], signaling information NZP-CSI-RS-ResourceSet includes information on each resource set. According to the signaling information, each resource set may include information on at least a resource set index (nzp-CSI-ResourceSetId) or a set (nzp-CSI-RS-Resources) of indexes of an including CSI-RS, and include part of information (repetition) on a spatial domain transmission filter of an including CSI-RS resource or information on whether an including CSI-RS resource is used for tracking (trs-Info).

The CSI-RS may be the most representative reference signal included in the resource set. The base station and the UE may exchange signaling information such as [Table 6] in order to transmit information on the CSI-RS resource.

```
TABLE 6
-- ASN1START
-- TAG-NZP-CSI-RS-RESOURCE-START
NZP-CSI-RS-Resource ::= SEQUENCE {
  nzp-CSI-RS-ResourceId NZP-CSI-RS-ResourceId,
  resourceMapping CSI-RS-ResourceMapping,
  powerControlOffset INTEGER (−8..15),
  powerControlOffsetSS ENUMERATED{db−3, db0, db3, db6} OPTIONAL, -- Need R
  scramblingID ScramblingId,
  periodicityAndOffset CSI-ResourcePeriodicityAndOffset OPTIONAL, -- Cond
PeriodicOrSemiPersistent
  qcl-InfoPeriodicCSI-RS TCI-StateId OPTIONAL, -- Cond Periodic
  ...
  }
-- TAG-NZP-CSI-RS-RESOURCE-STOP
-- ASN1STOP
```

In [Table 6], signaling information NZP-CSI-RS-Resource includes information on each CSI-RS. Information included in the signaling information NZP-CSI-RS-Resource may have the following meanings:
nzp-CSI-RS-ResourceId: CSI-RS resource index;
resourceMapping: Resource mapping information of CSI-RS resource;
powerControlOffset: Ratio between PDSCH EPRE (Energy Per RE) and CSI-RS EPRE;
powerControlOffsetSS: Ratio between SS/PBCH block EPRE and CSI-RS EPRE;
scramblingID: scrambling index of the CSI-RS sequence;
periodicity AndOffset: Transmission period and slot offset of the CSI-RS
resource; and
qcl-InfoPeriodicCSI-RS: TCI-state information in the case that the corresponding CSI-RS is a periodic CSI-RS.

The resourceMapping included in the signaling information NZP-CSI-RS-Resource indicates resource mapping information of the CSI-RS resource, and may include frequency resource resource element (RE) mapping, number of ports, symbol mapping, CDM type, frequency resource density, and frequency band mapping information. The number of ports, frequency resource density, CDM type, and time-frequency axis RE mapping that may be configured through this may have a value determined in one of rows of [Table 7].

TABLE 7

| | Ports | Density | | | CDM group | | |
|---|---|---|---|---|---|---|---|
| Row | χ | ρ | cdm-Type | (k̅, l̅) | index j | k′ | l′ |
| 1 | 1 | 3 | No CDM | (k₀, l₀), (k₀ + 4, l₀), (k₀ + 8, l₀) | 0, 0, 0 | 0 | 0 |
| 2 | 1 | 1, 0.5 | No CDM | (k₀, l₀) | 0 | 0 | 0 |
| 3 | 2 | 1, 0.5 | FD-CDM2 | (k₀, l₀) | 0 | 0, 1 | 0 |
| 4 | 4 | 1 | FD-CDM2 | (k₀, l₀), (k₀ + 2, l₀) | 0, 1 | 0, 1 | 0 |
| 5 | 4 | 1 | FD-CDM2 | (k₀, l₀), (k₀, l₀ + 1) | 0, 1 | 0, 1 | 0 |
| 6 | 8 | 1 | FD-CDM2 | (k₀, l₀), (k₁, l₀), (k₂, l₀), (k₃, l₀) | 0, 1, 2, 3 | 0, 1 | 0 |
| 7 | 8 | 1 | FD-CDM2 | (k₀, l₀), (k₁, l₀), (k₀, l₀ + 1), (k₁, l₀ + 1) | 0, 1, 2, 3 | 0, 1 | 0 |
| 8 | 8 | 1 | CDM4 | (k₀, l₀), (k₁, l₀) | 0, 1 | 0, 1 | 0, 1 |
| | | | (FD2, TD2) | | | | |
| 9 | 12 | 1 | FD-CDM2 | (k₀, l₀), (k₁, l₀), (k₂, l₀), (k₃, l₀), (k₄, l₀), (k₅, l₀) | 0, 1, 2, 3, 4, 5 | 0, 1 | 0 |
| 10 | 12 | 1 | CDM4 | (k₀, l₀), (k₁, l₀), (k₂, l₀) | 0, 1, 2 | 0, 1 | 0, 1 |
| | | | (FD2, TD2) | | | | |
| 11 | 16 | 1, 0.5 | FD-CDM2 | (k₀, l₀), (k₁, l₀), (k₂, l₀), (k₃, l₀), | 0, 1, 2, 3, | 0, 1 | 0 |
| | | | | (k₀, l₁ + 1), (k₁, l₀ + 1), (k₂, l₀ + 1), (k₃, l₀ + 1) | 4, 5, 6, 7 | | |
| 12 | 16 | 1, 0.5 | CDM4 | (k₀, l₀), (k₁, l₀), (k₂, l₀), (k₃, l₀) | 0, 1, 2, 3 | 0, 1 | 0, 1 |
| | | | (FD2, TD2) | | | | |
| 13 | 24 | 1, 0.5 | FD-CDM2 | (k₀, l₀), (k₁, l₀), (k₂, l₀), (k₀, l₀ + 1), (k₁, l₀ + 1), (k₂, l₀ + 1), | 0, 1, 2, 3, 4, 5, | 0, 1 | 0 |
| | | | | (k₀, l₁), (k₁, l₁), (k₂, l₁), (k₀, l₁ + 1), (k₁, l₁ + 1), (k₂, l₁ + 1) | 6, 7, 8, 9, 10, 11 | | |
| 14 | 24 | 1, 0.5 | CDM4 | (k₀, l₀), (k₁, l₀), (k₂, l₀), (k₀, l₁), (k₁, l₁), (k₂, l₁) | 0, 1, 2, 3, 4, 5 | 0, 1 | 0, 1 |
| | | | (FD2, TD2) | | | | |
| 15 | 24 | 1, 0.5 | CDM8 | (k₀, l₀), (k₁, l₀), (k₂, l₀) | 0, 1, 2 | 0, 1 | 0, 1, |
| | | | (FD2, TD4) | | | | 2, 3 |
| 16 | 32 | 1, 0.5 | FD-CDM2 | [symbol] | 0, 1, 2, 3, | 0, 1 | 0 |
| | | | | (k₀, l₀ + 1), (k₁, l₀ + 1), (k₂, l₀ + 1), (k₃, l₀ + 1), | 4, 5, 6, 7, | | |
| | | | | (k₀, l₁), (k₁, l₁), (k₂, l₁), (k₃, l₁), | 8, 9, 10, 11, | | |
| | | | | (k₀, l₁ + 1), (k₁, l₁ + 1), (k₂, l₁ + 1), (k₃, l₁ + 1) | 12, 13, 14, 15 | | |
| 17 | 32 | 1, 0.5 | CDM4 | (k₀, l₀), (k₁, l₀), (k₂, l₀), (k₃, l₀), (k₀, l₁), (k₁, l₁), (k₂, l₁), (k₃, l₁) | 0, 1, 2, 3, 4, 5, 6, 7 | 0, 1 | 0, 1 |
| | | | (FD2, TD2) | | | | |
| 18 | 32 | 1, 0.5 | CDM8 | (k₀, l₀), (k₁, l₀), (k₂, l₀), (k₃, l₀) | 0, 1, 2, 3 | 0, 1 | 0, 1, |
| | | | (FD2, TD4) | | | | 2, 3 |

[symbol]

indicates data missing or illegible when filed

[Table 7] illustrates a frequency resource density, a CDM type, a frequency-axis and time-axis start positions (k̅, l̅) of a CSI-RS component RE pattern, and the number (k′) of frequency-axis REs and the number (l′) of time-axis REs of a CSI-RS component RE pattern that may be configured according to the number of CSI-RS ports (X). The above-described CSI-RS component RE pattern may be a basic unit constituting a CSI-RS resource. Through the Y=1+max (k′) number of REs of the frequency axis and the Z=1+max (l′) number of REs of the time axis, the CSI-RS component RE pattern may be composed of the YZ number of REs. In the case that the number of CSI-RS ports is 1 port, a CSI-RS RE position may be designated without limitation of subcarriers in a physical resource block (PRB), and the CSI-RS RE position may be designated by a 12-bit bitmap. In the case that the number of CSI-RS ports is {2, 4, 8, 12, 16, 24, 32} ports and that Y=2, CSI-RS RE positions may be designated for every two subcarriers in a PRB, and CSI-RS RE positions may be designated by a 6-bit bitmap. In the case that the number of CSI-RS ports is 4 ports and that Y=4, CSI-RS RE positions may be designated for every four subcarriers in a PRB, and CSI-RS RE positions may be designated by a 3-bit bitmap. Similarly, time axis RE positions may be designated by a bitmap of total 14 bits.

### [CSI Report Configuration]

According to an embodiment of the disclosure, a report setting may have a connection relationship with each other with reference to at least one ID thereof, and a resource setting(s) having a connection relationship with the report setting provide(s) configuration information including information on a reference signal for channel information measurement. In the case that the resource setting(s) having a connection relationship with the report setting is(are) used for channel information measurement, the measured channel information may be used for channel information reporting according to a reporting method configured in the report setting having the connection relationship.

According to an embodiment of the disclosure, the report setting may include configuration information related to a CSI reporting method. For example, the base station and the UE may exchange signaling information such as [Table 8] in order to transmit information on the report setting.

```
TABLE 8
-- ASN1START
-- TAG-CSI-REPORTCONFIG-START
CSI-ReportConfig ::= SEQUENCE {
  reportConfigId CSI-ReportConfigId,
  carrier ServCellIndex OPTIONAL, -- Need S
  resourcesForChannelMeasurement CSI-ResourceConfigId,
  csi-IM-ResourcesForInterference CSI-ResourceConfigId OPTIONAL, -- Need R
  nzp-CSI-RS-ResourcesForInterference CSI-ResourceConfigId OPTIONAL, -- Need R
  reportConfigType CHOICE {
  periodic SEQUENCE {
    reportSlotConfig CSI-ReportPeriodicityAndOffset,
    pucch-CSI-ResourceList SEQUENCE (SIZE (1..maxNrofBWPs)) OF PUCCH-CSI-
Resource
  },
  semiPersistentOnPUCCH SEQUENCE {
    reportSlotConfig CSI-ReportPeriodicityAndOffset,
    pucch-CSI-ResourceList SEQUENCE (SIZE (1..maxNrofBWPs)) OF PUCCH-CSI-
Resource
  },
  semiPersistentOnPUSCH SEQUENCE {
    reportSlotConfig ENUMERATED {sl5, sl10, sl20, sl40, sl80, sl160, sl320},
    reportSlotOffsetList SEQUENCE (SIZE (1.. maxNrofUL-Allocations)) OF
INTEGER(0..32),
    p0alpha P0-PUSCH-AlphaSetId
  },
  aperiodic SEQUENCE {
    reportSlotOffsetList SEQUENCE (SIZE (1..maxNrofUL-Allocations)) OF
INTEGER(0..32)
  }
  },
  reportQuantity CHOICE {
  none NULL,
  cri-RI-PMI-CQI NULL,
  cri-RI-i1 NULL,
  cri-RI-i1-CQI SEQUENCE {
    pdsch-BundleSizeForCSI ENUMERATED {n2, n4} OPTIONAL -- Need S
  },
  cri-RI-CQI NULL,
  cri-RSRP NULL,
  ssb-Index-RSRP NULL,
  cri-RI-LI-PMI-CQI NULL
  },
  reportFreqConfiguration SEQUENCE {
  cqi-FormatIndicator ENUMERATED { widebandCQI, subbandCQI } OPTIONAL,
-- Need R
  pmi-FormatIndicator ENUMERATED { widebandPMI, subbandPMI } OPTIONAL,
-- Need R
  csi-ReportingBand CHOICE {
    subbands3 BIT STRING(SIZE(3)),
    subbands4 BIT STRING(SIZE(4)),
    subbands5 BIT STRING(SIZE(5)),
    subbands6 BIT STRING(SIZE(6)),
    subbands7 BIT STRING(SIZE(7)),
    subbands8 BIT STRING(SIZE(8)),
    subbands9 BIT STRING(SIZE(9)),
    subbands10 BIT STRING(SIZE(10)),
    subbands11 BIT STRING(SIZE(11)),
    subbands12 BIT STRING(SIZE(12)),
    subbands13 BIT STRING(SIZE(13)),
    subbands14 BIT STRING(SIZE(14)),
    subbands15 BIT STRING(SIZE(15)),
    subbands16 BIT STRING(SIZE(16)),
    subbands17 BIT STRING(SIZE(17)),
    subbands18 BIT STRING(SIZE(18)),
    ...,
    subbands19-v1530 BIT STRING(SIZE(19))
  } OPTIONAL -- Need S
  } OPTIONAL, -- Need R
  timeRestrictionForChannelMeasurements ENUMERATED {configured, notConfigured},
  timeRestrictionForInterferenceMeasurements ENUMERATED {configured,
notConfigured},
  codebookConfig CodebookConfig OPTIONAL, -- Need R
  dummy ENUMERATED {n1, n2} OPTIONAL, -- Need R
  groupBasedBeamReporting CHOICE {
  enabled NULL,
  disabled SEQUENCE {
    nrofReportedRS ENUMERATED {n1, n2, n3, n4} OPTIONAL -- Need S
  }
  },
  cqi-Table ENUMERATED {table1, table2, table3, spare1} OPTIONAL, -- Need R
  subbandSize ENUMERATED {value1, value2},
  non-PMI-PortIndication SEQUENCE (SIZE (1..maxNrofNZP-CSI-RS-
ResourcesPerConfig)) OF PortIndexFor8Ranks OPTIONAL, -- Need R
  ...,
  [[
  semiPersistentOnPUSCH-v1530 SEQUENCE {
  reportSlotConfig-v1530 ENUMERATED {sl4, sl8, sl16}
  } OPTIONAL -- Need R
  ]]
}
```

In [Table 8], signaling information CSI-ReportConfig includes information on each report setting. Information included in the signaling information CSI-ReportConfig may have the following meanings:
reportConfigId: report setting index;
carrier: serving cell index;
resourcesForChannelMeasurement: Resource setting index for channel
measurement having a connection relationship with the report setting;
csi-IM-ResourcesForInterference: Index of the resource setting having a CSI-IM resource for interference measurement having a connection relationship with the report setting;
nzp-CSI-RS-ResourcesForInterference: Index of the resource setting having a CSI-RS resource for interference measurement having a connection relationship with the report setting;
reportConfigType: Indicates the time axis transmission configuration and transmission channel of the channel report, and may have aperiodic transmission, semi-persistent physical uplink control channel (PUCCH) transmission, semi-periodic PUSCH transmission, or periodic transmission configuration;
reportQuantity: Indicates a type of reporting channel information, and it may have types of channel information (“cri-RI-PMI-CQI,” “cri-RI-i1,” “cri-RI-i1-CQI,” “cri-RI-CQI,” “cri-RSRP,” “ssb-Index-RSRP,” “cri-RI-LI-PMI-CQI”) in the case that no channel report is transmitted (“none”) and in the case that channel report is transmitted. Here, elements included in types of channel information mean a channel quality indicator (CQI), precoding matric indicator (PMI), CSI-RS resource indicator (CRI), SS/PBCH block resource indicator (SSBRI), layer indicator (LI), rank indicator (RI), and/or L1-reference signal received power (RSRP);
reportFreqConfiguration: Indicates whether reporting channel information includes only information on the entire band (wideband) or information on each subband, and in the case that reporting channel information includes information on each subband, it may have configuration information on a subband including channel information;
timeRestrictionForChannelMeasurements: Whether the reference signal for channel measurement is restricted in the time axis among reference signals referenced by reporting channel information;
timeRestrictionForInterferenceMeasurements: Whether the reference signal for interference measurement is restricted in the time axis among reference signals referenced by reporting channel information;
codebookConfig: Codebook information referenced by reporting channel information.
groupBasedBeamReporting: Whether to perform group beaming in channel reporting;
cqi-Table: CQI table index referenced by reporting channel information;
subbandSize: Index indicating a subband size of channel information; and
non-PMI-PortIndication: Port mapping information referenced when reporting non-PMI channel information.

In the case that the base station instructs channel information reporting through upper layer signaling or L1 signaling, the UE may perform channel information reporting with reference to the above configuration information included in the instructed report setting.

The base station may instruct the UE to report channel state information (CSI) through upper layer signaling including radio resource control (RRC) signaling or medium access control (MAC) control element (CE) signaling, or L1 signaling (e.g., common DCI, group-common DCI, UE-specific DCI).

For example, the base station may instruct the UE to perform an aperiodic channel information report (CSI report) through higher layer signaling or DCI using the DCI format 0_1. The base station configures a plurality of CSI report trigger states including a parameter for an aperiodic CSI report of the UE or a parameter for a CSI report through higher layer signaling. The parameters for the CSI report or the CSI report trigger states may include a set including a slot interval or a possible slot interval between a PDCCH including the DCI and a PUSCH including the CSI report, a reference signal ID for channel state measurement, a type of including channel information, and the like. When the base station instructs the UE to perform some of the multiple CSI report trigger states through DCI, the UE reports channel information according to the CSI report settings of the report settings configured in the instructed CSI report trigger states. The channel information reporting may be performed through a PUSCH scheduled with the DCI format 0_1. Time axis resource assignment of the PUSCH including the CSI report of the UE may be performed through a slot interval with the PDCCH indicated through the DCI, and a start symbol and symbol length indication within the slot for time axis resource assignment of the PUSCH, and the like. For example, a position of the slot in which the PUSCH including the CSI report of the UE is transmitted may be indicated through a slot interval with the PDCCH indicated through the DCI, and a start symbol and symbol length within the slot may be indicated through a time domain resource assignment field of the DCI described above.

For example, the base station may instruct the UE to perform a semi-persistent CSI report transmitted through a PUSCH through DCI using a DCI format 0_1. The base station may activate or deactivate a semi-persistent CSI report transmitted through the PUSCH through DCI scrambled with an SP-CSI-RNTI. If the semi-persistent CSI report is activated, the UE may periodically report channel information according to a configured slot interval. If the semi-persistent CSI report is deactivated, the UE may stop the activated periodic channel information reporting. The base station configures a parameter for the semi-persistent CSI report of the UE or multiple CSI report trigger states including a parameter for the semi-persistent CSI report through upper layer signaling. Parameters for a CSI report or CSI report trigger states may include a slot interval or a set including possible slot intervals between a PDCCH including DCI indicating a CSI report and a PUSCH including the CSI report, a slot interval between a slot in which upper layer signaling indicating a CSI report is activated and a PUSCH including the CSI report, a slot interval period of the CSI report, a type of including channel information, and the like. When the base station activates some of a plurality of CSI report trigger states or some of a plurality of report settings to the UE through upper layer signaling or DCI, the UE may report channel information according to a report setting included in the indicated CSI report trigger state or a CSI report configuration configured in the activated report setting. The channel information reporting may be performed through a PUSCH semi-persistently scheduled in a DCI format 0_1 scrambled with an SP-CSI-RNTI. Time axis resource assignment of the PUSCH including the CSI report of the UE may be performed through a slot interval period of the CSI report, a slot interval with a slot in which upper layer signaling is activated, a slot interval with the PDCCH indicated through DCI, a start symbol and symbol length indication within the slot for time axis resource assignment of the PUSCH, and the like. For example, a position of a slot in which the PUSCH including the CSI report of the UE is transmitted may be indicated through a slot interval with the PDCCH indicated through DCI, and a start symbol and symbol length within the slot may be indicated through a time domain resource assignment field of the DCI format 0_1 described above.

For example, the base station may instruct the UE to perform a semi-persistent CSI report transmitted to a PUCCH through upper layer signaling such as an MAC-CE. Through the MAC-CE signaling, the base station may activate or deactivate the semi-persistent CSI report transmitted to the PUCCH. When the semi-persistent CSI report is activated, the UE may periodically report channel information according to a configured slot interval. When the semi-persistent CSI report is deactivated, the UE may stop the activated periodic channel information reporting. The base station configures parameters for the semi-persistent CSI report of the UE through upper layer signaling. The parameters for the CSI report may include a PUCCH resource to which the CSI report is transmitted, a slot interval period of the CSI report, a type of including channel information, and the like. The UE may transmit the CSI report through the PUCCH. Alternatively, in the case that the PUCCH for the CSI report overlaps with the PUSCH, the UE may transmit the CSI report to the PUSCH. A position of the PUCCH transmission slot including the CSI report may be indicated through a slot interval period of the CSI report configured through upper layer signaling, a slot interval between a slot in which upper layer signaling is activated and a PUCCH including the CSI report, and a start symbol and a symbol length within the slot may be indicated through a start symbol and symbol length to which the PUCCH resource configured through upper layer signaling is allocated.

For example, the base station may instruct the UE to perform a periodic CSI report through upper layer signaling. The base station may activate or deactivate a periodic CSI report through upper layer signaling including RRC signaling. When the periodic CSI report is activated, the UE may periodically report channel information according to a configured slot interval. When the periodic CSI report is deactivated, the UE may stop the activated periodic channel information report. The base station configures a report setting including parameters for the periodic CSI report of the UE through upper layer signaling. The parameters for the CSI report may include a PUCCH resource configuration for the CSI report, a slot interval between a slot in which upper layer signaling indicating the CSI report is activated and a PUCCH including the CSI report, a slot interval period of the CSI report, a reference signal ID for channel state measurement, a type of including channel information, and the like. The UE may transmit the CSI report through the PUCCH. Alternatively, in the case that the PUCCH for the CSI report overlaps with the PUSCH, the UE may transmit the CSI report to the PUSCH. A position of a slot in which the PUCCH including the CSI report is transmitted may be indicated through a slot interval period of the CSI report configured through upper layer signaling, a slot interval between a slot in which upper layer signaling is activated and the PUCCH including the CSI report, and a start symbol and a symbol length within the slot may be indicated through a start symbol and a symbol length to which a PUCCH resource configured through upper layer signaling is allocated.

For the above-described CSI report setting (CSI-ReportConfig), each report setting CSI-ReportConfig may be associated with a CSI resource setting associated with the corresponding report setting and one downlink (DL) bandwidth part identified by an upper layer parameter bandwidth part identifier (bwp-id) given by the CSI-ResourceConfig. A time domain reporting operation for each report setting CSI-ReportConfig supports “Aperiodic,” “Semi-Persistent,” and “Periodic” schemes, which may be configured from the base station to the UE by a reportConfigType parameter configured from the upper layer. The semi-persistent CSI reporting method supports “PUCCH-based semi-persistent (semi-PersistentOnPUCCH)” and “PUSCH-based semi-persistent (semi-PersistentOnPUSCH).” In the case of a periodic or semi-permanent CSI reporting method, the UE may receive a configuration of a PUCCH or PUSCH resource to transmit CSI from the base station through upper layer signaling. A period and slot offset of the PUCCH or PUSCH resource to transmit CSI may be given as numerology of an uplink (UL) bandwidth part where the CSI report is configured to be transmitted. In the case of the aperiodic CSI reporting method, the UE may be scheduled with the PUSCH resource to transmit CSI from the base station through L1 signaling (the above-described DCI format 0_1).

For the above-described CSI resource setting (CSI-ResourceConfig), each CSI resource setting CSI-ReportConfig may include the S(≥1) number of CSI resource sets (given by the higher layer parameter csi-RS-ResourceSetList). The CSI resource set list may be composed of a non-zero power (NZP) CSI-RS resource set and a SS/PBCH block set, or a CSI-interference measurement (CSI-IM) resource set. Each CSI resource setting may be located in a downlink (DL) bandwidth part identified by a higher layer parameter bwp-id, and the CSI resource setting may be connected to a CSI reporting setting in the same downlink bandwidth part. A time domain operation of the CSI-RS resource in the CSI resource setting may be configured to one of “aperiodic,” “periodic” or “semi-persistent” from the higher layer parameter resourceType. For periodic or semi-persistent CSI resource setting, the number of CSI-RS resource sets may be limited to S=1, and the configured period and slot offset may be given as numerology of a downlink bandwidth part identified by bwp-id. The UE may receive a configuration of one or more CSI resource settings for channel or interference measurement from the base station through upper layer signaling and include, for example, the following CSI resources:
CSI-IM resource for interference measurement;
NZP CSI-RS resource for interference measurement; and/or
NZP CSI-RS resource for channel measurement.

For CSI-RS resource sets associated with resource settings in which the upper layer parameter resourceType is configured to “aperiodic,” “periodic,” or “semi-persistent,” a trigger state for the CSI report setting where reportType is configured to “aperiodic” and a resource setting for channel or interference measurement for one or more component cells (CCs) may be configured to the upper layer parameter CSI-AperiodicTriggerStateList.

Aperiodic CSI reporting of the UE may use a PUSCH, periodic CSI reporting may use a PUCCH, and semi-persistent CSI reporting may be performed using a PUSCH in the case of being triggered or activated by DCI, and using a PUCCH after being activated by a MAC control element (MAC CE). As described above, the CSI resource setting may also be configured aperiodically, periodically, or semi-persistently. A combination between the CSI reporting setting and the CSI resource setting may be supported based on [Table 9].

TABLE 9

| CSI-RS | Periodic CSI | Semi-Persistent CSI | Aperiodic CSI |
|---|---|---|---|
| Configuration | Reporting | Reporting | Reporting |
| Periodic | No dynamic | For reporting on | Triggered by DCI; |
| CSI-RS | triggering/ | PUCCH, the UE | additionally, |
| | activation | receives an | activation command |
| | | activation command | [10, TS 38.321] |
| | | [10, TS 38.321]; for | possible as defined |
| | | reporting on | in Subclause |
| | | PUSCH, the UE | 5.2.1.5.1. |
| | | receives triggering | |
| | | on DCI | |
| Semi- | Not | For reporting on | Triggered by DCI; |
| Persistent | Supported | PUCCH, the UE | additionally, |
| CSI-RS | | receives an | activation command |
| | | activation command | [10, TS 38.321] |
| | | [10, TS 38.321]; for | possible as defined |
| | | reporting on | in Subclause |
| | | PUSCH, the UE | 5.2.1.5.1. |
| | | receives triggering | |
| | | on DCI | |
| Aperiodic | Not | Not | Triggered by DCI; |
| CSI-RS | Supported | Supported | additionally, |
| | | | activation command |
| | | | [10, TS 38.321] |
| | | | possible as defined |
| | | | in Subclause |
| | | | 5.2.1.5.1. |

Aperiodic CSI reporting may be triggered by the “CSI request” field of the above-described DCI format 0_1 corresponding to scheduling DCI for a PUSCH. The UE may monitor the PDCCH, acquire a DCI format 0_1, and acquire scheduling information and a CSI request indicator for a PUSCH. The CSI request indicator may be configured to NTS (=0, 1, 2, 3, 4, 5, or 6) bits and be determined by higher layer signaling (reportTriggerSize). One trigger state among one or more aperiodic CSI reporting trigger states that may be configured by higher layer signaling (CSI-AperiodicTriggerStateList) may be triggered by the CSI request indicator.
In the case that all bits in the CSI request field are 0, this may mean that no CSI reporting is requested.
If the number (M) of CSI trigger states in the configured CSI-AperiodicTriggerStateLite is greater than 2NTs−1, the M number of CSI trigger states may be mapped to 2NTs−1, and one of trigger states of 2NTs−1 may be indicated by the CSI request field, according to the defined mapping relationship.
If the number (M) of CSI trigger states in the configured CSI-AperiodicTriggerStateLite is smaller than or equal to 2NTs−1, one of the M number of CSI trigger states may be indicated by the CSI request field.

[Table 10] illustrates an example of the relationship between a CSI request indicator and a CSI trigger state that may be indicated by the corresponding indicator.

TABLE 10

| CSI request | CSI trigger | CSI- | CSI- |
|---|---|---|---|
| field | state | ReportConfigId | ResourceConfigId |
| 00 | no CSI request | N/A | N/A |
| 01 | CSI trigger | CSI report#1 | CSI resource#1, |
| | state#1 | CSI report#2 | CSI resource#2 |
| 10 | CSI trigger | CSI report#3 | CSI resource#3 |
| | state#2 | | |
| 11 | CSI trigger | CSI report#4 | CSI resource#4 |
| | state#3 | | |

The UE may perform measurement on a CSI resource within a CSI trigger state triggered by a CSI request field, and generate CSI (including at least one of the above-described CQI, PMI, CRI, SSBRI, LI, RI, or L1-RSRP) from this. The UE may transmit the acquired CSI using a PUSCH scheduled by the corresponding DCI format 0_1. In the case that 1 bit corresponding to an uplink data indicator (UL-SCH indicator) in the DCI format 0_1 indicates “1,” uplink data (UL-SCH) and the acquired CSI may be multiplexed and transmitted in a PUSCH resource scheduled by the DCI format 0_1. In the case that 1 bit corresponding to the uplink data indicator (UL-SCH indicator) in the DCI format 0_1 indicates “0,” only CSI may be mapped and transmitted without uplink data (UL-SCH) to the PUSCH resource scheduled by the DCI format 0_1.

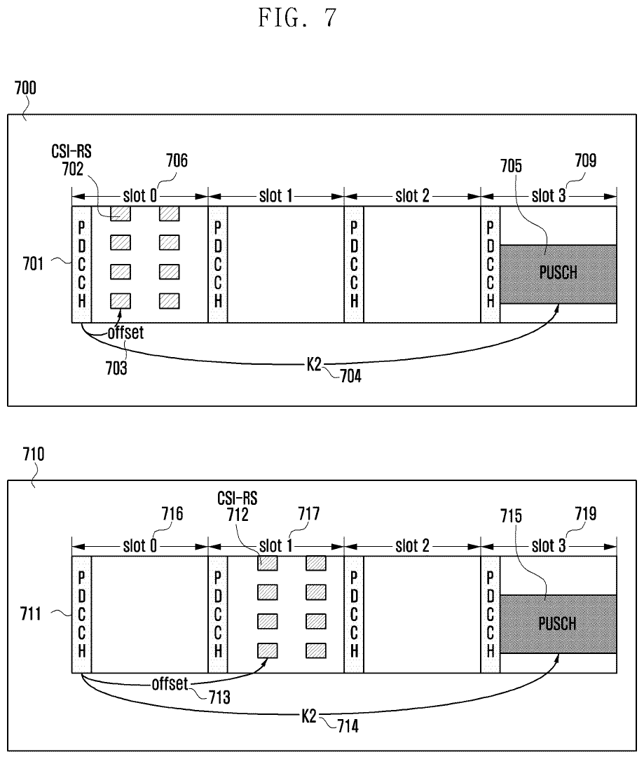

FIG. 7 illustrates an example of an aperiodic CSI reporting method according to an embodiment of the present disclosure.

In an example 700 of FIG. 7, the UE may monitor a PDCCH 701 to acquire a DCI format 0_1, and acquire scheduling information and CSI request information on a PUSCH 705 from this. The UE may acquire resource information on a CSI-RS 702 to be measured from a received CSI request indicator. The UE may determine whether to perform measurement on the CSI-RS 702 resource transmitted at any time point based on a time point that receives a DCI format 0_1 and a parameter (aperiodicTriggeringOffset described above) for offset in the CSI resource set configuration (e.g., NZP CSI-RS resource set configuration (NZP-CSI-RS-ResourceSet)). More specifically, the UE may receive a configuration of an offset value X of a parameter aperiodicTriggeringOffset in the NZP-CSI-RS resource set configuration from the base station through upper layer signaling, and the configured offset value X may mean an offset between a slot that receives DCI triggering aperiodic CSI reporting and a slot in which a CSI-RS resource is transmitted. For example, an aperiodicTriggeringOffset parameter value and the offset value X may have a mapping relationship described in [Table 11].

TABLE 11

| aperiodicTriggeringOffset | Offset X | |
|---|---|---|
| 0 | 0 | slot |
| 1 | 1 | slot |
| 2 | 2 | slots |
| 3 | 3 | slots |
| 4 | 4 | slots |
| 5 | 16 | slots |
| 6 | 24 | slots |

The example 700 of FIG. 7 illustrates an example in which the above-described offset value is configured to X=0 (703). In this case, the UE may receive a CSI-RS 702 in a slot (corresponding to a slot 0, 706 of FIG. 7) that receives a DCI format 0_1 triggering aperiodic CSI reporting, and report CSI information measured with the received CSI-RS to the base station through the PUSCH 705. The UE may acquire scheduling information (information corresponding to each field of the above-described DCI format 0_1) on the PUSCH 705 for CSI reporting from the DCI format 0_1. As an example, the UE may acquire information on a slot to transmit the PUSCH 705 from the above-described time domain resource assignment information for the PUSCH 705 in the DCI format 0_1. In the example 700 of FIG. 7, the UE acquired a K2 value 704 corresponding to a slot offset value for PDCCH-to-PUSCH as 3, and accordingly, the PUSCH 705 may be transmitted in a slot 3, 709 separated by 3 slots from a slot 0, 706, a time point that receives the PDCCH 701.

In an example 710 of FIG. 7, the UE may monitor a PDCCH 711 to acquire a DCI format 0_1, and acquire scheduling information and CSI request information on a PUSCH 715 from this. The UE may acquire resource information on a CSI-RS 712 to be measured from the received CSI request indicator. The example 710 of FIG. 7 illustrates an example in which an offset value for the above-described CSI-RS is configured to X=1 (713). In this case, the UE may receive a CSI-RS 712 in a slot that receives the DCI format 0_1 that triggers the aperiodic CSI report (corresponding to a slot 0, 716 of FIG. 7), and report CSI information measured with the received CSI-RS to the base station through the PUSCH 715. The UE may acquire scheduling information (information corresponding to each field of the above-described DCI format 0_1) on the PUSCH 715 for CSI reporting from the DCI format 0_1. For example, the UE may acquire information on a slot to transmit the PUSCH 715 from the above-described time domain resource assignment information for the PUSCH 715 in the DCI format 0_1. In the example 710 of FIG. 7, the UE acquired a K2 value 714 corresponding to a slot offset value for PDCCH-to-PUSCH as 3, and accordingly, the PUSCH 715 may be transmitted in a slot 3, 719 separated by 3 slots from a slot 0, 716, a time point that receives the PDCCH 711.

An aperiodic CSI report may include at least one or both of a CSI part 1 and a CSI part 2, and in the case that the aperiodic CSI report is transmitted through a PUSCH, the aperiodic CSI report may be multiplexed with a transport block. For multiplexing, a CRC is inserted into input bits of the aperiodic CSI, and then encoded and rate matched, and then mapped to a resource element in the PUSCH in a specific pattern and transmitted. The CRC insertion may be omitted according to a coding method or a length of input bits. The number of modulation symbols calculated for rate matching when multiplexing the CSI Part 1 or CSI part 2 included in the aperiodic CSI report may be calculated as illustrated in [Table 12].

TABLE 12
For CSI part 1 transmission on PUSCH not using repetition type B with UL-SCH, the
number of coded modulation symbols per layer for CSI part 1 transmission, denoted as
Q_{CSI-part1}′, is determined as follows:
${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \\ ⌈ α \cdot {\sum }_{l = 0}^{{N}_{symb , all}^{PUSCH} - 1} {M}_{sc}^{UCI} ( l ) ⌉ - {Q}_{\frac{ACK}{CG} - UCI}^{′} \}$
. . .
For CSI part 1 transmission on an actual repetition of a PUSCH with repetition Type B with
UL-SCH, the number of coded modulation symbols per layer for CSI part 1 transmission,
denoted as Q_{CSI-part1}′, is determined as follows:
${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , \\ ⌈ α \cdot {\sum }_{l = 0}^{{N}_{symb , nominal}^{PUSCH} - 1} {M}_{sc , nominal}^{UCI} ( l ) ⌉ - {Q}_{\frac{ACK}{CG} - UCI}^{′} , {\sum }_{l = 0}^{{N}_{symb , actual}^{PUSCH} - 1} {M}_{sc , actual}^{UCI} ( l )$
. . .
For CSI part 1 transmission on PUSCH without UL-SCH, the number of coded modulation
symbols per layer for CSI part 1 transmission, denoted as Q_{CSI-part1}′, is determined as
follows:
if there is CSI part 2 to be transmitted on the PUSCH,
${Q}_{CSI - 1}^{′} = min \{ ⌈ \frac{( {O}_{CSI - 1} + {L}_{CSI - 1} ) \cdot {β}_{offset}^{PUSCH}}{R \cdot {Q}_{m}} ⌉ , {\sum }_{l = 0}^{{N}_{symb , all}^{PUSCH} - 1} {M}_{sc}^{UCI} ( l ) - {Q}_{ACK}^{′} \} \\ else \\ {Q}_{CSI - 1} = {\sum }_{l = 0}^{{N}_{symb , all}^{PUSCH} - 1} {M}_{sc}^{UCI} ( l ) - {Q}_{ACK}^{′} \\ end if$
. . .
For CSI part 2 transmission on PUSCH not using repetition type B with UL-SCH, the
number of coded modulation symbols per layer for CSI part 2 transmission, denoted as
Q_{CSI-part2}′, is determined as follows:
${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \\ ⌈ α \cdot {\sum }_{l = 0}^{{N}_{symb , all}^{PUSCH} - 1} {M}_{sc}^{UCI} ( l ) ⌉ - {Q}_{\frac{ACK}{CG} - UCI}^{′} - {Q}_{CSI - 1}^{′} \}$
For CSI part 2 transmission on an actual repetition of a PUSCH with repetition Type B with
UL-SCH, the number of coded modulation symbols per layer for CSI part 2 transmission,
denoted as Q_{CSI-part2}′, is determined as follows:
${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , \\ ⌈ α \cdot {\sum }_{l = 0}^{{N}_{symb , nominal}^{PUSCH} - 1} {M}_{sc , nominal}^{UCI} ( l ) ⌉ - {Q}_{\frac{ACK}{CG} - UCI}^{′} - {Q}_{CSI - 1}^{′} , \\ {\sum }_{l = 0}^{{N}_{symb , actual}^{PUSCH} - 1} {M}_{sc , actual}^{UCI} ( l ) - {Q}_{\frac{ACK}{CG} - UCI}^{′} - {Q}_{CSI - 1}^{′} \}$
. . .
For CSI part 2 transmission on PUSCH without UL-SCH, the number of coded modulation
symbols per layer for CSI part 2 transmission, denoted as Q_{CSI-part2}′, is determined as
follows:
${Q}_{CSI - 2}^{′} = {\sum }_{l = 0}^{{N}_{symb , all}^{PUSCH} - 1} {M}_{sc}^{UCI} ( l ) - {Q}_{ACK}^{′} - {Q}_{CSI - 1}^{′}$

In particular, in the case of PUSCH repetition transmission schemes A and B, the UE may multiplex and transmit an aperiodic CSI report only on first repetition transmission among PUSCH repetition transmissions. This is because aperiodic CSI report information to be multiplexed is encoded in a polar code manner, and in order to be multiplexed on multiple PUSCH repetitions, each PUSCH repetition may have the same frequency and time resource assignment, and in particular, in the case of the PUSCH repetition type B, each actual repetition may have a different OFDM symbol length; thus, the aperiodic CSI report may be multiplexed and transmitted only on first PUSCH repetition.

Further, for the PUSCH repetition transmission scheme B, in the case that the UE schedules aperiodic CSI reporting without scheduling for a transport block or receives DCI activating semi-persistent CSI reporting, even if the number of PUSCH repetition transmissions configured by upper layer signaling is greater than 1, a value of nominal repetition may be assumed to 1. Further, in the case that the UE schedules or activates aperiodic or semi-persistent CSI reporting without scheduling for a transport block based on the PUSCH repetition transmission scheme B, the UE may expect that first nominal repetition may be the same as first actual repetition. For a PUSCH transmitted including semi-persistent CSI based on the PUSCH repetition transmission scheme B without scheduling for DCI after semi-persistent CSI reporting is activated by the DCI, if first nominal repetition is different from first actual repetition, transmission for the first nominal repetition may be ignored.

### [CSI Computation Time]

In the case that the base station instructs the UE to perform an aperiodic CSI report or a semi-persistent CSI report through DCI, the UE may determine whether the UE may perform valid channel reporting through the instructed CSI report in consideration of a channel computation time required for the CSI report. For the aperiodic CSI report or the semi-persistent CSI report instructed through DCI, the UE may perform a valid CSI report from an uplink symbol after a Z symbol after a last symbol included in the PDCCH including the DCI instructing the CSI report ends, and the above-described Z symbol may vary according to numerology of a downlink bandwidth part corresponding to the PDCCH including the DCI instructing the CSI report, numerology of an uplink bandwidth part corresponding to the PUSCH transmitting the CSI report, and the type or characteristic (report quantity, frequency band granularity, number of ports of a reference signal, codebook type, and the like) of channel information reported in the CSI report. In other words, in order to determine a CSI report as a valid CSI report (if the corresponding CSI report is a valid CSI report), uplink transmission of the corresponding CSI report may not be performed prior to a Zref symbol including timing advance. In this case, the Zref symbol is an uplink symbol starting a cyclic prefix (CP) after a time T_{proc,CSI}=(Z)(2048+144)·κ2^{-∥}·T_{C} from the moment that a last symbol of the triggering PDCCH ends. Here, a detailed value of Z follows the following description,

$${T}_{c} = \frac{1}{Δ {f}_{max} \cdot {N}_{f}} f\_max = 480 \cdot 10 \hat{} 3 Hz , {N}_{f} = 4096 , κ = 64 ,$$

and μ is numerology. In this case, μ may be promised to use one causing the largest T_{proc,CSI} value among (μ_{PDCCH}, μ_{CSI-RS}, μ_{UL}), μ_{PDCCH} may mean a subcarrier spacing used for PDCCH transmission, μ_{CSI-RS} may mean a subcarrier spacing used for CSI-RS transmission, and μ_{UL} may mean a subcarrier spacing of an uplink channel used for uplink control information (UCI) transmission for CSI reporting. As another example, μ may be promised to use one causing the largest T_{proc,CSI} value among (μ_{PDCCH}, μ_{UL}). Definitions of μ_{PDCCH} and μ_{UL} refer to the above description. For convenience of future description, satisfying the above condition is referred to as satisfying a CSI reporting validity condition 1.

Further, in the case that the reference signal for channel measurement for an aperiodic CSI report instructed to the UE through DCI is an aperiodic reference signal, a valid CSI report may be performed from an uplink symbol after a Z′ symbol after a last symbol including the reference signal ends, and the above-described Z′ symbol may vary according to numerology of a downlink bandwidth part to which the PDCCH including DCI instructing the CSI report corresponds, numerology of a bandwidth to which the reference signal for channel measurement for the CSI report corresponds, numerology of an uplink bandwidth part to which the PUSCH transmitting the CSI report corresponds, and the type or characteristic (report quantity, frequency band granularity, number of ports of the reference signal, codebook type, and the like) of channel information to be reported in the CSI report. In other words, in order to determine a CSI report as a valid CSI report (if the corresponding CSI report is a valid CSI report), uplink transmission of the corresponding CSI report may not be performed prior to a Zref symbol including timing advance. In this case, the Zref symbol is an uplink symbol that starts a cyclic prefix (CP) after a time T_{proc,CSI}′=(Z′)(2048+144)·κ2^{-μ}·T_{C} from the moment that a last symbol of an aperiodic CSI-RS or aperiodic CSI-IM triggered by the triggering PDCCH ends. Here, a detailed value of Z′ follows the following description,

$${T}_{c} = \frac{1}{Δ {f}_{max} \cdot {N}_{f}} f\_max = 480 \cdot 10 \hat{} 3 Hz , {N}_{f} = 4096 , κ = 64 ,$$

and μ is numerology. In this case, μ may be promised to use one causing a largest T_{proc,CSI} value among (μ_{PDCCH}, μ_{CSI-RS}, μ_{UL}), μ_{PDCCH} may mean a subcarrier spacing used for triggering PDCCH transmission, μ_{CSI-RS} may mean a subcarrier spacing used for CSI-RS transmission, and μ_{UL} may mean a subcarrier spacing of an uplink channel used for uplink control information (UCI) transmission for CSI reporting. As another example, μ may be promised to use one causing a largest T_{proc,CSI} value among (μ_{PDCCH}, μ_{UL}). In this case, definitions of μ_{PDCCH} and μ_{UL} refer to the above description. For convenience of future description, satisfying the above condition is referred to as satisfying a CSI reporting validity condition 2.

In the case that the base station instructs the UE to perform an aperiodic CSI report for an aperiodic reference signal through DCI, the UE may perform a valid CSI report from a first uplink symbol satisfying both the time point after a Z symbol after a last symbol included in the PDCCH including DCI instructing the CSI report ends and the time point after a Z′ symbol after a last symbol including the reference signal ends. That is, in the case of aperiodic CSI reporting based on the aperiodic reference signal, when satisfying both CSI reporting validity conditions 1 and 2, it is determined as a valid CSI report.

In the case that the CSI report time point instructed by the base station does not satisfy CSI computation time requirement, the UE may determine the corresponding CSI report as invalid and may not consider updating the channel information state for the CSI report.

The Z, Z′ symbols for calculating the CSI computation time described above follow [Table 13] and [Table 14]. For example, in the case that channel information reported in the CSI report includes only wideband information and that the number of ports of the reference signal is 4 or less and that there is one reference signal resource and that the codebook type is “typeI-SinglePanel” or a type (report quantity) of reporting channel information is “cri-RI-CQI,” the Z, Z′ symbols follow Z₁, Z₁′ values of [Table 14]. Hereinafter, this is referred to as delay requirement 2. Further, in the case that the PUSCH including the CSI report does not include a TB or HARQ-ACK and that a CPU occupation of the UE is 0, the Z, Z′ symbols follow the Z₁, Z₁′ values of [Table 13], and this is referred to as delay requirement 1. The CPU occupation described above is described in detail below. Further, in the case that the report quantity is “cri-RSRP” or “ssb-Index-RSRP,” the Z, Z′ symbols follow Z₃, Z₃′ values of [Table 14]. X1, X2, X3, and X4 of [Table 14] represent a UE capability for the beam reporting time, and KB1 and KB2 of [Table 14] represent a UE capability for the beam change time. In the case that the Z, Z′ symbols do not correspond to the type or characteristic of channel information reported in the above-described CSI report, the Z, Z′ symbols follow Z₂, Z₂′ values of [Table 14].

TABLE 13

Z₁ [symbols]

| μ | Z₁ | Z′₁ |
|---|---|---|
| 0 | 10 | 8 |
| 1 | 13 | 11 |
| 2 | 25 | 21 |
| 3 | 43 | 36 |

TABLE 14

| | Z₁ [symbols] | | Z₂ [symbols] | | Z₃ [symbols] | |
|---|---|---|---|---|---|---|
| μ | Z₁ | Z′₁ | Z₂ | Z′₂ | Z₃ | Z′₃ |
| 0 | 22 | 16 | 40 | 37 | 22 | X₁ |
| 1 | 33 | 30 | 72 | 69 | 33 | X₂ |
| 2 | 44 | 42 | 141 | 140 | min(44, X₃ + KB₁) | X₃ |
| 3 | 97 | 85 | 152 | 140 | min(97, X₄ + KB₂) | X₄ |

### [CSI Reference Resource]

When the base station instructs the UE to perform an aperiodic/semi-persistent/periodic CSI report, the base station may configure a CSI reference resource in order to determine a reference time and frequency for a channel to be reported in the CSI report. A frequency of the CSI reference resource may be information on a carrier and subband to measure CSI, which are indicated in the CSI report configuration, and these may correspond to the carrier and reportFreqConfiguration, respectively in CSI-ReportConfig, which is upper layer signaling. The time of the CSI reference resource may be defined based on the time at which the CSI report is transmitted. For example, in the case of instructing to transmit a CSI report #X in an uplink slot n′ of the carrier and BWP where the CSI report is to be transmitted, the time of the CSI reference resource of the CSI report #X may be defined as a downlink slot n-nCSI-ref of the carrier and BWP that measure CSI. The downlink slot n is calculated as

$$n = ⌊ {n}^{′} \cdot {2}^{{μ}_{DL}} / {2}^{{μ}_{UL}} ⌋ ,$$

when numerology of the carrier and BWP that measures CSI is denoted as μDL and numerology of the carrier and BWP that transmits the CSI report #X is denoted as μUL. A slot interval nCSI-ref between the downlink slot n and the CSI reference signal follows n_{CSI-ref}=4·2^{μ}^{_{DL}} in the case that a single CSI-RS/SSB resource is connected to the corresponding CSI report and follows n_{CSI-ref}=5·2^{μ}^{_{DL}} in the case that multiple CSI-RS/SSB resources are connected to the corresponding CSI report according to the number of CSI-RS/SSB resources for channel measurement, in the case that a CSI report #X transmitted in the uplink slot n′ is a semi-persistent or periodic CSI report. In the case that the CSI report #X transmitted in the uplink slot n′ is an aperiodic CSI report, it is calculated as

$${n}_{CSI - ref} = ⌊ \frac{{Z}^{′}}{{N}_{symb}^{slot}} ⌋$$

in consideration of a CSI computation time Z′ for channel measurement. The above-described N_{symb}^{slot} is the number of symbols included in one slot, and in NR, it is assumed as N_{symb}^{slot}=14.

In the case that the base station instructs the UE to transmit a CSI report in an uplink slot n′ through upper layer signaling or DCI, the UE may report CSI by performing channel measurement or interference measurement on a CSI-RS resource, CSI-IM resource, or SSB resource transmitted no later than a CSI reference resource slot of the CSI report transmitted in the uplink slot n′ among a CSI-RS resource or a CSI-IM or SSB resource associated with the corresponding CSI report. The CSI-RS resource, CSI-IM resource, or SSB resource associated with the corresponding CSI report may mean a CSI-RS resource, CSI-IM resource, or SSB resource included in a resource set configured in a resource setting referenced by a report setting for a CSI report of the UE configured through upper layer signaling, a CSI-RS resource, CSI-IM resource, or SSB resource referenced by a CSI report trigger state including parameters for the corresponding CSI report, or a CSI-RS resource, CSI-IM resource, or SSB resource indicated by an ID of a reference signal (RS) set.

In the embodiments of the disclosure, a CSI-RS/CSI-IM/SSB occasion means a transmission time point of CSI-RS/CSI-IM/SSB resource(s) determined by a higher layer configuration or a combination of a higher layer configuration and DCI triggering. For example, in a semi-persistent or periodic CSI-RS resource, a slot to be transmitted is determined according to a slot period and slot offset configured by higher layer signaling, and a transmission symbol(s) within the slot is(are) determined according to resource mapping information (resourceMapping). As another example, in an aperiodic CSI-RS resource, a slot to be transmitted is determined according to a slot offset with a PDCCH including DCI indicating channel reporting configured by higher layer signaling, and a transmission symbol(s) within the slot is(are) determined according to resource mapping information.

The above-described CSI-RS occasion may be determined by independently considering a transmission time point of each CSI-RS resource or comprehensively considering the transmission time point of one or more CSI-RS resource(s) included in the resource set, and accordingly, the following two interpretations are possible for the CSI-RS occasion according to each resource set configuration.
Interpretation 1-1: Among one or more CSI-RS resources included in the resource set(s) configured in the resource setting referenced by the report setting configured for the CSI report, from a start time point of an earliest symbol to an end time point of a latest symbol in which one specific resource is transmitted.
Interpretation 1-2: Among all CSI-RS resources included in a resource set(s) configured in the resource setting referenced by the report setting configured for the CSI report, from a start time point of an earliest symbol transmitted by the CSI-RS resource transmitted at an earliest time point to an end time point of a latest symbol transmitted by the CSI-RS resource transmitted at a latest time point

Hereinafter, in the embodiments of the disclosure, it is possible to consider both interpretations of the CSI-RS occasion and apply them individually. Further, it is possible to consider both interpretations of the CSI-IM occasion and the SSB occasion, as in the CSI-RS occasion, but because the principle thereof is similar to the description above, a redundant description thereof will be omitted below.

In the embodiments of the disclosure, a “CSI-RS/CSI-IM/SSB occasion” for a CSI report #X transmitted in an “uplink slot n” means a set of a CSI-RS occasion, CSI-IM occasion, and SSB occasion not later than the CSI reference resource of a CSI report #X transmitted in the “uplink slot n” among the CSI-RS occasion, CSI-IM occasion, and SSB occasion of a CSI-RS resource, CSI-IM resource, and SSB resource included in a resource set configured in a resource setting referenced by a report setting configured for the CSI report #X.

In the embodiments of the disclosure, the latest CSI-RS/CSI-IM/SSB occasion among CSI-RS/CSI-IM/SSB occasions for a CSI report #X transmitted in an uplink slot n′ may be interpreted in the following two ways.
Interpretation 2-1: A set of occasions including the latest CSI-RS occasion among CSI-RS occasions for a CSI report #X transmitted in an uplink slot n′, the latest CSI-IM occasion among CSI-RS occasions for a CSI report #X transmitted in an uplink slot n′, and the latest SSB occasion among SSB occasions for a CSI report #0 transmitted in an uplink slot n′.
Interpretation 2-2: The latest occasion among all CSI-RS occasion, CSI-IM occasion, and SSB occasion for a CSI report #X transmitted in an uplink slot n′.

Hereinafter, in embodiments of the disclosure, it is possible to individually apply “the latest CSI-RS/CSI-IM/SSB occasion among CSI-RS/CSI-IM/SSB occasions for a CSI report #X transmitted in an “uplink slot n′” in consideration of both interpretations. Further, considering the above-described two interpretations (Interpretation 1-1, Interpretation 1-2) for the CSI-RS occasion, CSI-IM occasion, and SSB occasion, in embodiments of the disclosure, it is possible to individually apply the “latest CSI-RS/CSI-IM/SSB occasion among CSI-RS/CSI-IM/SSB occasions for a CSI report #X transmitted in an “uplink slot n′” in consideration of all four different interpretations (applying Interpretation 1-1 and Interpretation 2-1, applying Interpretation 1-1 and Interpretation 2-2, applying Interpretation 1-2 and Interpretation 2-1, applying Interpretation 1-2 and Interpretation 2-2).

The base station may instruct a CSI report in consideration of an amount of channel information in which the UE may calculate simultaneously for the CSI report, i.e., the number of channel information calculation units (CSI processors (CPUs)) of the UE. When the number of CPUs in which the UE may calculate simultaneously is N_{CPU}, the UE may not expect a CSI report instruction from the base station requiring more channel information calculations than N_{CPU} or may not consider an update of channel information requiring more channel information calculations than N_{CPU}·N_{CPU} may be reported by the UE to the base station through upper layer signaling or may be configured by the base station through upper layer signaling.

It is assumed that the CSI report instructed by the base station to the UE occupies some or all of the CPU for channel information calculation among the total number N_CPU of channel information in which the UE may calculate simultaneously. For each CSI report, for example, when the number of CPUs required for CSI report n (n=0, 1, . . . , N−1) is O_{CPU}⁽ⁿ⁾, the number of CPUs required for the total N number of CSI reports may be Σₙ₌₀^{N-1}O_{CPU}⁽ⁿ⁾. CPUs required for each reportQuantity configured in the CSI report may be configured as illustrated in [Table 15].

```
TABLE 15
- O_{CPU}⁽ⁿ⁾ = 0 : The case that the reportQuantity configured in the CSI report is configured to
  “none” and that trs-Info is configured to the CSI-RS resource set connected to the CSI
  report
- O_{CPU}⁽ⁿ⁾ = 1 : The case that the reportQuantity configured in the CSI report is configured to
  “none,” “cri-RSRP,” or “ssb-Index-RSRP” and that trs-Info is not configured to the CSI-
  RS resource set connected to the CSI report
- The case that the reportQuantity configured in the CSI report is configured to “cri-RI-PMI-
  CQI,” “cri-RI-i1,” “cri-RI-i1-CQI,” “cri-RI-CQI,” or “cri-RI-LI-PMI-CQI”
>> O_{CPU}⁽ⁿ⁾ = N_{CPU} : The case that an aperiodic CSI report is triggered and that the
    corresponding CSI report is not multiplexed with one or both of TB/HARQ-ACK, the
    corresponding CSI report is wideband CSI, corresponds to maximum 4 CSI-RS ports,
    corresponds to a single resource without a CRI report, and codebookType corresponds
    to “typeI-SinglePanel” or reportQuantity corresponds to “cri-RI-CQI.”
    (The corresponding case corresponds to the above-described delay requirement 1, and
    may be seen as the case that the UE uses all available CPUs to quickly calculate and
    report CSI.)
>> O_{CPU}⁽ⁿ⁾ = Kₛ : All other cases except for the above case. Kₛ indicates the number of CSI-
    RS resources in the CSI-RS resource set for channel measurement.
```

In the case that the number of channel information calculations required by the UE for multiple CSI reports at a specific time point is greater than the number N_{CPU} of CPUs in which the UE may calculate simultaneously, the UE may not consider updating channel information for some CSI reports. Among the multiple instructed CSI reports, CSI reports that do not consider updating channel information are determined in consideration of the time in which channel information calculation required for at least CSI report occupies the CPU and the priority of reporting channel information. For example, channel information calculation required for the CSI report may not consider updating channel information for the CSI report initiated at the latest time point of the time occupying the CPU, and it is possible to not preferentially consider updating channel information for a CSI report having a low channel information priority.

The priority of the above channel information may be determined with reference to [Table 16].

```
TABLE 16
CSI priority value Pri_{iCSI}(y, k, c, s) = 2 · N_{cells} · Mₛ · y + N_{cells} · Mₛ · k + Mₛ · c + s,
  - y = 0 the case of aperiodic CSI report transmitted through PUSCH, y = 1 the case of
  semi-persistent CSI report transmitted through PUSCH, y = 2 the case of semi-
  persistent CSI report transmitted through PUCCH, y = 3 the case of periodic CSI
  report transmitted through PUCCH;
  - k = 0 the case that CSI report includes L1-RSRP, k = 1 the case that CSI report does
  not include L1-RSRP;
  - c : Serving cell index, N_{cells} : Maximum number of serving cells configured by upper
  layer signaling (maxNrofServingCells);
  - s : CSI report configuration index (reportConfigID), Mₛ: Maximum number of CSI
  report configurations configured by upper layer signaling (maxNrofCSI-
  ReportConfigurations).
```

The CSI priority for a CSI report is determined through the priority value PriiCSI(y,k,c,s) in [Table 16]. With reference to [Table 16], the CSI priority value is determined through the type of channel information included in the CSI report, time axis reporting characteristics (aperiodic, semi-persistent, periodic) of the CSI report, a channel (PUSCH, PUCCH) through which the CSI report is transmitted, a serving cell index, and a CSI report configuration index. The CSI priority of the CSI report determines that a CSI priority of a CSI report with a smaller priority value is high by comparing the priority values PriiCSI (y,k,c,s).

When the time occupied by the CPU to calculate channel information required for the CSI report instructed by the base station to the UE is a CPU occupation time, the CPU occupation time is determined in consideration of part or all of the type (report quantity) of channel information included in the CSI report, time axis characteristics (aperiodic, semi-persistent, periodic) of the CSI report, a slot or symbol occupied by upper layer signaling or DCI instructing the CSI report, and the slot or symbol occupied by the reference signal for channel state measurement.

### [PDCCH: Related to DCI]

Hereinafter, downlink control information (DCI) in a 5G system will be described in detail.

In the 5G system, scheduling information on uplink data (or physical uplink shared channel (PUSCH)) or downlink data (or physical downlink shared channel (PDSCH)) is transmitted from the base station to the UE through DCI. The UE may monitor a DCI format for fallback and a DCI format for non-fallback with respect to the PUSCH or PDSCH. The DCI format for fallback may be composed of a fixed field predefined between the base station and the UE, and the DCI format for non-fallback may include a configurable field.

The DCI may be transmitted through a physical downlink control channel (PDCCH) via channel coding and modulation processes. A cyclic redundancy check (CRC) is attached to a DCI message payload, and the CRC may be scrambled with a radio network temporary identifier (RNTI) corresponding to the identity of the UE. Different RNTIs may be used according to the purpose of the DCI message, for example, UE-specific data transmission, power control command, or random access response. That is, the RNTI is not explicitly transmitted but is included in a CRC calculation process and transmitted. Upon receiving the DCI message transmitted on the PDCCH, the UE may identify the CRC using the allocated RNTI, and when the CRC identification result is correct, the UE may know that the corresponding message has been transmitted to the UE.

For example, DCI scheduling a PDSCH for system information (SI) may be scrambled with an SI-RNTI. DCI scheduling a PDSCH for a random access response (RAR) message may be scrambled with an RA-RNTI. DCI scheduling a PDSCH for a paging message may be scrambled with a P-RNTI. DCI notifying a slot format indicator (SFI) may be scrambled with an SFI-RNTI. DCI notifying transmit power control (TPC) may be scrambled with a TPC-RNTI. DCI scheduling a UE-specific PDSCH or PUSCH may be scrambled with a cell RNTI (C-RNTI).

A DCI format 0_0 may be used as fallback DCI scheduling a PUSCH, and in this case, a CRC may be scrambled with a C-RNTI. The DCI format 0_0 in which a CRC is scrambled with a C-RNTI may include, for example, information of Table 17.

TABLE 17
Identifier for DCI formats-[1] bit
$\begin{matrix}Frequency domain \\ resource assignment\end{matrix} = [ ⌈ {log}_{2} ( \frac{{N}_{RB}^{UL , BWP} ( {N}_{RB}^{UL , BWP} + 1 )}{2} ) ⌉ ] its$
Time domain resource assignment-X bits
Frequency hopping flag-1 bit.
Modulation and coding scheme-5 bits
New data indicator-1 bit
Redundancy version-2 bits
HARQ process number-4 bits
TPC (transmit power control) command for scheduled PUSCH-[2] bits
UL/SUL (supplementary UL) indicator-0 or 1 bit

A DCI format 0_1 may be used as non-fallback DCI scheduling a PUSCH, and in this case, a CRC may be scrambled with a C-RNTI. The DCI format 0_1 in which a CRC is scrambled with a C-RNTI may include, for example, information of Table 18.

```
TABLE 18
  Carrier indicator-0 or 3 bits
  UL/SUL indicator-0 or 1 bit
  Identifier for DCI formats-[1] bits
  Bandwidth part indicator-0, 1 or 2 bits
  Frequency domain resource assignment
    $For resource allocation type 0 , ⌈ \frac{{N}_{RB}^{UL , BWP}}{P} ⌉ bits$
    $For resource allocation type 1 , ⌈ {log}_{2} ( \frac{{N}_{RB}^{UL , BWP} ( {N}_{RB}^{UL , BWP} + 1 )}{2} ) ⌉ ts$
  Time domain resource assignment-1, 2, 3, or 4 bits
  VRB (virtual resource block)-to-PRB (physical resource block)
  mapping-0
  or 1 bit, only for resource allocation type 1.
    0 bit if only resource allocation type 0 is configured;
    1 bit otherwise.
  Frequency hopping flag-0 or 1 bit, only for resource allocation type 1.
    0 bit if only resource allocation type 0 is configured;
    1 bit otherwise.
  Modulation and coding scheme-5 bits
  New data indicator-1 bit
  Redundancy version-2 bits
  HARQ process number-4 bits
  1st downlink assignment index-1 or 2 bits
    1 bit for semi-static HARQ-ACK codebook;
    2 bits for dynamic HARQ-ACK codebook with single HARQ-ACK
    codebook.
  2nd downlink assignment index-0 or 2 bits
    2 bits for dynamic HARQ-ACK codebook with two HARQ-ACK
    sub-codebooks;
    0 bit otherwise.
  TPC command for scheduled PUSCH-2 bits
  SRS [symbol]     indicator
$⌈ {log}_{2} ( {\sum }_{k = 1}^{{L}_{max Σ}} ( \begin{matrix}{N}_{SRS} \\ k\end{matrix} ) ( ) ) ⌉ log 〛 \_ 2 ( N\_ “ SRS ” ) ⌉ bits$
    $⌈ {log}_{2} ( {\sum }_{k = 1}^{{L}_{max Σ}} ( \begin{matrix}{N}_{SRS} \\ k\end{matrix} ) ( ) ) ▯▯ ⌉ \text{for noncodebook based PUSCH}$
    transmission;
    [log2(N_{SRS}) Its for codebook based PUSCH transmission.
  Precoding information and number of layers-up to 6 bits
  Antenna ports-up to 5 bits
  SRS request-2 bits
  CSI request-0, 1, 2, 3, 4, 5, or 6 bits
  CBG (code block group) transmission information-0, 2, 4, 6, or 8 bits
  PTRS-DMRS association-0 or 2 bits.
  beta offset indicator-0 or 2 bits
  DMRS sequence initialization-0 or 1 bit
```

A DCI format 1_0 may be used as fallback DCI scheduling a PDSCH, and in this case, a CRC may be scrambled with a C-RNTI. The DCI format 1_0 in which a CRC is scrambled with a C-RNTI may include, for example, information of Table 19.

TABLE 19
Identifier for DCI formats-[1] bit
$\begin{matrix}Frequency domain \\ resource assignment\end{matrix} - [ ⌈ {log}_{2} ( \frac{{N}_{RB}^{DL , BWP} ( {N}_{RB}^{DL , BWP} + 1 )}{2} ) ⌉ ] its$
Time domain resource assignment-X bits
VRB-to-PRB mapping-1 bit.
Modulation and coding scheme-5 bits
New data indicator-1 bit
Redundancy version-2 bits
HARQ process number-4 bits
Downlink assignment index-2 bits
TPC command for scheduled PUCCH-[2] bits
PUCCH (physical uplink control channel) resource indicator-3 bits
PDSCH-to-HARQ feedback timing indicator-[3] bits

A DCI format 1_1 may be used as non-fallback DCI scheduling a PDSCH, and in this case, a CRC may be scrambled with a C-RNTI. The DCI format 1_1 in which a CRC is scrambled with a C-RNTI may include, for example, information of Table 20.

```
TABLE 20
  Carrier indicator-0 or 3 bits
  Identifier for DCI formats-[1] bits
  Bandwidth part indicator-0, 1 or 2 bits
  Frequency domain resource assignment
    $For resource allocation type 0 , ⌈ \frac{{N}_{RB}^{DL , BWP}}{P} ⌉ bits$
    $For resource allocation type 1 , ⌈ {log}_{2} ( \frac{{N}_{RB}^{DL , BWP} ( {N}_{RB}^{DL , BWP} + 1 )}{2} ) ⌉ ts$
  Time domain resource assignment-1, 2, 3, or 4 bits
  VRB-to-PRB mapping-0 or 1 bit, only for resource allocation type 1.
    0 bit if only resource allocation type 0 is configured;
    1 bit otherwise.
  PRB bundling size indicator-0 or 1 bit
  Rate matching indicator-0, 1, or 2 bits
  ZP CSI-RS trigger-0, 1, or 2 bits
For transport block 1:
  Modulation and coding scheme-5 bits
  New data indicator-1 bit
  Redundancy version-2 bits
For transport block 2:
  Modulation and coding scheme-5 bits
  New data indicator-1 bit
  Redundancy version-2 bits
  HARQ process number-4 bits
  Downlink assignment index-0 or 2 or 4 bits
  TPC command for scheduled PUCCH-2 bits
  PUCCH resource indicator-3 bits
  PDSCH-to-HARQ_feedback timing indicator-3 bits
  Antenna ports-4, 5 or 6 bits
  Transmission configuration indication-0 or 3 bits
  SRS request-2 bits
  CBG transmission information-0, 2, 4, 6, or 8 bits
  CBG flushing out information-0 or 1 bit
  DMRS sequence initialization-1 bit
```

### [PDCCH: CORESET, REG, CCE, Search Space]

Hereinafter, a downlink control channel in a 5G communication system will be described in more detail with reference to the drawings.

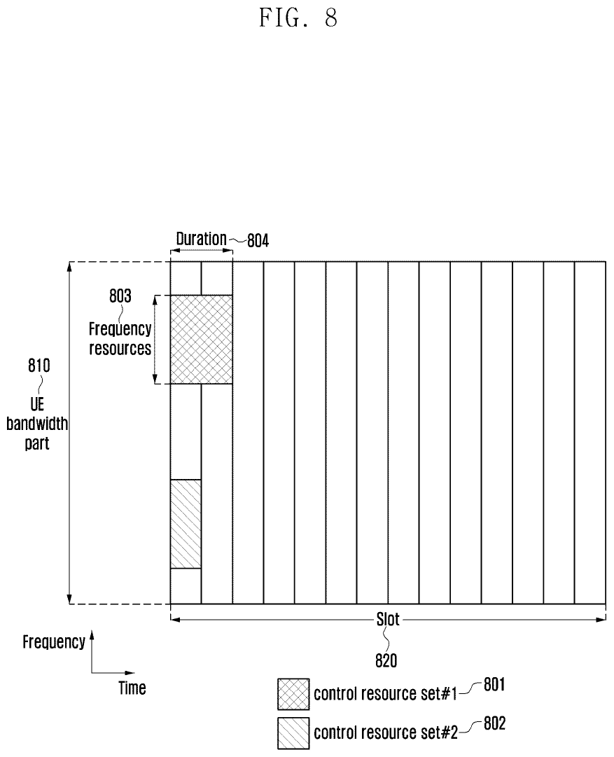

FIG. 8 illustrates an example of a control area (control resource set (CORESET)) in which a downlink control channel is transmitted in a 5G wireless communication system. FIG. 8 illustrates an example in which a UE bandwidth part 810 is configured in the frequency axis and in which two CORESETs (CORESET #1, 801 and CORESET #2, 802) are configured within 1 slot 820 in the time axis. The CORESETs 801 and 802 may be configured to a specific frequency resource 803 within the entire UE bandwidth part 810 in the frequency axis. One or a plurality of OFDM symbols may be configured to the time axis, and this may be defined to a control resource set duration 804. With reference to the illustrated example of FIG. 8, the CORESET #1, 801 is configured to a control resource set duration of 2 symbols, and the CORESET #2, 802 is configured to a control resource set duration of 1 symbol.

The CORESET in the above-described 5G may be configured by the base station to the UE through higher layer signaling (e.g., system information, master information block (MIB), radio resource control (RRC) signaling). Configuring the CORESET to the UE means providing information such as a CORESET identity, a frequency location of the CORESET, and a symbol length of the CORESET. For example, the CORESET may include information of Table 21.

TABLE 21

| | |
|---|---|
| ControlResourceSet ::= | SEQUENCE { |

-- Corresponds to L1 parameter “CORESET-ID”

| | |
|---|---|
| controlResourceSetId | ControlResourceSetId, |

(control domain identity)

| | |
|---|---|
| frequencyDomainResources | BIT STRING (SIZE (45)), |

(frequency axis resource assignment information)

| | |
|---|---|
| duration | INTEGER (1..maxCoReSetDuration), |

(time axis resource assignment information)

| | |
|---|---|
| cce-REG-MappingType | CHOICE { |

(CCE-to-REG mapping type)

| | |
|---|---|
| interleaved | SEQUENCE { |
| reg-BundleSize | ENUMERATED {n2, n3, n6}, |

(REG bundle size)

| | |
|---|---|
| precoderGranularity | ENUMERATED {sameAsREG- |

bundle, allContiguousRBs},

| | |
|---|---|
| interleaverSize | ENUMERATED {n2, n3, n6} |

```
      (Interleaver size)
      shiftIndex
      INTEGER(0..maxNrofPhysicalResourceBlocks-1)
        OPTIONAL
    (Interleaver shift)
  },
```

| | |
|---|---|
| nonInterleaved | NULL |

},

| | |
|---|---|
| tci-StatesPDCCH | SEQUENCE(SIZE (1..maxNrofTCI- |
| StatesPDCCH)) OF TCI-StateId | OPTIONAL, |

(QCL configuration information)

| | |
|---|---|
| tci-PresentInDCI | ENUMERATED {enabled} |
| | OPTIONAL, -- Need S |

}

In Table 21, tci-StatesPDCCH (simply referred to as a transmission configuration indication (TCI) state) configuration information may include one or a plurality of synchronization signal (SS)/physical broadcast channel (PBCH) block index or channel state information reference signal (CSI-RS) index information in a quasi co located (QCL) relationship with a DMRS transmitted in the corresponding CORESET.

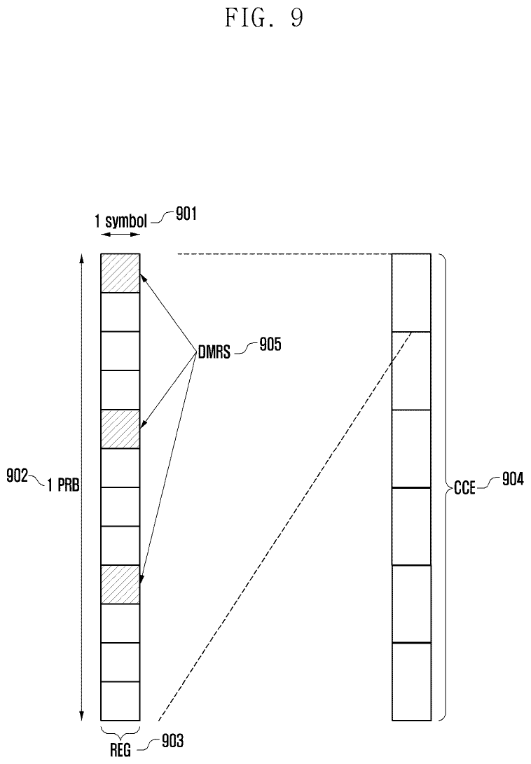

FIG. 9 illustrates an example of a basic unit of time and frequency resources constituting a downlink control channel that may be used in 5G. With reference to FIG. 9, a basic unit of time and frequency resources constituting a control channel may be referred to as a resource element group (REG) 903, and the REG 903 may be defined to 1 OFDM symbol 901 in the time axis and 1 physical resource block (PRB) 902 in the frequency axis, that is, 12 subcarriers. The base station may concatenate the REG 903 to constitute a downlink control channel allocation unit.

As illustrated in FIG. 9, in the case that a basic unit to which a downlink control channel is allocated in 5G is a control channel element (CCE) 904, 1 CCE 904 may be composed of a plurality of REGs 903. When the REG 903 illustrated in FIG. 9 is described as an example, the REG 903 may be composed of 12 REs, and when 1 CCE 904 is composed of 6 REGs 903, 1 CCE 904 may be composed of 72 REs. When a downlink control area is configured, the corresponding area may be composed of a plurality of CCEs 904, and a specific downlink control channel may be mapped and transmitted to one or a plurality of CCEs 904 according to an aggregation level (AL) in the control area. The CCEs 904 in the control area are identified by numbers, and in this case, the numbers of the CCEs 904 may be given according to a logical mapping method.

The basic unit of the downlink control channel illustrated in FIG. 9, that is, the REG 903 may include both REs to which DCI is mapped and an area to which a DMRS 905, which is a reference signal for decoding them, is mapped. As illustrated in FIG. 9, three DMRSs 905 may be transmitted within one REG 903. The number of CCEs required to transmit the PDCCH may be 1, 2, 4, 8, or 16 according to an aggregation level (AL), and the numbers of different CCEs may be used for implementing link adaptation of the downlink control channel. For example, in the case that AL=L, one downlink control channel may be transmitted through the L number of CCEs. The UE may detect a signal without knowing information on a downlink control channel, and a search space representing a set of CCEs is defined for blind decoding. The search space is a set of downlink control channel candidates consisting of CCEs in which the UE may attempt to decode on a given aggregation level, and because there are various aggregations levels that make one group with 1, 2, 4, 8, and 16 CCEs, the UE may have a plurality of search spaces. A search space set may be defined as a set of search spaces in all configured aggregation levels.

The search space may be classified into a common search space and a UE-specific search space. In order to receive cell common control information such as dynamic scheduling for system information or paging messages, a certain group of UEs or all UEs may search for the common search space of the PDCCH. For example, PDSCH scheduling allocation information for transmission of an SIB including cell operator information may be received by searching for the common search space of the PDCCH. In the case of a common search space, because a certain group of UEs or all UEs may receive the PDCCH, the common search space may be defined as a set of pre-promised CCEs. Scheduling allocation information on the UE-specific PDSCH or PUSCH may be received by searching for the UE-specific search space of the PDCCH. The UE-specific search space may be defined UE-specifically as a function of various system parameters and the identity of the UE.

In 5G, a parameter for a search space for a PDCCH may be configured from the base station to the UE through higher layer signaling (e.g., SIB, MIB, RRC signaling). For example, the base station may configure the number of PDCCH candidates at each aggregation level L, a monitoring period for the search space, a monitoring occasion in units of a symbol within a slot for the search space, a search space type (common search space or UE-specific search space), a combination of a DCI format and a radio network temporary identifier (RNTI) to be monitored in a corresponding search space, and a CORESET index to monitor a search space to the UE. For example, the parameter for the search space for the PDCCH may include information of Table 22.

TABLE 22

| | |
|---|---|
| SearchSpace ::= | SEQUENCE { |

```
  -- Identity of the search space. SearchSpaceId = 0 identifies the SearchSpace
    configured via PBCH (MIB) or ServingCellConfigCommon.
```

| | |
|---|---|
| searchSpaceId | SearchSpaceId, |

(search space identifier)

| | |
|---|---|
| controlResourceSetId | ControlResourceSetId, |

(control domain identifier)

| | |
|---|---|
| monitoringSlotPeriodicityAndOffset | CHOICE { |

(monitoring slot level period)

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |

}

OPTIONAL,

duration(monitoring length) INTEGER (2..2559)

| | |
|---|---|
| monitoringSymbolsWithinSlot | BIT STRING (SIZE (14)) |
| | OPTIONAL, |

(monitoring symbol within slot)

| | |
|---|---|
| nrofCandidates | SEQUENCE { |

(Number of PDCCH candidates for each aggregation level)

| | |
|---|---|
| aggregationLevel1 | ENUMERATED {n0, n1, n2, n3, n4, |

n5, n6, n8},

| | |
|---|---|
| aggregationLevel2 | ENUMERATED {n0, n1, n2, n3, n4, |

n5, n6, n8},

| | |
|---|---|
| aggregationLevel4 | ENUMERATED {n0, n1, n2, n3, n4, |

n5, n6, n8},

| | |
|---|---|
| aggregationLevel8 | ENUMERATED {n0, n1, n2, n3, n4, |

n5, n6, n8},

| | |
|---|---|
| aggregationLevel16 | ENUMERATED {n0, n1, n2, n3, n4, |

```
    n5, n6, n8}
  },
```

| | |
|---|---|
| searchSpaceType | CHOICE { |

```
  (search space type)
    -- Configures this search space as common search space (CSS) and DCI formats
    to monitor.
```

| | |
|---|---|
| common | SEQUENCE { |

```
    (common search space)
  }
```

| | |
|---|---|
| ue-Specific | SEQUENCE { |

```
    (UE-specific search space)
      -- Indicates whether the UE monitors in this USS for DCI formats 0-0 and 1-
    0 or for formats 0-1 and 1-1.
```

| | |
|---|---|
| formats | ENUMERATED {formats0-0-And- |

```
    1-0, formats0-1-And-1-1},
      ...
    }
```

According to configuration information, the base station may configure one or a plurality of search space sets to the UE. According to some embodiments, the base station may configure a search space set 1 and a search space set 2 to the UE, configure to monitor a DCI format A scrambled with an X-RNTI in the common search space in the search space set 1, and configure to monitor a DCI format B scrambled with a Y-RNTI in the UE-specific search space in the search space set 2.

According to configuration information, one or a plurality of search space sets may exist in a common search space or a UE-specific search space. For example, a search space set #1 and a search space set #2 may be configured to common search spaces, and a search space set #3 and a search space set #4 may be configured to UE-specific search spaces.

In the common search space, a combination of the following DCI format and RNTI may be monitored. The disclosure is not limited to the following examples:
DCI format 0_0/1_0 with CRC scrambled by C-RNTI, CS-RNTI, SP-CSI-RNTI, RA-RNTI, TC-RNTI, P-RNTI, SI-RNTI;
DCI format 2_0 with CRC scrambled by SFI-RNTI;
DCI format 2_1 with CRC scrambled by INT-RNTI;
DCI format 2_2 with CRC scrambled by TPC-PUSCH-RNTI, TPC-PUCCH-RNTI; and/or
DCI format 2_3 with CRC scrambled by TPC-SRS-RNTI.

In the UE-specific search space, the combination of the following DCI format and RNTI may be monitored. The disclosure is not limited to the following examples:
DCI format 0_0/1_0 with CRC scrambled by C-RNTI, CS-RNTI, TC-RNTI; and/or
DCI format 1_0/1_1 with CRC scrambled by C-RNTI, CS-RNTI, TC-RNTI.

The specified RNTIs may follow the following definitions and uses:
C-RNTI (Cell RNTI): Used for scheduling a UE-specific PDSCH;
TC-RNTI (Temporary Cell RNTI): Used for scheduling a UE-specific PDSCH;
CS-RNTI (Configured Scheduling RNTI): Used for scheduling a semi-statically configured UE-specific PDSCH;
RA-RNTI (Random Access RNTI): Used for scheduling a PDSCH in a random access step;
P-RNTI (Paging RNTI): Used for scheduling a PDSCH in which paging is transmitted;
SI-RNTI (System Information RNTI): Used for scheduling a PDSCH through which system information is transmitted;
INT-RNTI (Interruption RNTI): Used for notifying whether puncturing for a PDSCH;
TPC-PUCCH-RNTI (Transmit Power Control for PUCCH RNTI): Used for indicating a power control command for a PUCCH;
TPC-SRS-RNTI (Transmit Power Control for PUCCH RNTI): Used for indicating a power control command for a PUCCH; and/or
TPC-SRS-RNTI (Transmit Power Control for SRS RNTI): Used for indicating a power control command for an SRS.

The above-described specified DCI formats may follow the definition of Table 23.

TABLE 23

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH and |
| | PUSCH |
| 2_3 | Transmission of a group of TPC commands for |
| | SRS transmissions by one or more UEs |

In 5G, a search space of an aggregation level L in a control area p and a search space set s may be expressed as in Equation 1.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + iere \qquad [ Equation 1 ]$$

L: aggregation level;
n_{CI}: carrier index;
N_{CCE,p}: the number of total CCEs existing in a control area p;
n_{s,f}^{μ}: slot index;
M_{s,max}^{(L)} he number of PDCCH candidates of the aggregation level L;
m_{s,n}_{_{CI}}=0, . . . , M_{s,max}^{(L)} PDCCH candidate index of the aggregation level L;
i=0, . . . , L−1;

$${Y}_{p , {n}_{s , f}^{μ}} = ( {A}_{p} \cdot {Y}_{p , {n}_{s , f}^{μ} - 1} ) mod D , {Y}_{p , - 1} = {n}_{RNTI} \neq 0 , {A}_{p} = 39827$$

for pmod3=0, Aₚ=39829 for pmod3=1, Aₚ=39839 for pmod3=2, D=65537; and
n_{RNTI}: UE identifier.

The Y_{p,n}_{_{s,f}}_{^{μ}} value may correspond to 0 in the case of a common search space.

In the case of a UE-specific search space, the Y_{p,n}_{_{s,f}}_{^{μ}} value may correspond to a value that changes according to an identity of the UE (C-RNTI or an ID configured to the UE by the base station) and a time index.

In 5G, as a plurality of search space sets may be configured with different parameters (e.g., parameters in Table 22), a set of search space sets monitored by the UE at each time point may be different. For example, in the case that a search space set #1 is configured to an X-slot period and that a search space set #2 is configured to a Y-slot period and that X and Y are different, the UE may monitor both the search space set #1 and the search space set #2 in a specific slot and monitor one of the search space set #1 and the search space set #2 in a specific slot.

### [PUCCH: Related to Transmission]

In the NR system, the UE may transmit control information (UCI) to the base station through a PUCCH. The control information may include at least one of a HARQ-ACK indicating whether demodulation/decoding for a transport block (TB) received by the UE through a PDSCH was successful, a scheduling request (SR) in which the UE requests resource allocation to the base station for uplink data transmission, or channel state information (CSI) which is information for reporting a channel state of the UE.

PUCCH resources may be broadly divided into a long PUCCH and a short PUCCH according to a length of the allocated symbol. In the NR system, the long PUCCH has a length of 4 symbols or more within a slot, and the short PUCCH has a length of 2 symbols or less within a slot.

When the long PUCCH is described in more detail, the long PUCCH may be used for the purpose of improving uplink cell coverage; thus, the long PUCCH may be transmitted in a DFT-S-OFDM method, which is single-carrier transmission rather than OFDM transmission. The long PUCCH supports transmission formats such as a PUCCH format 1, a PUCCH format 3, and a PUCCH format 4 according to the number of supportable control information bits and whether UE multiplexing is supported through pre-DFT OCC support in a front stage of IFFT.

First, the PUCCH format 1 is a long PUCCH format based on DFT-S-OFDM that may support control information of up to 2 bits and uses frequency resources of 1 RB. Control information may be composed of a combination of HARQ-ACK and SR or each of them. The PUCCH format 1 is repeatedly composed of OFDM symbols including a demodulation reference signal (DMRS), which is a demodulation reference signal (or reference signal), and OFDM symbols including UCI.

For example, in the case that the number of transmission symbols of the PUCCH format 1 is 8 symbols, the symbol may be sequentially composed of a DMRS symbol, a UCI symbol, a DMRS symbol, a UCI symbol, a DMRS symbol, a UCI symbol, a DMRS symbol, and a UCI symbol from a first start symbol of the 8 symbols. The DMRS symbol may be spread using an orthogonal code (or orthogonal sequence or spreading code, w_i (m)) in the time axis in a sequence corresponding to a length of 1 RB in the frequency axis within one OFDM symbol, and transmitted after performing IFFT.

After the UE generates d(0) by modulating 1-bit control information with BPSK and 2-bit control information with QPSK, scrambles the generated d(0) by multiplying it by a sequence corresponding to a length of 1 RB in the frequency axis, spreads the scrambled sequence in the time axis using an orthogonal code (or orthogonal sequence or spreading code, w_i (m)), and performs IFFT, the UCI symbol may be transmitted.

The UE generates a sequence based on a group hopping or sequence hopping configuration configured by upper layer signaling from the base station and the configured ID, and cyclically shifts the generated sequence with an initial cyclic shift (CS) value configured by an upper signal to generate a sequence corresponding to a length of 1 RB.

When a length (NSF) of the spreading code is given, wᵢ(m) is determined as in

$${w}_{i} ( m ) = {e}^{\frac{j 2 πϕ ( m )}{{N}_{SF}}}$$

and is specifically given as in [Table 24]. i means an index of the spreading code itself, and m means an index of elements of the spreading code. Here, numbers in [ ] in [Table 24] mean φ(m), and for example, in the case that the length of the spreading code is 2 and that the index of the configured spreading code is i=0, the spreading code wᵢ(m) becomes

$${w}_{i} ( 0 ) = {e}^{j 2 π \cdot 0 / {N}_{SF}} = 1 , {w}_{i} ( 1 ) = {e}^{j 2 π \cdot 0 / {N}_{SF}} = 1$$

and thus wᵢ(m)=[1 1].

TABLE 24
$Spreading code {W}_{i} ( m ) = {e}^{\frac{j 2 π 0 ( m ) \_}{{N}_{SF}}} for PUCCH \text{format 1}$

| | φ(m) | | | | | | |
|---|---|---|---|---|---|---|---|
| N_{SF} | i = 0 | i = 1 | i = 2 | i = 3 | i = 4 | i = 5 | i = 6 |
| 1 | [0] | — | — | — | — | — | — |
| 2 | [00] | [01] | — | — | — | — | — |
| 3 | [000] | [012] | [021] | | | | |
| 4 | [0000] | [0202] | [0022] | [0220] | | | |
| 5 | [00000] | [01234] | [02413] | [03142] | [04321] | | |
| 6 | [000000] | [012345] | [024024] | [030303] | [042042] | [054321] | |
| 7 | [0000000] | [0123456] | [0246135] | [0362514] | [0415263] | [0531642] | [0654321] |

Hereinafter, the PUCCH format 3 is a long PUCCH format based on DFT-S-OFDM that may support control information exceeding 2 bits, and the number of used RBs may be configured through the upper layer. Control information may be composed of a combination of HARQ-ACK, SR, and CSI or each of them. In the PUCCH format 3, DMRS symbol positions are presented in [Table 25] according to whether frequency hopping occurs within a slot and whether additional DMRS symbols are configured.

TABLE 25

| | DMRS position within PUCCH format 3/4 transmission | | | |
|---|---|---|---|---|
| PUCCH | Additional DMRS is not | | | |
| format 3/4 | configured | | Additional DMRS is configured | |
| transmis- | Frequency | Frequency | Frequency | Frequency |
| sion | hopping is not | hopping is | hopping is not | hopping is |
| length | configured | configured | configured | configured |
| 4 | 1 | 0.2 | 1 | 0.2 |

| | | |
|---|---|---|
| 5 | 0, 3 | 0, 3 |
| 6 | 1, 4 | 1, 4 |
| 7 | 1, 4 | 1, 4 |
| 8 | 1, 5 | 1, 5 |
| 9 | 1, 6 | 1, 6 |
| 10 | 2, 7 | 1, 3, 6, 8 |
| 11 | 2, 7 | 1, 3, 6, 9 |
| 12 | 2, 8 | 1, 4, 7, 10 |
| 13 | 2, 9 | 1, 4, 7, 11 |
| 14 | 3, 10 | 1, 5, 8, 12 |

For example, in the case that the number of transmission symbols of the PUCCH format 3 is 8 symbols, a DMRS is transmitted to the 1st and 5th symbols, starting a first start symbol of the 8 symbols as 0. [Table 25] is applied to the DMRS symbol positions of the PUCCH format 4 in the same way.

Hereinafter, the PUCCH format 4 is a long PUCCH format based on DFT-S-OFDM that may support control information exceeding 2 bits, and uses frequency resources of 1 RB. Control information may be composed of a combination of HARQ-ACK, SR, and CSI, or each of them. What makes the PUCCH format 4 different from the PUCCH format 3 is that in the case of PUCCH format 4, the PUCCH format 4 of multiple UEs may be multiplexed within one RB. It is possible to multiplex the PUCCH format 4 of multiple UEs by applying pre-DFT orthogonal cover code (OCC) to control information in a front end of the IFFT. However, the number of transmittable control information symbols of one UE decreases according to the number of multiplexed UEs. The number of multiplexable UEs, i.e., the number of different available OCCs may be 2 or 4, and the number of OCCs and the OCC index to be applied may be configured through a higher layer.

Hereinafter, a short PUCCH is described. The short PUCCH may be transmitted in both a downlink centric slot and an uplink centric slot, and generally be transmitted in a last symbol of the slot, or an OFDM symbol at a back portion (e.g., last OFDM symbol, second OFDM symbol from the end, or last 2 OFDM symbols). The short PUCCH may be transmitted at any position in the slot. The short PUCCH may be transmitted using one OFDM symbol or two OFDM symbols. The short PUCCH may be used for reducing a delay time compared to the long PUCCH in a situation where uplink cell coverage is good, and be transmitted in a CP-OFDM scheme.

The short PUCCH may support transmission formats such as a PUCCH format 0 and a PUCCH format 2 according to the number of control information bits that may be supported. First, the PUCCH format 0 is a short PUCCH format that may support control information of up to 2 bits and uses frequency resources of 1RB. Control information may be composed of a combination of HARQ-ACK and SR or each of them. The PUCCH format 0 does not transmit a DMRS and is structured to transmit only a sequence mapped to 12 subcarriers in the frequency axis within one OFDM symbol. The UE may generate a sequence based on a group hopping or sequence hopping configuration configured as an upper signal from the base station and a configured ID, and cyclically shift a sequence generated with a final CS value obtained by adding another CS value according to whether the indicated initial cyclic shift (CS) value is ACK or NACK and map the sequence to 12 subcarriers and transmit.

For example, in the case that HARQ-ACK is 1 bit, the UE may add 6 to the initial CS value to generate a final CS if it is ACK, as in [Table 26], and add 0 to the initial CS to generate a final CS if it is NACK. A CS value 0 for NACK and a CS value 6 for ACK are defined in the standard, and the UE may generate a PUCCH format 0 according to values defined in the standard to transmit 1-bit HARQ-ACK.

TABLE 26

| 1 bit HARQ-ACK | NACK | ACK |
|---|---|---|
| Final CS | (initial CS + 0) mod | (initial CS + 6) mod 12 |
| | 12 = initial CS | |

For example, in the case that the HARQ-ACK is 2-bit, the UE adds 0 to the initial CS value if it is (NACK, NACK), adds 3 to the initial CS value if it is (NACK, ACK), adds 6 to the initial CS value if it is (ACK, ACK), and adds 9 to the initial CS value if it is (ACK, NACK), as illustrated in [Table 27]. A CS value 0 for (NACK, NACK), a CS value 3 for (NACK, ACK), a CS value 6 for (ACK, ACK), and a CS value 9 for (ACK, NACK) are defined in the standard, and the UE may generate a PUCCH format 0 according to values defined in the standard to transmit 2-bit HARQ-ACK. In the case that a final CS value exceeds 12 by the CS value added to the initial CS value according to ACK or NACK, because a length of the sequence is 12, modulo 12 may be applied to the final CS value.

TABLE 27

| 2 bit HARQ- | NACK, | NACK, | ACK, | ACK, |
|---|---|---|---|---|
| ACK | NACK | ACK | ACK | NACK |
| Final CS | (initial | (initial | (initial | (initial |
| | CS + 0) | CS + 3) | CS + 6) | CS + 9) |
| | mod 12 = | mod 12 | mod 12 | mod 12 |
| | initial CS | | | |

Hereinafter, the PUCCH format 2 is a short PUCCH format that supports control information exceeding 2 bits, and the number of used RBs may be configured through a higher layer. The control information may be composed of a combination of HARQ-ACK, SR, and CSI, or each of them. When an index of the first subcarrier is #0, in the PUCCH format 2, positions of subcarriers in which a DMRS is transmitted within one OFDM symbol may be fixed to subcarriers having indices of #1, #4, #7, and #10. The control information may be mapped to the remaining subcarriers except for subcarriers in which a DMRS is located through a modulation process after channel encoding.

In summary, values and ranges that may be configured for each PUCCH format described above may be arranged as illustrated in Table 28. In Table 28, in the case that a value does not need to be configured, it is denoted by N.A.

TABLE 28

| | | PUCCH | PUCCH | PUCCH | PUCCH | PUCCH |
|---|---|---|---|---|---|---|
| | | Format 0 | Format 1 | Format 2 | Format 3 | Format 4 |
| Starting symbol | Configurability | √ | √ | √ | √ | √ |
| | Value range | 0-13 | 0-10 | 0-13 | 0-10 | 0-10 |
| Number of | Configurability | √ | √ | √ | √ | √ |
| symbols in a slot | Value range | 1, 2 | 4-14 | 1, 2 | 4-14 | 4-14 |
| Index for | Configurability | √ | √ | √ | √ | √ |
| identifying | Value range | 0-274 | 0-274 | 0-274 | 0-274 | 0-274 |
| starting PRB | | | | | | |
| Number of PRBs | Configurability | N.A. | N.A. | √ | √ | N.A. |
| | Value range | N.A. | N.A. | 1-16 | 1-6, 8-10, | N.A. |
| | | (Default is 1) | (Default is 1) | | 12, 15, 16 | (Default is 1) |
| Enabling | Configurability | √ | √ | √ | √ | √ |
| frequency | Value range | On /Off (only for 2 | On/Off | On/Off (only for 2 | On/off | On/off |
| hopping | | symbol) | | symbol) | | |
| (intra-slot) | | | | | | |
| Freq.cy resource | Configurability | √ | √ | √ | √ | √ |
| of 2^{nd} hop if | Value range | 0-274 | 0-274 | 0-274 | 0-274 | 0-274 |
| intra-slot | | | | | | |
| frequency | | | | | | |
| hopping is | | | | | | |
| enabled | | | | | | |
| Index of initial | Configurability | √ | √ | N.A. | N.A. | N.A. |
| cyclic shift | Value range | 0-11 | 0-11 | N.A. | N.A. | N.A. |
| Index of | Configurability | N.A. | √ | N.A. | N.A. | N.A. |
| time-domain | Value range | N.A. | 0-6 | N.A. | N.A. | N.A. |
| OCC | | | | | | |
| Length of | Configurability | N.A. | N.A. | N.A. | N.A. | √ |
| Pre-DFT OCC | Value range | N.A. | N.A. | N.A. | N.A. | 2, 4 |
| Index of Pre-DFT | Configurability | N.A. | N.A. | N.A. | N.A. | √ |
| OCC | Value range | N.A. | N.A. | N.A. | N.A. | 0, 1, 2, 3 |

To improve uplink coverage, multi-slot repetition may be supported for PUCCH formats 1, 3, and 4, and PUCCH repetition may be configured for each PUCCH format. The UE may perform repetition transmission for a PUCCH including UCI as many as the number of slots configured through nrofSlots, which is higher layer signaling. For PUCCH repetition transmission, PUCCH transmission of each slot is performed using the same number of consecutive symbols, and the number of corresponding consecutive symbols may be configured through nrofSymbols in PUCCH-format1, PUCCH-format3, or PUCCH-format4, which is higher layer signaling. For PUCCH repetition transmission, PUCCH transmission of each slot is performed using the same starting symbol, and the corresponding starting symbol may be configured through a startingSymbolIndex in PUCCH-format 1, PUCCH-format 3, or PUCCH-format 4, which is higher layer signaling. For PUCCH repetition transmission, single PUCCH-spatialRelationInfo may be configured to a single PUCCH resource. For PUCCH repetition transmission, if the UE is configured to perform frequency hopping in PUCCH transmission in different slots, the UE may perform frequency hopping in units of a slot. Further, if the UE is configured to perform frequency hopping in PUCCH transmission in different slots, the UE may start PUCCH transmission from a first PRB index configured through a startingPRB, which is higher layer signaling in even slots and start PUCCH transmission from a second PRB index configured through a secondHopPRB, which is higher layer signaling in odd slots. Additionally, if the UE is configured to perform frequency hopping in PUCCH transmission in different slots, an index of a slot in which first PUCCH transmission is instructed to the UE is 0, and a PUCCH repetition transmission execution value may increase regardless of PUCCH transmission execution in each slot during the configured total number of PUCCH repetition transmissions. If the UE is configured to perform frequency hopping in PUCCH transmission in different slots, the UE does not expect frequency hopping within a slot to be configured when transmitting a PUCCH. If the UE is not configured to perform frequency hopping in PUCCH transmission in different slots but is configured to perform frequency hopping within a slot, the first and second PRB indices may be applied equally within a slot. If the number of uplink symbols available for PUCCH transmission is smaller than nrofSymbols configured by higher layer signaling, the UE may not transmit a PUCCH. If the UE fails to transmit a PUCCH in any slot for any reason during PUCCH repetition transmission, the UE may increase the number of PUCCH repetition transmissions.

In NR Release 17, the number of slots repeatedly transmitted for each PUCCH resource may be configured through upper layer signaling pucch-RepetitionNrofSlots-r17 in PUCCH-ResourceExt, which is an extension of PUCCH-Resource, which is upper layer signaling for PUCCH resources. In the case that the corresponding upper layer signaling pucch-RepetitionNrofSlots-r17 is configured and that the corresponding PUCCH resource is scheduled and that the upper layer signaling nrofSlots is also configured, the UE determines the number of slots in which the corresponding PUCCH resource is repeatedly transmitted through pucch-RepetitionNrofSlots-r17 and ignores the upper layer signaling nrofSlots.

### [PUCCH: PUCCH Resource Configuration]

Hereinafter, a PUCCH resource configuration of the base station or the UE is described. The base station may configure PUCCH resources for each BWP through an upper layer for a specific UE. The PUCCH resource configuration may be as illustrated in [Table 29].

```
TABLE 29
PUCCH-Config ::= SEQUENCE {
resourceSetToAddModList SEQUENCE (SIZE (1..maxNrofPUCCH-ResourceSets)) OF
PUCCH-ResourceSet OPTIONAL, -- Need N
resourceSetToReleaseList SEQUENCE (SIZE (1..maxNrofPUCCH-ResourceSets)) OF
PUCCH-ResourceSetId OPTIONAL, -- Need N
resourceToAddModList SEQUENCE (SIZE (1..maxNrofPUCCH-Resources)) OF
PUCCH-Resource OPTIONAL, -- Need N
resourceToReleaseList SEQUENCE (SIZE (1..maxNrofPUCCH-Resources)) OF
PUCCH-ResourceId OPTIONAL, -- Need N
format1 SetupRelease { PUCCH-FormatConfig } OPTIONAL, -- Need M
format2 SetupRelease { PUCCH-FormatConfig } OPTIONAL, -- Need M
format3 SetupRelease { PUCCH-FormatConfig } OPTIONAL, -- Need M
format4 SetupRelease { PUCCH-FormatConfig } OPTIONAL, -- Need M
schedulingRequestResourceToAddModList SEQUENCE (SIZE (1..maxNrofSR-
Resources)) OF SchedulingRequestResourceConfig OPTIONAL, -- Need N
schedulingRequestResourceToReleaseList SEQUENCE (SIZE (1..maxNrofSR-
Resources)) OF SchedulingRequestResourceId OPTIONAL, -- Need N
multi-CSI-PUCCH-ResourceList SEQUENCE (SIZE (1..2)) OF PUCCH-ResourceId
OPTIONAL, -- Need M
dl-DataToUL-ACK SEQUENCE (SIZE (1..8)) OF INTEGER (0..15) OPTIONAL, --
Need M
spatialRelationInfoToAddModList SEQUENCE (SIZE (1..maxNrofSpatialRelationInfos))
OF PUCCH-SpatialRelationInfo OPTIONAL, -- Need N
spatialRelationInfoToReleaseList SEQUENCE (SIZE (1..maxNrofSpatialRelationInfos))
OF PUCCH-SpatialRelationInfoId OPTIONAL, -- Need N
pucch-PowerControl PUCCH-PowerControl OPTIONAL, -- Need M
...,
[[
resourceToAddModListExt-r16 SEQUENCE (SIZE (1..maxNrofPUCCH-Resources)) OF
PUCCH-ResourceExt-r16 OPTIONAL, -- Need N
dl-DataToUL-ACK-r16 SetupRelease { DL-DataToUL-ACK-r16 } OPTIONAL, -- Need
M
ul-AccessConfigListDCI-1-1-r16 SetupRelease { UL-AccessConfigListDCI-1-1-r16 }
OPTIONAL, -- Need M
subslotLengthForPUCCH-r16 CHOICE {
  normalCP-r16 ENUMERATED {n2,n7},
  extendedCP-r16 ENUMERATED {n2,n6}
} OPTIONAL, -- Need R
dl-DataToUL-ACK-DCI-1-2-r16 SetupRelease { DL-DataToUL-ACK-DCI-1-2-r16}
OPTIONAL, -- Need M
numberOfBitsForPUCCH-ResourceIndicatorDCI-1-2-r16 INTEGER (0..3) OPTIONAL,
-- Need R
dmrs-UplinkTransformPrecodingPUCCH-r16 ENUMERATED {enabled} OPTIONAL, --
Cond PI2-BPSK
spatialRelationInfoToAddModListSizeExt-v1610 SEQUENCE (SIZE
(1..maxNrofSpatialRelationInfosDiff-r16)) OF PUCCH-SpatialRelationInfo
OPTIONAL, -- Need N
spatialRelationInfoToReleaseListSizeExt-v1610 SEQUENCE (SIZE
(1..maxNrofSpatialRelationInfosDiff-r16)) OF PUCCH-SpatialRelationInfoId
OPTIONAL, -- Need N
spatialRelationInfoToAddModListExt-v1610 SEQUENCE (SIZE
(1..maxNrofSpatialRelationInfos-r16)) OF PUCCH-SpatialRelationInfoExt-r16
OPTIONAL, -- Need N
spatialRelationInfoToReleaseListExt-v1610 SEQUENCE (SIZE
(1..maxNrofSpatialRelationInfos-r16)) OF PUCCH-SpatialRelationInfoId-r16
OPTIONAL, -- Need N
resourceGroupToAddModList-r16 SEQUENCE (SIZE (1..maxNrofPUCCH-
ResourceGroups-r16)) OF PUCCH-ResourceGroup-r16 OPTIONAL, -- Need N
resourceGroupToReleaseList-r16 SEQUENCE (SIZE (1..maxNrofPUCCH-
ResourceGroups-r16)) OF PUCCH-ResourceGroupId-r16 OPTIONAL, -- Need N
sps-PUCCH-AN-List-r16 SetupRelease { SPS-PUCCH-AN-List-r16 } OPTIONAL, --
Need M
schedulingRequestResourceToAddModListExt-v1610 SEQUENCE (SIZE
(1..maxNrofSR-Resources)) OF SchedulingRequestResourceConfigExt-v1610
OPTIONAL -- Need N
]]
}
```

In [Table 29], one or more PUCCH resource sets may be configured within the PUCCH resource configuration for a specific BWP, and in some of the PUCCH resource sets, a maximum payload value for UCI transmission may be configured. One or more PUCCH resources may belong to each PUCCH resource set, and each PUCCH resource may belong to one of the PUCCH formats described above.

For PUCCH resource sets, a first PUCCH resource set may have a maximum payload value fixed to 2 bits. Accordingly, the corresponding value may not be configured separately through an upper layer, and the like. In the case that the remaining PUCCH resource sets are configured, indexes of the corresponding PUCCH resource sets may be configured in ascending order according to the maximum payload value, and a maximum payload value may not be configured to the last PUCCH resource set. An upper layer constitution for the PUCCH resource set may be as illustrated in [Table 30].

TABLE 30
PUCCH-ResourceSet ::= SEQUENCE {
pucch-ResourceSetId PUCCH-ResourceSetId,
resourceList SEQUENCE (SIZE (1..maxNrofPUCCH-ResourcesPerSet)) OF PUCCH-
ResourceId,
maxPayloadSize INTEGER (4..256) OPTIONAL -- Need R
}

A resourceList parameter in [Table 30] may include IDs of PUCCH resources belonging to the PUCCH resource set.

In the case that initial access is made or the PUCCH resource set is not configured, a PUCCH resource set as illustrated in [Table 31] and composed of multiple cell-specific PUCCH resources in the initial BWP may be used. A PUCCH resource to be used for initial access within this PUCCH resource set may be indicated through SIB1.

TABLE 31

| | PUCCH | First | Number of | PRB offset | Set of initial |
|---|---|---|---|---|---|
| Index | format | symbol | symbols | RB_{BWP}^{offset} | CS indexes |
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 4 | 10 | 4 | {0, 3, 6, 9} |
| 11 | 1 | 0 | 14 | 0 | {0, 6} |
| 12 | 1 | 0 | 14 | 0 | {0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | └N_{BWP}^{size}/4┘ | {0, 3, 6, 9} |

A maximum payload of each PUCCH resource included in a PUCCH resource set may be 2 bits in the case of a PUCCH format 0 or 1, and may be determined by a symbol length, number of PRBs, and maximum code rate in the case of the remaining formats. The symbol length and the number of PRBs may be configured for each PUCCH resource, and a maximum code rate may be configured for each PUCCH format.

Hereinafter, PUCCH resource selection for UCI transmission is described. In the case of SR transmission, a PUCCH resource for an SR corresponding to schedulingRequestID may be configured through an upper layer, as illustrated in [Table 32]. The PUCCH resource may be a resource belonging to a PUCCH format 0 or PUCCH format 1.

TABLE 32
SchedulingRequestResourceConfig ::= SEQUENCE {
schedulingRequestResourceId SchedulingRequestResourceId,
schedulingRequestID SchedulingRequestId,
periodicityAndOffset CHOICE {

| | |
|---|---|
| sym2 | NULL, |
| sym6or7 | NULL, |
| sl1 | NULL, -- Recurs in every slot |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639) |
| } | OPTIONAL, -- Need M |
| resource | PUCCH-ResourceId OPTIONAL -- Need M |

}

The configured PUCCH resource may have a transmission period and offset configured through a periodicity AndOffset parameter in [Table 32]. In the case that the UE has uplink data to transmit at a time point corresponding to the configured period and offset, the corresponding PUCCH resource may be transmitted, otherwise, the corresponding PUCCH resource may not be transmitted.

In the case of CSI transmission, a PUCCH resource to transmit a periodic or semi-persistent CSI report through a PUCCH may be configured in a pucch-CSI-ResourceList parameter, as illustrated in [Table 33]. The pucch-CSI-ResourceList parameter may include a list of PUCCH resources for each BWP for a cell or CC to transmit the corresponding CSI report. The PUCCH resource may be a resource belonging to a PUCCH format 2, PUCCH format 3, or PUCCH format 4. A transmission period and offset of the PUCCH resource may be configured through reportSlotConfig of [Table 33].

TABLE 33

| CSI-ReportConfig ::= | | SEQUENCE { |
|---|---|---|
| reportConfigId | | CSI-ReportConfigId, |
| carrier | ServCellIndex | OPTIONAL, -- Need S |

...

| | |
|---|---|
| reportConfigType | CHOICE { |

| | |
|---|---|
| periodic | SEQUENCE { |

| | |
|---|---|
| reportSlotConfig | CSI-ReportPeriodicityAndOffset, |
| pucch-CSI-ResourceList | SEQUENCE (SIZE (1..maxNrofBWPs)) OF PUCCH-CSI- |

Resource
},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI- |

Resource
},

| | |
|---|---|
| semiPersistentOnPUSCH | SEQUENCE { |
| reportSlotConfig | ENUMERATED {sl5, sl10, sl20, sl40, sl80, sl160, sl320}, |
| reportSlotOffsetList | SEQUENCE (SIZE (1.. maxNrofUL-Allocations)) OF |

INTEGER(0..32),

| | |
|---|---|
| p0alpha | P0-PUSCH-AlphaSetId |

},

| | |
|---|---|
| aperiodic | SEQUENCE { |

| | |
|---|---|
| reportSlotOffsetList | SEQUENCE (SIZE (1.. maxNrofUL-Allocations)) OF |

INTEGER(0..32)
}
},
...
}

In the case of HARQ-ACK transmission, a resource set of the PUCCH resource to be transmitted according to a payload of the UCI including the corresponding HARQ-ACK may be first selected. That is, a PUCCH resource set having a minimum payload not smaller than the UCI payload may be selected. Thereafter, a PUCCH resource in the PUCCH resource set may be selected through a PUCCH resource indicator (PRI) in DCI that schedules a TB corresponding to the HARQ-ACK, and the PRI may be a PUCCH resource indicator specified in [Table 19] or [Table 20]. The relationship between the PRI and the PUCCH resource selected from the PUCCH resource set may be as illustrated in [Table 34].

TABLE 34

| PUCCH | |
|---|---|
| resource | |
| indicator | PUCCH resource |
| ‘000’ | 1^{st} PUCCH resource provided by pucch-ResourceId obtained |
| | from the 1^{st} value of resourceList |
| ‘001’ | 2^{nd} PUCCH resource provided by pucch-ResourceId obtained |
| | from the 2^{nd} value of resourceList |
| ‘010’ | 3^{rd} PUCCH resource provided by pucch-ResourceId obtained |
| | from the 3^{rd} value of resourceList |
| ‘011’ | 4^{th} PUCCH resource provided by pucch-ResourceId obtained |
| | from the 4^{th} value of resourceList |
| ‘100’ | 5^{th} PUCCH resource provided by pucch-ResourceId obtained |
| | from the 5^{th} value of resourceList |
| ‘101’ | 6^{th} PUCCH resource provided by pucch-ResourceId obtained |
| | from the 6^{th} value of resourceList |
| ‘110’ | 7^{th} PUCCH resource provided by pucch-ResourceId obtained |
| | from the 7^{th} value of resourceList |
| ‘111’ | 8^{th} PUCCH resource provided by pucch-ResourceId obtained |
| | from the 8^{th} value of resourceList |

If the number of PUCCH resources in the selected PUCCH resource set is greater than 8, the PUCCH resource may be selected by [Equation 2].

$${r}_{PUCCH} = \{ \begin{matrix}\begin{matrix}⌊ \frac{{n}_{CCE , p} \cdot ⌈ {R}_{PUCCH} / 8 ⌉}{{N}_{CCE , p}} ⌋ + {Δ}_{PRI} \cdot ⌈ \frac{{R}_{PUCCH}}{8} ⌉ \\ if {Δ}_{PRI} < {R}_{PUCCH} mod 8\end{matrix} \\ \begin{matrix}⌊ \frac{{n}_{CCE , p} \cdot ⌊ {R}_{PUCCH} / 8 ⌋}{{N}_{CCE , p}} ⌋ + {Δ}_{PRI} \cdot ⌊ \frac{{R}_{PUCCH}}{8} ⌋ + \\ {R}_{PUCCH} mod 8 \\ if {Δ}_{PRI} \geq {R}_{PUCCH} mod 8\end{matrix}\end{matrix} \} . \qquad [ Equation 2 ]$$

In [Equation 2], r_{PUCCH} represents an index of a PUCCH resource selected within the PUCCH resource set, R_{PUCCH} represents the number of PUCCH resources belonging to the PUCCH resource set, Δ_{PRI} represents a PRI value, N_{CCE,p} represents the number of total CCEs of CORESET p to which the received DCI belongs, and n_{CCE,p} represents a first CCE index for the received DCI.

A time point at which the corresponding PUCCH resource is transmitted is a time point after a K₁ slot from TB transmission corresponding to the HARQ-ACK. A candidate for a value K₁ is configured by an upper layer, and more specifically, it may be configured in a dl-DataToUL-ACK parameter in the PUCCH-Config specified in [Table 29]. One K₁ value of these candidates may be selected by a PDSCH-to-HARQ feedback timing indicator in DCI that schedules the TB, and this value may be a value specified in [Table 18] or [Table 19]. The unit of the K₁ value may be a slot unit or a subslot unit. Here, a subslot is a unit of a length smaller than that of a slot, and one or more symbols may constitute one subslot.

Hereinafter, the case that two or more PUCCH resources are located in one slot is described. The UE may transmit UCI through one or two PUCCH resources in one slot or subslot, and when UCI is transmitted through two PUCCH resources in one slot/subslot, i) each PUCCH resource does not overlap in units of a symbol, and ii) at least one PUCCH resource may be a short PUCCH. The UE may not expect to transmit multiple PUCCH resources for HARQ-ACK transmission in one slot.

### [PUSCH: Related to Transmission Method]

Hereinafter, a scheduling method of PUSCH transmission will be described. PUSCH transmission may be dynamically scheduled by the UL grant in DCI or operated by a configured grant Type 1 or Type 2. A dynamic scheduling instruction for PUSCH transmission is possible by a DCI format 0_0 or 0_1.

Configured grant Type 1 PUSCH transmission may be semi-statically configured through reception of configuredGrantConfig including rrc-ConfiguredUplinkGrant in [Table 35] through higher signaling without reception of the UL grant in DCI. Configured grant type 2 PUSCH transmission may be scheduled semi-persistently by the UL grant in DCI after receiving configuredGrantConfig not including rrc-ConfiguredUplinkGrant in [Table 35] through higher signaling. In the case that PUSCH transmission operates by a configured grant, parameters applied to PUSCH transmission are applied through configuredGrantConfig, which is higher signaling of [Table 35] except for dataScramblingIdentityPUSCH, txConfig, codebookSubset, maxRank, and scaling of UCI-OnPUSCH provided by a push-Config of [Table 36], which is higher signaling. When the UE is provided with a transformPrecoder in a configuredGrantConfig, which is higher signaling of [Table 35], the UE applies tp-pi2BPSK in a push-Config of [Table 36] to PUSCH transmission operating by the configured grant.

```
TABLE 35
ConfiguredGrantConfig ::= SEQUENCE {
frequencyHopping ENUMERATED {intraSlot, interSlot} OPTIONAL, -- Need S,
cg-DMRS-Configuration DMRS-UplinkConfig,
mcs-Table ENUMERATED {qam256, qam64LowSE} OPTIONAL, -- Need S
mcs-TableTransformPrecoder ENUMERATED { qam256, qam64LowSE} OPTIONAL, -
- Need S
uci-OnPUSCH SetupRelease { CG-UCI-OnPUSCH } OPTIONAL, -- Need M
resource Allocation ENUMERATED { resourceAllocationType0, resourceAllocation Type1,
dynamicSwitch },
rbg-Size ENUMERATED { config2} OPTIONAL, -- Need S
powerControlLoopToUse ENUMERATED {n0, n1},
p0-PUSCH-Alpha PO-PUSCH-AlphaSetId,
transformPrecoder ENUMERATED {enabled, disabled} OPTIONAL, -- Need S
nrofHARQ-Processes INTEGER(1 .. 16),
repK ENUMERATED {n1, n2, n4, n8},
repK-RV ENUMERATED {s1-0231, s2-0303, s3-0000} OPTIONAL, -- Need R
periodicity ENUMERATED {
  sym2, sym7, sym1x14, sym2x14, sym4x14, sym5x14, sym8x14, sym10x14, sym16x14,
sym20x14,
  sym32x14, sym40x14, sym64x14, sym80x14, sym128x14, sym160x14, sym256x14,
sym320x14, sym512x14,
  sym640x14, sym1024x14, sym1280x14, sym2560x14, sym5120x14,
  sym6, sym1x12, sym2x12, sym4x12, sym5x12, sym8x12, sym10x12, sym16x12,
sym20x12, sym32x12,
  sym40x12, sym64x12, sym80x12, sym128x12, sym160x12, sym256x12, sym320x12,
sym512x12, sym640x12,
  sym1280x12, sym2560×12
},
configuredGrantTimer INTEGER (1..64) OPTIONAL, -- Need R
rrc-ConfiguredUplinkGrant SEQUENCE {
timeDomainOffset INTEGER (0..5119),
timeDomainAllocation INTEGER (0..15),
frequencyDomainAllocation BIT STRING (SIZE(18)),
antennaPort INTEGER (0..31),
dmrs-SeqInitialization INTEGER (0..1) OPTIONAL, -- Need R
precodingAndNumberOfLayers INTEGER (0 .. 63),
srs-ResourceIndicator INTEGER (0..15) OPTIONAL, -- Need R
mcsAndTBS INTEGER (0..31),
frequencyHoppingOffset INTEGER (1..maxNrofPhysicalResourceBlocks-1) OPTIONAL,
-- Need R
pathlossReferenceIndex INTEGER (0..maxNrofPUSCH-PathlossReferenceRSs-1),
...
} OPTIONAL, -- Need R
...
}
```

Hereinafter, a PUSCH transmission method will be described. A DMRS antenna port for PUSCH transmission is the same as an antenna port for SRS transmission. PUSCH transmission may follow a codebook-based transmission method and a non-codebook-based transmission method, respectively, according to whether a value of txConfig in a push-Config of [Table 36], which is a higher signaling is “codebook” or “nonCodebook.”

As described above, PUSCH transmission may be dynamically scheduled through a DCI format 0_0 or 0_1, and be semi-statically configured by configured grant. When the UE is instructed to schedule PUSCH transmission through a DCI format 0_0, the UE performs a beam configuration for PUSCH transmission using a pucch-spatialRelationInfoID corresponding to an UE-specific PUCCH resource corresponding to the minimum ID within the activated uplink BWP in the serving cell, and in this case, PUSCH transmission is performed based on a single antenna port. The UE does not expect scheduling for PUSCH transmission through a DCI format 0_0 in BWP in which a PUCCH resource including pucch-spatialRelationInfo is not configured. When the UE is not configured with txConfig in push-Config of [Table 36], the UE does not expect to be scheduled in a DCI format 0_1.

```
TABLE 36
PUSCH-Config := SEQUENCE {
dataScramblingIdentityPUSCH INTEGER (0..1023) OPTIONAL, -- Need S
txConfig ENUMERATED { codebook, nonCodebook} OPTIONAL, -- Need S
dmrs-UplinkForPUSCH-MappingTypeA SetupRelease { DMRS-UplinkConfig }
OPTIONAL, -- Need M
dmrs-UplinkForPUSCH-MappingTypeB SetupRelease { DMRS-UplinkConfig }
OPTIONAL, -- Need M
pusch-PowerControl PUSCH-PowerControl OPTIONAL, -- Need M
frequencyHopping ENUMERATED {intraSlot, interSlot} OPTIONAL, -- Need S
frequencyHoppingOffsetLists SEQUENCE (SIZE (1..4)) OF INTEGER (1..
maxNrofPhysicalResourceBlocks-1)
  OPTIONAL, -- Need M
resourceAllocation ENUMERATED { resourceAllocation Type0, resourceAllocation Type1,
dynamicSwitch},
pusch-TimeDomainAllocationList SetupRelease { PUSCH-
TimeDomainResourceAllocationList } OPTIONAL, -- Need M
pusch-AggregationFactor ENUMERATED { n2, n4, n8 } OPTIONAL, -- Need S
mcs-Table ENUMERATED {qam256, qam64LowSE} OPTIONAL, -- Need S
mcs-TableTransformPrecoder ENUMERATED { qam256, qam64LowSE} OPTIONAL,
-- Need S
transformPrecoder ENUMERATED { enabled, disabled } OPTIONAL, -- Need S
codebookSubset ENUMERATED { fullyAndPartialAndNonCoherent,
partial AndNonCoherent, nonCoherent}
  OPTIONAL, -- Cond codebookBased
maxRank INTEGER (1..4) OPTIONAL, -- Cond codebookBased
rbg-Size ENUMERATED { config2} OPTIONAL, -- Need S
uci-OnPUSCH SetupRelease { UCI-OnPUSCH} OPTIONAL, -- Need M
tp-pi2BPSK ENUMERATED { enabled} OPTIONAL, -- Need S
...
}
```

Hereinafter, codebook-based PUSCH transmission will be described. Codebook-based PUSCH transmission may be dynamically scheduled through a DCI format 0_0 or 0_1, and operate quasi-statically by a configured grant. When the codebook-based PUSCH is dynamically scheduled by a DCI format 0_1 or quasi-statically configured by a configured grant, the UE determines a precoder for PUSCH transmission based on a SRS resource indicator (SRI), transmission precoding matrix indicator (TPMI), and transmission rank (the number of PUSCH transmission layers).

In this case, the SRI may be given through a field SRS resource indicator in DCI or may be configured through an srs-ResourceIndicator, which is higher signaling. When transmitting a codebook-based PUSCH, the UE may be configured with at least one SRS resource, and be configured with maximum two SRS resources. In the case that the UE receives the SRI through DCI, the SRS resource indicated by the corresponding SRI means an SRS resource corresponding to the SRI among SRS resources transmitted earlier than the PDCCH including the corresponding SRI. Further, TPMI and transmission rank may be given through a field precoding information and number of layers in DCI or may be configured through precodingAndNumberOfLayers, which is higher signaling. The TPMI is used for indicating a precoder applied to PUSCH transmission. When the UE is configured with one SRS resource, the TPMI is used for indicating a precoder to be applied in the configured one SRS resource. When the UE is configured with a plurality of SRS resources, the TPMI is used for indicating a precoder to be applied in the SRS resource indicated through the SRI.

A precoder to be used for PUSCH transmission is selected from an uplink codebook having the same number of antenna ports as a value of nrofSRS-Ports in SRS-Config, which is higher signaling. In codebook-based PUSCH transmission, the UE determines a codebook subset based on TPMI and codebookSubset in push-Config, which is higher signaling. The codebookSubset in push-Config, which is higher signaling may be configured to one of “fullyAndPartialAndNonCoherent,” “partialAndNonCoherent,” or “nonCoherent” based on the UE capability reported by the UE to the base station. When the UE reported “partialAndNonCoherent” with the UE capability, the UE does not expect that a value of codebookSubset, which is higher signaling is configured to “fullyAndPartialAndNonCoherent.” Further, when the UE reported “nonCoherent” with the UE capability, the UE does not expect that a value of a codebookSubset, which is higher signaling is configured to “fully AndPartialAndNonCoherent” or “partialAndNonCoherent.” In the case that nrofSRS-Ports in an SRS-ResourceSet, which is higher signaling indicates two SRS antenna ports, the UE does not expect that a value of a codebookSubset, which is higher signaling is configured to “partialAndNonCoherent.”

The UE may be configured with one SRS resource set in which a value of usage in the SRS-ResourceSet, which is higher signaling is configured to “codebook,” and one SRS resource in the corresponding SRS resource set may be indicated through the SRI. When several SRS resources are configured in an SRS resource set in which a usage value in SRS-ResourceSet, which is higher signaling is configured to “codebook,” the UE expects that a value of nrofSRS-Ports in the SRS-Resource, which is higher signaling is configured to the same value for all SRS resources.

The UE transmits one or a plurality of SRS resources included in an SRS resource set in which a value of usage is configured to “codebook” to the base station according to higher signaling, and the base station selects one of SRS resources transmitted by the UE to instruct the UE to perform PUSCH transmission using transmission beam information of the corresponding SRS resource. In this case, in codebook-based PUSCH transmission, the SRI is used as information for selecting an index of one SRS resource and is included in DCI. Additionally, the base station includes information indicating the TPMI and rank to be used by the UE for PUSCH transmission in the DCI. The UE applies a rank indicated based on a transmission beam of the corresponding SRS resource and a precoder indicated by the TPMI to perform PUSCH transmission using the SRS resource indicated by the SRI.

Hereinafter, non-codebook based PUSCH transmission will be described. Non-codebook based PUSCH transmission may be dynamically scheduled through a DCI format 0_0 or 0_1, and operate quasi-statically by a configured grant. In the case that at least one SRS resource is configured in an SRS resource set in which a value of usage in the SRS-ResourceSet, which is higher signaling is configured to “nonCodebook,” the UE may receive scheduling of non-codebook based PUSCH transmission through a DCI format 0_1.

For an SRS resource set in which a value of usage in the SRS-ResourceSet, which is higher signaling is configured to “nonCodebook,” the UE may be configured with one connected non-zero power CSI-RS (NZP CSI-RS) resource. The UE may calculate a precoder for SRS transmission through measurement of an NZP CSI-RS resource connected to the SRS resource set. When the difference between a last reception symbol of an aperiodic NZP CSI-RS resource connected to the SRS resource set and a first symbol of aperiodic SRS transmission in the UE is smaller than 42 symbols, the UE does not expect that information on the precoder for SRS transmission is updated.

When a value of resourceType in SRS-ResourceSet, which is higher signaling is configured to “aperiodic,” the connected NZP CSI-RS is indicated by an SRS request, which is a field in a DCI format 0_1 or 1_1. In this case, when the connected NZP CSI-RS resource is an aperiodic NZP CSI-RS resource, it indicates that the connected NZP CSI-RS exists in the case that a value of a field SRS request in a DCI format 0_1 or 1_1 is not “00.” In this case, the corresponding DCI may not indicate cross carrier or cross BWP scheduling. Further, when a value of the SRS request indicates existence of the NZP CSI-RS, the corresponding NZP CSI-RS is located in a slot in which the PDCCH including the SRS request field is transmitted. In this case, TCI states configured to the scheduled subcarriers are not configured to QCL-TypeD.

When a periodic or semi-persistent SRS resource set is configured, the connected NZP CSI-RS may be indicated through associatedCSI-RS in an SRS-ResourceSet, which is higher signaling. For non-codebook based transmission, the UE does not expect that spatialRelationInfo, which is higher signaling for an SRS resource and associatedCSI-RS in SRS-ResourceSet, which is higher signaling are configured together.

In the case that the UE are configured with a plurality of SRS resources, the UE may determine a precoder and transmission rank to be applied to PUSCH transmission based on the SRI indicated by the base station. In this case, the SRI may be indicated through a field SRS resource indicator in DCI or may be configured through a srs-ResourceIndicator, which is higher signaling. Similar to the above-described codebook-based PUSCH transmission, in the case that the UE receives an SRI through DCI, the SRS resource indicated by the corresponding SRI means an SRS resource corresponding to the SRI among SRS resources transmitted earlier than the PDCCH including the corresponding SRI. The UE may use one or a plurality of SRS resources for SRS transmission, and the number of maximum SRS resources that may be simultaneously transmitted in the same symbol within one SRS resource set and the number of maximum SRS resources are determined by an UE capability reported by the UE to the base station. In this case, SRS resources transmitted simultaneously by the UE occupy the same RB. The UE configures one SRS port for each SRS resource. A SRS resource set in which a value of usage in the SRS-ResourceSet, which is higher signaling is configured to “nonCodebook” may be configured to only one, and SRS resources for non-codebook based PUSCH transmission may be configured to maximum four.

The base station transmits one NZP-CSI-RS connected to the SRS resource set to the UE, and the UE calculates a precoder to use when transmitting one or a plurality of SRS resources in the corresponding SRS resource set based on the measured result upon receiving the corresponding NZP-CSI-RS. The UE applies the calculated precoder when transmitting one or a plurality of SRS resources in the SRS resource set in which the usage is configured to “nonCodebook” to the base station, and the base station selects one or a plurality of SRS resources among one or a plurality of received SRS resources. In this case, in non-codebook based PUSCH transmission, the SRI indicates an index capable of expressing a combination of one or a plurality of SRS resources, and the SRI is included in DCI. In this case, the number of SRS resources indicated by the SRI transmitted by the base station may be the number of transmission layers of the PUSCH, and the UE applies a precoder applied to transmission of the SRS resource to each layer to transmit the PUSCH.

### [Related to UE Capability Reporting]

In LTE and NR, the UE may perform a procedure that reports a capability supported by the UE to the corresponding base station in a state connected to the serving base station. In the description below, this is referred to as a UE capability report.

The base station may transmit a UE capability enquiry message requesting a capability report to the UE in a connected state. The message may include a UE capability request for each radio access technology (RAT) type of the base station. The request for each RAT type may include information on a combination of supporting frequency bands, and the like. Further, in the case of the UE capability enquiry message, multiple UE capabilities for each RAT type may be requested through one RRC message container transmitted by the base station, or the base station may include a UE capability enquiry message including a UE capability request for each RAT type multiple times and transmit the UE capability enquiry message to the UE. That is, the UE capability enquiry may be repeated multiple times in one message, and the UE may constitute a corresponding UE capability information message and report the UE capability enquiry message multiple times. In a next generation mobile communication system, a UE capability request may be made for Multi-RAT dual connectivity (MR-DC) including NR, LTE, and E-UTRA-NR dual connectivity (EN-DC). Further, the UE capability enquiry message is generally transmitted initially after the UE is connected to the base station, but the UE capability enquiry message may be requested under any conditions when the base station is needed.

In the above step, the UE that has received the UE capability report request from the base station constitutes a UE capability according to the RAT type and band information requested from the base station. Hereinafter, a method in which the UE constitutes the UE capability in the NR system is described.

1. If the UE receives a list of LTE and/or NR bands from the base station as a UE capability request, the UE constitutes a band combination (BC) for EN-DC and NR stand alone (SA). That is, the UE constitutes a candidate list of BCs for EN-DC and NR SA based on bands requested to the base station in a FreqBandList. Further, a priority of the bands is given in the order listed in FreqBandList.

2. In the case that the base station sets an “eutra-nr-only” flag or an “eutra” flag to request a UE capability report, the UE completely removes a candidate list of NR SA BCs from a candidate list of the constituted BCs. This operation may occur only in the case that the LTE base station (eNB) requests an “eutra” capability.

3. Thereafter, the UE removes fallback BCs from the candidate list of BCs constituted in the above step. Here, the fallback BCs mean BCs that may be obtained by removing a band corresponding to at least one SCell from any BC, and may be omitted because BCs before removing a band corresponding to at least one SCell may already cover the same. This step is also applied to MR-DC, that is, to LTE bands. BCs remaining after this step are a final “candidate BC list.”

4. The UE selects BCs that match the requested RAT type from the final “candidate BC list” to select BCs to report. In this step, the UE constitutes a supportedBandCombinationList in the determined order. That is, the UE constitutes BCs and UE capabilities to report in the order of the preconfigured rat-Type (nr->eutra-nr->eutra). Further, the UE constitutes a featureSetCombination for the constituted supportedBandCombinationList, and constitutes a list of “candidate feature set combinations” from the candidate BC list from which the list of the fallback BCs (including capabilities of the same or lower level) is removed. The “candidate feature set combination” includes all feature set combinations for NR and EUTRA-NR BCs, and may be obtained from feature set combinations of UE-NR-Capabilities and UE-MRDC-Capabilities containers.

5. Further, if the requested rat Type is eutra-nr and influencing, featureSetCombinations are included in both containers of UE-MRDC-Capabilities and UE-NR-Capabilities. However, a feature set of NR is included only in UE-NR-Capabilities.

After the UE capability is constituted, the UE transmits a UE capability information message including the UE capability to the base station. Based on the UE capability received from the UE, the base station then performs appropriate scheduling and transmission and reception management for the corresponding UE.

### Embodiment 1: L1-RSRP and L1-SINR Measurement and Reporting Method

As an embodiment of the disclosure, a method of measuring and reporting L1-RSRP and L1-SINR of the UE is described. This embodiment may operate in combination with other embodiments. For example, Embodiment 1 may operate in combination with Embodiment 2 and/or Embodiment 3.

As an embodiment of the disclosure, a method of measuring and reporting L1-RSRP of the UE is described.

For L1-RSRP calculation, the following may be considered:
The UE may receive a configuration of one or more CSI-RS resources, one or more SSB resources, or both CSI-RS resources and SSB resources having a QCL relationship with QCL-TypeC and QCL-TypeD between resources, and the CSI-RS resources and SSB resources may be included in different resource sets.
The UE may receive a configuration of maximum 64 CSI-RS resources within one CSI-RS resource set.
The UE may receive a configuration of maximum 16 CSI-RS resource sets.
The UE may receive a configuration of the number of different CSI-RS resources to maximum 128 across all CSI-RS resource sets.

For L1-RSRP reporting, in the case that the UE receive a configuration of nrofReportedRS in CSI-ReportConfig, which is upper layer signaling, to 1, a reported L1-RSRP value may be quantized into 7 bits, and the range of the corresponding value may be defined from −140 dBm to −44 dBm in 1 dB intervals. In the case that the UE is configured with nrofReportedRS in CSI-ReportConfig, which is upper layer signaling, to be greater than 1 or that the UE is configured with groupBasedBeamReporting, which is upper layer signaling, to enabled, the UE may quantize the largest value among measured L1-RSRP into 7 bits, and the range of the corresponding value may be defined from −140 dBm to −44 dBm in 1 dB intervals, and a differential L1-RSRP that may mean a relative RSRP value from the largest L1-RSRP value may be quantized into 4 bits, and the interval of the corresponding value may be defined to 2 dB. The corresponding differential L1-RSRP may be reported together with the largest L1-RSRP value.

In the case that timeRestrictionForChannelMeasurements, which is upper layer signaling configured in CSI-ReportConfig is configured to “notConfigured” to the UE, the UE may calculate an L1-RSRP value to be reported in an uplink slot n based on the CSI-RS or SSB in the CSI resource setting connected to the L1-RSRP report received in or before the CSI reference resource that may be defined on the time resource.

In the case that timeRestrictionForChannelMeasurements, which is upper layer signaling configured in CSI-ReportConfig is configured to “Configured” to the UE, the UE may calculate an L1-RSRP value to be reported in an uplink slot n based only on the most recent reception position among the CSI-RS or SSB in the CSI resource setting connected to an L1-RSRP report received in or before the CSI reference resource that may be defined on the time resource.

The following [Table 37] illustrates the disposition order of information when reporting L1-RSRP. In this case, a bit length of the CRI and SSBRI below may be defined as the number of bits that may express the number of CSI-RS resources in the CSI-RS resource set (e.g., ┌log₂(Kₛ^{CSI-RS})┐r the number of bits that may express the number of SSB resources in the SSB resource set (e.g., ┌log₂(Kₛ^{SSB})┐ In this case, Kₛ^{CSI-RS} and Kₛ^{SSB} may mean the number of CSI-RS resources in the CSI-RS resource set and the number of SSB resources in the SSB resource set, respectively. As described above, RSRP and Differential RSRP may be expressed with 7 bits and 4 bits, respectively.

TABLE 37

| CSI report number | CSI fields |
|---|---|
| CSI report #n | CRI or SSBRI #1 |
| | CRI or SSBRI #1 |
| | CRI or SSBRI #1 |
| | CRI or SSBRI #1 |
| | RSRP #1 |
| | Differential RSRP #2 |
| | Differential RSRP #3 |
| | Differential RSRP #4 |

As an embodiment of the disclosure, a method of configuring resources for L1-SINR measurement and reporting is described. The above [Table 8] is about CSI-ReportConfig configured through upper layer signaling related to CSI reporting, and may be used for describing L1-SINR measurement to be described later.

If one resource setting is configured in CSI-ReportConfig, which is upper layer signaling, for L1-SINR measurement, the corresponding resource setting (e.g., resourcesForChannelMeasurement, which is upper layer signaling) may be an NZP CSI-RS for channel and interference measurement. In this case, the UE may assume that the NZP CSI-RS with 1 port and 3 REs/RB as a density value is used for channel and interference measurement.

If two resource settings are configured in CSI-ReportConfig, which is upper layer signaling, for L1-SINR measurement, a corresponding first resource setting (e.g., resourcesForChannelMeasurement, which is upper layer signaling) may be an SSB or NZP CSI-RS for channel measurement, and a corresponding second resource setting (e.g., csi-IM-ResourcesForInterference or nzp-CSI-RS-ResourcesForInterference, which is upper layer signaling) may be an CSI-IM for interference measurement or an NZP CSI-RS with 1 port and 3 REs/RB as a density value. In this case, the SSB or NZP CSI-RS for channel measurement may be connected to 1 CSI-IM resource or 1 NZP CSI-RS for interference measurement within the same resource set. The number of SSBs or NZP CSI-RSs for channel measurement may be the same as the number of CSI-IM or NZP CSI-RS for interference measurement.
In this case, when the UE determines an SSB for channel measurement, or a reference RS for the CSI-IM connected to the NZP CSI-RS or the QCL-TypeD of the NZP CSI-RS for interference measurement, the UE may use the SSB for channel measurement or the reference RS for the QCL-TypeD of the NZP CSI-RS for channel measurement.
Further, the UE may expect that an NZP CSI-RS resource set for channel measurement and an NZP CSI-RS resource set for interference measurement are configured to repetition, which is higher layer signaling. That is, both the NZP CSI-RS resource set for channel measurement and the NZP CSI-RS resource set for interference measurement may be used for beam management.

For L1-SINR measurement based on a specific interference measurement resource, the UE may assume that total power received from a specific NZP CSI-RS resource for interference measurement or a specific CSI-IM resource for interference measurement corresponds to interference and noise.

For L1-SINR calculation, the UE may receive a configuration of an NZP CSI-RS resource and/or an SSB resource for channel measurement, and an NZP CSI-RS or CSI-IM resource for interference measurement. In this case, the UE may receive a configuration of maximum 16 CSI resource sets for channel measurement, and maximum 64 CSI-RS or 64 SSB resources across all resource sets.

In the case that the above one or two resource settings are configured for L1-SINR measurement, time restriction for channel measurement or interference measurement to be described later may be considered.
In the case that timeRestrictionForChannelMeasurements is configured to “notConfigured” in CSI-ReportConfig, which is upper layer signaling, the UE may need to derive channel measurement for calculating L1-SINR to be reported in the n-th uplink slot based on an SSB or NZP CSI-RS that may be received temporally earlier than the CSI reference resource connected to one or two resource settings described above.
In the case that timeRestrictionForChannelMeasurements is configured to “configured” in CSI-ReportConfig, which is upper layer signaling, the UE may need to derive channel measurement for calculating L1-SINR to be reported in the n-th uplink slot based on the most recent SSB or NZP CSI-RS that may be received temporally earlier than the CSI reference resource connected to one or two resource settings described above.
In the case that timeRestrictionForInterferenceMeasurements is configured to “notConfigured” in CSI-ReportConfig, which is upper layer signaling, the UE may need to derive interference measurement for calculating L1-SINR to be reported in the n-th uplink slot based on an NZP CSI-RS for interference measurement or CSI-IM that may be received temporally earlier than the CSI reference resource connected to one or two resource settings described above.
In the case that timeRestrictionForChannelMeasurements is configured to “configured” in CSI-ReportConfig, which is upper layer signaling, the UE may need to derive interference measurement for calculating L1-SINR to be reported in the n-th uplink slot based on the most recent one of an NZP CSI-RS for interference measurement or CSI-IM that may be received temporally earlier than a CSI reference resource connected to one or two resource settings described above.

An L1-SINR reporting method of the UE is described.

When reporting L1-SINR, the UE may constitute UCI using a specific quantization level according to conditions to be described later and report the UCI to the base station.
If nrofReportedRS is configured to 1 in CSI-ReportConfig, which is upper layer signaling, an L1-SINR value may be quantized to 7 bits using a step size of 0.5 dB for values within the range of [−23, 40] dB and reported.
In the case that nrofReportedRS in CSI-ReportConfig, which is upper layer signaling is greater than 1, or that groupBasedBeamReporting, which is upper layer signaling is configured to “enabled,” the UE may use differential L1-SINR reporting. In this case, the maximum L1-SINR value may be quantized to 7 bits using a step size of 0.5 dB for a value within the range of [−23, 40] dB, and the differential L1-SINR value may be quantized to 4 bits using a step size of 1 dB for the difference with the maximum L1-SINR reported together with the corresponding differential L1-SINR. In the case that the NZP CSI-RS is configured for channel measurement and/or interference measurement, the reported L1-SINR value may expect not to be compensated for power offset such as powerControlOffsetSS or powerControlOffset, which is upper layer signaling.

In the case that the UE receives a configuration of reportQuantity to “cri-SINR” or “ssb-Index-SINR” in CSI-ReportConfig, which is upper layer signaling, the UE may consider operations to be described later related to group based beam reporting.
In the case that the UE receives a configuration of groupBasedBeamReporting, which is upper layer signaling to “disabled,” the UE may include the nrofReportedRS number of different CRIs or SSBRIs configured through upper layer signaling in a single report to report it to the base station.
In the case that the UE receives a configuration of groupBasedBeamReporting, which is upper layer signaling to “enabled,” the UE may include two different CRIs or SSBRIs in one report to report it to the base station. In this case, the CSI-RS and/or SSB indicated by the CRI or SSBRI may be those received simultaneously from the UE.

In the case that the UE receives a configuration of reportQuantity to “ssb-Index-SINR” in CSI-ReportConfig, which is upper layer signaling, the UE may need to derive L1-SINR based on the SSBRI reported to the base station. In this case, SSBRIk (k>0) may correspond to the (k+1)th entry of csi-SSB-ResourceList in the CSI-SSB-ResourceSet for channel measurement, and be connected to the (k+1)th entry of csi-IM-Resource in the csi-IM-ResourceSet or the (k+1)th entry of nzp-CSI-RS-Resources in the NZP-CSI-RS-ResourceSet for interference measurement.

If the UE receives a configuration of reportQuantity to “cri-RSRP,” “cri-SINR,” or “none” in CSI-ReportConfig, which is upper layer signaling, and the CSI-ReportConfig is connected to a resource setting in which a resourceType, which is upper layer signaling is configured to “aperiodic,” the UE may not expect that more than 16 CSI-RS resources are configured in the CSI-RS resource set included in the corresponding resource setting.

Equation for the priority rule described above may be considered as PriiCSI (y, k, c, s)=2·Ncells·Ms·y+Ncells·Ms·k+Ms·c+s, and in the case of CSI report including L1-SINR report, it may be considered as k=0.

The following [Table 38] illustrates the disposition order of information when reporting L1-SINR. In this case, a bit length of the CRI and SSBRI below may be defined as the number of bits that may express the number of CSI-RS resources in the CSI-RS resource set (e.g., ┌log₂(Kₛ^{CSI-RS})┐r the number of bits that may express the number of SSB resources in the SSB resource set (e.g., ┌log₂(Kₛ^{SSB})┐In this case, Kₛ^{SSI-RS} and K_s\hat{ }SSB may mean the number of CSI-RS resources in the CSI-RS resource set and the number of SSB resources in the SSB resource set, respectively. As described above, SINR and Differential SINR may be expressed with 7 bits and 4 bits, respectively.

TABLE 38

| CSI report number | CSI fields |
|---|---|
| CSI report #n | CRI or SSBRI #1 |
| | CRI or SSBRI #1 |
| | CRI or SSBRI #1 |
| | CRI or SSBRI #1 |
| | SINR #1 |
| | Differential SINR #2 |
| | Differential SINR #3 |
| | Differential SINR #4 |

### Embodiment 2: CSI Reporting Event Initiated by the UE and Reported Information

In an embodiment of the disclosure, a CSI reporting event initiated by the UE and reported information is described. This embodiment may operate in combination with other embodiments. For example, Embodiment 2 may operate in combination with Embodiment 1 and/or Embodiment 3.

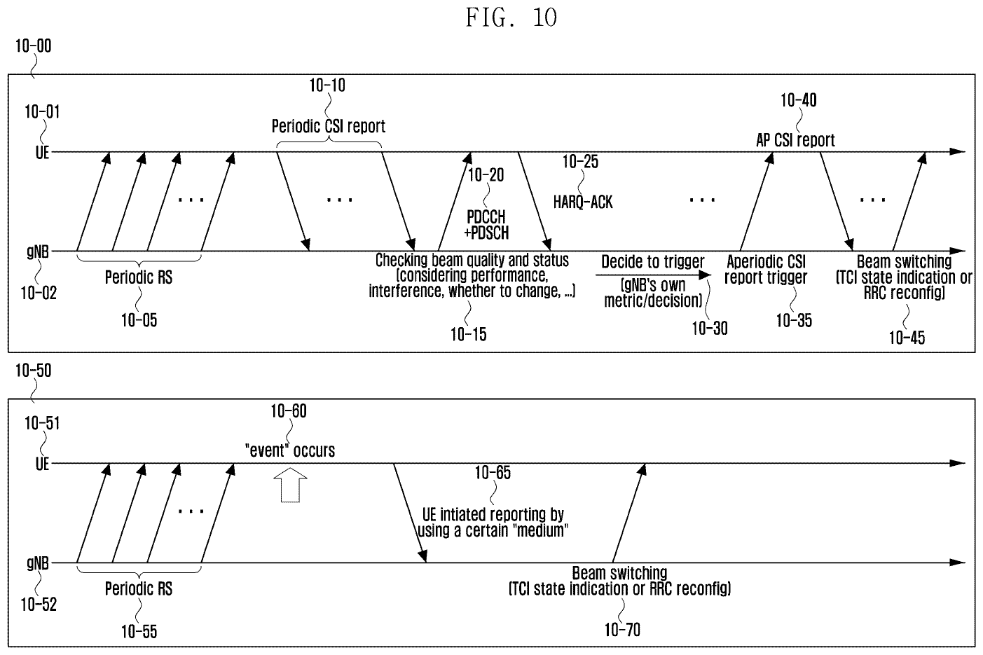

FIG. 10 illustrates a channel measurement and channel state reporting method according to a configuration and instruction of the base station according to an embodiment of the disclosure.

In FIG. 10, a process 10-00 relates to a method of securing and managing a downlink beam performance between the UE and the base station according to periodic reference signal reception and periodic channel state information reporting at the UE, and/or an aperiodic channel state information reporting trigger at the base station and aperiodic channel state information reporting method at the UE.

A base station 10-02 may notify a UE 10-01 of configuration information related to periodic reference signal reception and corresponding periodic channel state information reporting through upper layer signaling. Accordingly, the UE may receive a periodic reference signal transmitted from the base station (10-05) and report corresponding periodic channel state information (10-10). In this case, the corresponding periodic channel state information may include a performance of a downlink reception beam calculated in the UE. The base station may identify a downlink reception beam performance of the UE based on periodic reference signal reception and measurement and periodic channel state information reporting of the UE (10-15), and the shorter a period of reference signal reception and measurement and channel state information reporting, the more accurately a downlink reception beam performance of the UE may be identified, but a lot of signaling overhead may be consumed for transmission and reception of reference signals and transmission and reception of channel state information reports between the UE and the base station. In contrast, if the period of reference signal reception and measurement and channel state information reporting is long, to identify a reception beam performance of the UE by the base station may be relatively inaccurate; thus, the base station may determine to trigger an aperiodic channel state information report in order to identify a reception beam performance from the UE in the middle of the long period (10-30), and transmit a signal triggering the aperiodic channel state information report to the UE (10-35). Thereafter, the UE may perform an aperiodic channel state information report corresponding to aperiodic channel state information report triggering of the base station (10-40), and the base station may synthesize this information, and in the case that a beam performance of the downlink reception beam of the UE is insufficient and that it is necessary to change the downlink reception beam to another beam, the base station may notify beam switching (10-45), and the beam switching may use a method such as a change in the TCI state instructed to the UE or an RRC reconfiguration for changing the configuration of the source RS in the TCI state. However, in order for the base station to trigger an aperiodic channel state information report to the UE, the base station may assume implicit information from the UE for making this determination through base station implementation. Representative implicit information for this may include a PDCCH transmitted by the base station to the UE and PDSCH reception that may be scheduled through the PDCCH (10-20), and PUCCH transmission from the UE including HARQ-ACK information indicating whether PDSCH reception was successful (10-25). Based on information such as periodic channel state information report (10-10) that may be received from the UE and a PUCCH including HARQ-ACK information corresponding to the PDSCH scheduled to the UE (10-25), the base station may make a determination as to whether the UE needs to change a downlink reception beam or, if not, whether it is okay to maintain the current reception beam. However, because such information may be implicit information or, even if such information is direct information, it is highly likely that it is not information that the base station may obtain when it wants, an amount of information at the base station for a downlink reception beam performance of the UE may be insufficient in an absolute amount or may already be information from the past.

In FIG. 10, a process 10-50 relates to a method of securing and managing a transmission and reception beam performance between the UE and the base station according to a channel state information reporting method initiated from the UE according to occurrence of a specific event at the UE.

In order to solve problems in the above-described process 10-00, a base station 10-52 may notify a UE 10-51 of a channel state information reporting method initiated from the UE based on at least one combination of upper layer signaling, MAC-CE signaling, or L1 signaling. Based on this, the UE may receive at least one combination of a periodic reference signal, a semi-persistent reference signal, or an aperiodic reference signal (10-55), and the UE may perform channel state information reporting initiated therefrom (10-65) according to occurrence of a specific event defined therein (10-60). Thereafter, the base station may notify beam switching based on information transmitted from the UE (10-70).

Unlike the base station triggering aperiodic channel state information reporting or notifying beam switching based on implicit information, a channel state information reporting method initiated from the UE allows the UE to arbitrarily transmit a downlink reception beam performance of the UE to the base station, and even if the base station does not trigger aperiodic channel state information reporting, the base station may immediately identify and take a corresponding action (e.g., trigger aperiodic channel state information reporting or instruct beam switching) in the case that the downlink reception beam performance of the UE changes according to a specific event defined by the UE. According to channel state information reporting initiated from the UE, the base station may immediately respond to a change in the downlink reception beam if necessary, thereby reducing a delay time for beam management. Further, unlike obtaining the similar effect of allowing the base station to quickly identify a downlink reception beam performance of the UE even without channel state information reporting initiated from the UE by reducing a period of periodic reference signal reception and periodic channel state information reporting between the UE and the base station, a signaling overhead of reference signal and channel state information reporting may be significantly reduced.

For the above-described channel state information reporting method initiated from the UE, the UE needs to define a specific event (10-60) and notify the base station that a downlink reception beam performance of the UE has changed in the case that the corresponding event occurs. The UE may consider at least one combination of the following items for defining a specific event for performing the above-described channel state information reporting initiated therefrom.

### [Method 2-1]

The UE may be configured to enable a set of channel measurement reference signals for reporting channel state information initiated therefrom and a set of channel measurement reference signals for reporting periodic channel state information to be the same (e.g., a set of channel measurement reference signals). The UE may measure a reception beam performance (e.g., L1-RSRP or L1-SINR) through the set of channel measurement reference signals, and report the corresponding reception beam performance to the base station through periodic channel state information reporting. In the case that a reception beam with the best performance among periodically reported reception beam performances (e.g., L1-RSRP or L1-SINR) is changed through measurement of a reception beam performance for the set of channel measurement reference signals, the UE may perform channel state information reporting initiated therefrom. In this case, the UE may consider the following items in order to define the criteria for changing the reception beam with the best performance.
In the case that a reception beam with the best performance is the same during X consecutive periodic channel state information reports (X is any natural number).
In the case that a reception beam with the best performance is the same while continuously measuring each channel measurement reference signal connected to the corresponding channel state information report X times after the most recent channel state information report (X is any natural number).
In the case that a performance of any other receiving beam is higher than that of the reception beam with the best performance by a reference value or more (e.g., Y dB) during Z consecutive times.

For the above X, Y, and Z values, the UE may expect that it is notified by the base station through at least one combination of upper layer signaling, MAC-CE signaling, and L1 signaling or is fixedly defined in the standard. For example, the UE may consider X as 3 times, Y as 2 dB, which is an interval of the conventional differential RSRP, and Z as 1 time, and in the case that an L1-RSRP value of a first CSI-RS is the maximum value during three consecutive periodic channel state information reports, or in the case that the L1-RSRP value of the first CSI-RS is the maximum value while continuously measuring each channel measurement reference signal connected to the corresponding channel state information reports three times after the most recent periodic channel state information report and that an L1-RSRP value of a second CSI-RS becomes higher by 2.5 dB than the L1-RSRP value of the first CSI-RS once, the UE may transmit the L1-RSRP value of the second CSI-RS or an L1-RSRP differential value with the reception beam with the best performance (e.g., the first CSI-RS) to the base station based on the channel state information report initiated therefrom. The X, Y, and Z values are only examples, and other values may not be excluded.

When defining the above X value, the UE may define a counter and/or a timer for counting X in order to prevent channel state information reporting initiated therefrom from being performed too frequently and to report therefrom to the base station only when necessary. The UE may consider similar values when defining the Z value.
The UE may define a counter Xmax value and calculate within the Xmax when counting the consecutive Xs. For example, in the case that Xmax is 5 and that X is defined as 3, the UE may regard that the definition of the criterion for changing the reception beam with the best performance is satisfied only in the case that a reception beam with the best performance is the same during three consecutive times within five periodic channel state information reports. For example, in the case that the first CSI-RS has the largest L1-RSRP value consecutively in the second, third, and fourth channel state information reports among five periodic channel state information reports, the UE may regard that the first CSI-RS meets the definition of the criterion for changing the reception beam with the best performance. Conversely, while the first CSI-RS has the largest L1-RSRP value consecutively in the fourth and fifth channel state information reports among five periodic channel state information reports, in the case that the first CSI-RS still has the largest L1-RSRP value in the next channel state information report, the UE may regard that the first CSI-RS does not meet the definition of the criterion for changing the reception beam with the best performance.
The UE may start a timer after performing channel state information reporting initiated therefrom, but may not perform counting for the X value during the defined time period, and accordingly, may not perform channel state information reporting initiated therefrom.

In the case that there is one or more reception beams with a better performance than that of the reception beam with the best performance while the reception beam with the best performance is changed through the above-described [Method 2-1], the UE may transmit a performance of a single reception beam with the best performance among them to the base station through a channel state information report initiated therefrom or may transmit a performance of as many reception beams as the number notified by the base station through at least one combination of upper layer signaling, MAC-CE signaling, and L1 signaling, or the number fixedly defined in the standard to the base station through a channel state information report initiated therefrom.

In the case that the UE performs channel state information reporting initiated therefrom through the above-described [Method 2-1], the UE may consider at least one combination of L1-RSRP, L1-SINR, channel measurement reference signal index, or performance difference value compared to the best reception beam performance as information to be included in the channel state information report.

### [Method 2-2]

The UE may individually receive a configuration of a set of channel measurement reference signals (first channel measurement reference signal set) for reporting channel state information initiated therefrom and a set of channel measurement reference signals (second channel measurement reference signal set) for reporting periodic channel state information. The UE may expect that there is no reference signal commonly included in the first channel measurement reference signal set and the second channel measurement reference signal set (i.e., reference signals in the two sets are independent of each other), or that there is one or more reference signal (i.e., some of reference signals in the two sets are common and some of the remaining reference signals are independent of each other). In this case, the UE may regard reference signals in the first channel measurement reference signal set and reference signals in the second channel measurement reference signal set as reference signals transmitted within the same cell that may be measured by the UE for the purpose of identifying reception beam performance and beam switching within the cell, or as reference signals transmitted within different cells for the purpose of identifying a reception beam performance and cell switching between cells (such as L1/L2 signaling-based handover). The UE may measure a reception beam performance through the second channel measurement reference signal set (e.g., L1-RSRP or L1-SINR), and report the corresponding reception beam performance to the base station through periodic channel state information reporting. In the case that a reception beam with the best performance among periodically reported reception beam performances (e.g., L1-RSRP or L1-SINR) through reception beam performance measurement for the second channel measurement reference signal set has a lower performance than the reception beam with the best performance identified based on the reception beam performance measurement for the first channel measurement reference signal set, the UE may perform channel state information reporting initiated therefrom. In this case, the UE may similarly consider X, Y, and Z values considered in the above [Method 2-1] in order to define a criterion for changing the reception beam with the best performance, and additionally consider a counter and/or a timer for X considered in the above-described [Method 2-1].

When considering the above-described [Method 2-2], the UE may consider one or more sets of channel measurement reference signals for reporting channel state information initiated therefrom, and in this case, each set may correspond to different cells.

In the case that the UE performs channel state information reporting initiated therefrom through the above-described [Method 2-2], the UE may consider at least one combination of L1-RSRP, L1-SINR, channel measurement reference signal index, performance difference value compared to the best reception beam performance, channel measurement reference signal set index, or cell index as information to be included in the channel state information report.

### [Method 2-3]

The UE measures a performance of source RSs for QCL-TypeD for at least one TCI state in which QCL-TypeD is configured among activated TCI states at each code point of the TCI state field in the DCI, and in the case that the UE operates in a unified TCI state scheme, if the UE has a higher reception beam performance than a performance of a source RS for QCL-TypeD in the TCI state indicated and applied by the base station, as described above, the UE may perform channel state information reporting initiated therefrom. In order to define a criterion for the case that the UE has a higher reception beam performance than a performance of a source RS for QCL-TypeD in the TCI state indicated and applied by the base station, as described above, the UE may similarly consider X, Y, and Z values considered in the above [Method 2-1], and additionally consider a counter and/or a timer for X considered in the above-described [Method 2-1].

When considering the above-described [Method 2-3], the UE may assume source RSs for QCL-TypeD as a set of channel measurement reference signals for a channel state information report initiated therefrom for at least one TCI state in which QCL-TypeD is configured among activated TCI states at each code point of the TCI state field in the current DCI. In this case, the corresponding source RS may be a reference signal received by the UE from the same cell or a different cell.

In the case that the UE performs channel state information reporting initiated therefrom through the above-described [Method 2-3], the UE may consider at least one combination of L1-RSRP, L1-SINR, channel measurement reference signal index, performance difference value compared to the best reception beam performance, channel measurement reference signal set index, or cell index as information to be included in the channel state information report.

### [Method 2-4]

For the above [Method 2-1] to [Method 2-3], in the case that a value measured through a channel measurement reference signal is lower than a specific reference value during a specific time, the UE may perform channel state information reporting initiated therefrom in order to change or delete the corresponding channel measurement reference signal or set of channel measurement reference signals.

The UE may consider similarly to X and Y defined in the above-described [Method 2-1] for a specific reference value that may be defined for comparing the specific time and performance.

### [Method 2-5]

The UE may be notified by the base station of the use of at least one combined method of the above [Method 2-1] to [Method 2-4] through at least one combination of upper layer signaling, MAC-CE signaling, and L1 signaling, or may be fixedly defined in the standard.

The UE may be notified by the base station of at least one combination of the above [Method 2-1] to [Method 2-5] through at least one combination of upper layer signaling, MAC-CE signaling, and L1 signaling, or may expect that at least one combination of the above [Method 2-1] to [Method 2-5] is fixedly defined in the standard. Additionally, in the case that the UE is notified by the base station of a combination of at least one specific method through at least one combination of upper layer signaling, MAC-CE signaling, and L1 signaling, it may mean that the UE cannot support a combination of at least one specific other method. For example, the UE may expect that the above [Method 2-2] is fixedly defined in the standard for a specific event that may be defined for reporting channel state information initiated therefrom and an operation related to at least one parameter that may be introduced therefor. As another example, the UE may be notified by the base station for the above [Method 2-2] through at least one combination of upper layer signaling, MAC-CE signaling, and L1 signaling, and in this case, it may be regarded that the UE has been notified by the base station that the above [Method 2-2] is not supported.

The UE may report to the base station as a UE capability as to whether it may support at least one combination of the above [Method 2-1] to [Method 2-5]. In this case, in the case that the UE reports to the base station as a UE capability that a combination of one or more specific methods may be supported, it may be regarded that the UE has reported that it cannot support a combination of one or more specific other methods. For example, the UE may report to the base station as to whether it may support the above [Method 2-1] or [Method 2-2]. As another example, the UE may report to the base station that it may support the above [Method 2-1], and such a UE capability report may mean that the UE cannot support [Method 2-2].

For the above-described [Method 2-1] to [Method 2-5], the UE may define a timer that does not monitor occurrence of a specific event. As an example, in the case that beam switching occurs in the base station, the UE may not monitor a specific event defined in the above [Method 2-1] to [Method 2-5] during a certain time from the corresponding time point. As another example, after a specific event defined in the above [Method 2-1] to [Method 2-5] has occurred, the UE may not monitor a specific event defined in the above [Method 2-1] to [Method 2-5] during a certain time from the corresponding time point. This makes it possible to prevent frequent information exchange and beam switching between the UE and the base station by preventing channel state information reporting initiated from the UE during a certain time after the base station configures or instructs beam switching.

The UE may monitor only one of specific events defined in the above-described [Method 2-1] to [Method 2-5], and in the case that the corresponding event occurs, the UE may perform channel state information reporting initiated therefrom, may independently monitor one or more specific events to perform channel state information reporting initiated therefrom corresponding to each event, or may individually monitor one or more specific events, but in the case that one or more events occur simultaneously, the UE may perform only channel state information reporting initiated therefrom corresponding to the event with the highest priority. For each of the above cases, the UE may apply the timer individually or commonly. In the case that the UE monitors one or more events, commonly applying the timer may mean a method of applying a timer to be applied in the case that a specific event occurs to other events in the same manner.

### Embodiment 3: CSI Reporting Method Initiated by the UE

As an embodiment of the disclosure, a CSI reporting method initiated by the UE is described. This embodiment may operate in combination with other embodiments. For example, Embodiment 3 may operate in combination with Embodiment 1 and/or Embodiment 2.

After a specific event defined in the Embodiment 2 described above for reporting channel state information initiated from the UE has occurred, the UE may perform channel state information reporting initiated therefrom to transmit information related to a reception beam performance to the base station. In this case, the UE may determine which process to go through when reporting channel state information initiated therefrom in consideration of a combination of at least one of the following methods.

### [Method 3-1]

The UE may receive a configuration of one or more PUCCH resources for reporting channel state information initiated therefrom, and in the case that the above-described specific event occurs in the UE, the UE may select one of one or more PUCCH resources and transmit it to the base station. In this case, in the case that a specific single event occurs, the UE may receive a configuration of one or more PUCCH resources for the purpose of reporting specific information, and each PUCCH resource may mean specific information. In another method, the UE may receive a configuration of one or more PUCCH resources for the purpose of reporting individual information on one or more different events, and it may be regarded that each PUCCH resource means a response of the UE to each event and a channel state information report initiated therefrom corresponding to the response. In this case, the UE may receive a configuration of a period and offset in units of a slot for each PUCCH resource, and in the case that the specific event occurs, the UE may transmit a specific PUCCH resource at a closest period after a specific time offset from a time point of occurrence of the corresponding specific event. In this case, a specific time offset may be defined in units of a slot or ms, and include 0 among possible values (i.e., a specific time offset may not be required). Such a time offset may be defined through at least one combination of methods defined as a UE capability to be reported by the UE to the base station, notified by the base station through a combination of at least one of upper layer signaling, MAC-CE signaling, L1 signaling, or fixedly defined in the specification.

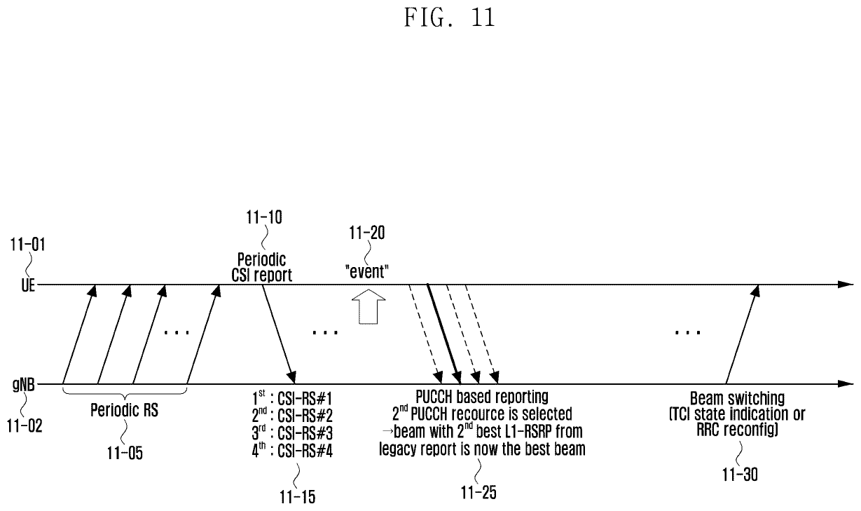

FIG. 11 illustrates an operation process of a UE and a base station for a CSI report initiated by a UE using one or more PUCCH resources according to an embodiment of the disclosure.

A UE 11-01 may receive a configuration of a set of periodic channel measurement reference signals from a base station 11-02 through upper layer signaling, and periodically receive the same to measure a reception beam performance (11-05). Thereafter, the UE may perform periodic channel state information reporting (11-10) and consider a reception beam performance index included in the corresponding channel state information report as an L1-RSRP. As an example, the UE may report an L1-RSRP value for a first CSI-RS as a reception beam performance included in the periodic channel state information report (11-10) performed at any time point as a largest L1-RSRP value, and report a second CSI-RS, a third CSI-RS, and a fourth CSI-RS in that order as reference signals having the next largest L1-RSRP values. Thereafter, in the case that a specific event occurs in the UE (11-20), for example, in the case that the second CSI-RS is measured to have a better performance than that of the first CSI-RS based on an event defined in the above [Method 2-1], the UE transmits, to the base station, a PUCCH resource corresponding to a specific order among reported four CSI-RSs upon reporting periodic channel state information (e.g., if it is assumed that each PUCCH resource is connected in order with an index of each CSI-RS, it may be assumed that the second CSI-RS is connected with a second PUCCH resource), and the UE may report to the base station that a reception beam performance of the second CSI-RS is now better than that of the first CSI-RS (11-25). Thereafter, in the case that the base station determines that beam switching is necessary for the UE, the base station may configure or instruct it to the UE (11-30).

In the case of considering the above-described [Method 3-1], because a process of reporting channel state information initiated from the UE may be relatively shortened, there may be an advantage in terms of a delay time. However, because the UE may receive a configuration of one or more PUCCH resources and transmit it after one or more specific events occur, the base station has no information at all on which event occurred in which UE and which PUCCH resource was transmitted; thus, blind decoding may need to be performed for one or more PUCCH resources for each different UE, which may increase overhead, and in the case that a PUCCH resource different from that transmitted by the UE is successfully decoded, an error propagation phenomenon may also occur. Further, because a process between the UE and the base station is simple, an amount of information that the UE may transmit through [Method 3-1] may be less than that of other methods.

### [Method 3-2]

For reporting channel state information initiated therefrom, the UE may receive a configuration of a PUCCH resource that triggers an aperiodic channel state information report, and in the case that the above-described specific event occurs in the UE, the UE may transmit a PUCCH resource that triggers an aperiodic channel state information report to the base station. In this case, the UE may receive a configuration of a PUCCH resource that triggers an aperiodic channel state information report from the base station separately from a PUCCH resource for a conventional uplink data scheduling request, and the corresponding PUCCH resource may include 1 bit of information. Further, the UE may receive a configuration of one PUCCH resource that may simultaneously request at least one combination of an aperiodic channel state information report or uplink data scheduling from the base station, and the corresponding PUCCH resource may include 2 bits of information. In the case that the corresponding PUCCH resource has information bits of “01,” the corresponding PUCCH resource may mean a conventional uplink data scheduling request, in the case that the corresponding PUCCH resource has information bits of “10,” the corresponding PUCCH resource may trigger the above-described aperiodic channel state information reporting, and in the case that the corresponding PUCCH resource has information bits of “11,” the corresponding PUCCH resource may trigger both the uplink data scheduling request and the aperiodic channel state information reporting. In the case that the base station receives the corresponding PUCCH resource having information bits of “11” from the UE, the base station may transmit single DCI to the UE to force the UE to include both PUSCH scheduling information and aperiodic channel state information reporting trigger information within the corresponding DCI. In this case, the UE may receive a configuration of a period and offset in units of a slot for one PUCCH resource that may simultaneously request a PUCCH resource that triggers the aperiodic channel state information reporting or at least one combination of aperiodic channel state information reporting or uplink data scheduling, and in the case that the specific event occurs, the UE may transmit a PUCCH resource at a closest period after a specific time offset from a time point of occurrence of the corresponding specific event. In this case, the specific time offset may be defined in units of a slot or ms, and include 0 among possible values (i.e., a specific time offset may not be required). Such a time offset may be defined through at least one combination of methods defined as a UE capability to be reported by the UE to the base station, notified by the base station through a combination of at least one of upper layer signaling, MAC-CE signaling, or L1 signaling, or fixedly defined in the standard.

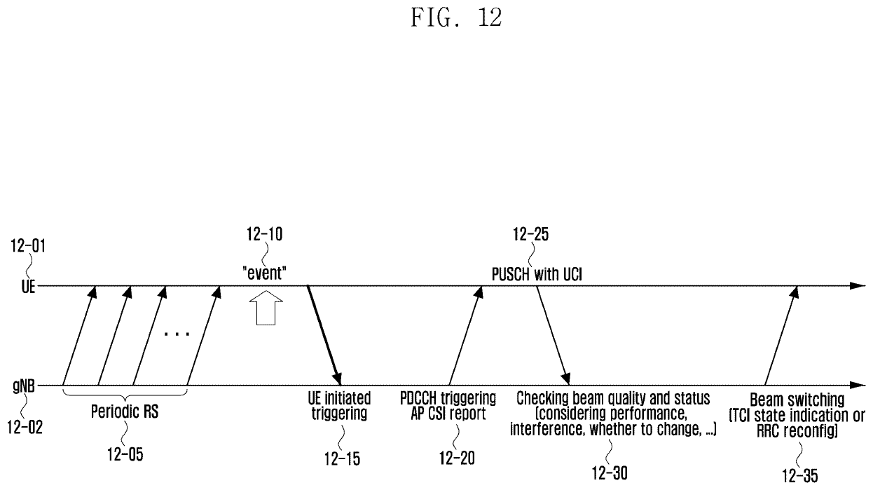

FIG. 12 illustrates an operation process of a UE and a base station for a CSI report initiated by a UE using a PUCCH resource that triggers a CSI report according to an embodiment of the disclosure.

A UE 12-01 may receive a configuration of a set of periodic channel measurement reference signals from a base station 12-02 through upper layer signaling, and periodically receive the same to measure a reception beam performance (12-05). Thereafter, in the case that a specific event occurs in the UE (12-10), the UE may transmit a PUCCH resource that triggers an aperiodic channel state information report to the base station (12-15). The corresponding PUCCH resource may be an individual PUCCH resource and a PUCCH resource for an uplink data scheduling request, as described above or may be a PUCCH resource for requesting at least one combination of an uplink data scheduling request or an aperiodic channel state information reporting request to the base station. In response thereto, the base station may transmit a PDCCH that triggers an aperiodic channel state information report to the UE (12-20), and the UE may calculate UCI according to the aperiodic channel state information reporting request in response thereto and include it in a PUSCH and transmit it to the base station (12-25). Thereafter, in the case that the base station determines that beam switching is necessary for the UE (12-30), the base station may configure or instruct this to the UE (12-35).

In the case of considering the above-described [Method 3-2], because a process of reporting channel state information initiated from the UE may be relatively long, there may be an insufficient advantage in terms of a delay time. However, as described above, because the base station may transmit aperiodic channel state information report triggering to the UE based on non-direct information, even though there is an aperiodic channel state information report method, it may not be fully utilized. Therefore, in the case that the UE first gives aperiodic channel state information report triggering in this way, there may be a clear advantage in a delay time compared to the conventional method. Further, because it is transmitted to the base station through one PUCCH resource together with the uplink data scheduling request, there may be an advantage in terms of a signaling overhead. Further, because UCI of various lengths may be transmitted from the UE to the base station through the corresponding aperiodic channel state information report, the range of information amounts exchanged between the UE and the base station may be applied to various methods from a small number of bits to a large number of bits.

### [Method 3-3]

For reporting channel state information initiated therefrom, the UE may receive a configuration of a conventional uplink data scheduling request PUCCH resource. In this case, the UE may receive uplink data scheduling DCI from the base station, and the UE may generate and transmit channel state information initiated therefrom in the form of an MAC-CE. In this case, the UE may receive a configuration of a period and offset in units of a slot for the PUCCH resource, and in the case that the specific event occurs, the UE may transmit a PUCCH resource at a closest period after a specific time offset from a time point of occurrence of the corresponding specific event. In this case, the specific time offset may be defined in units of a slot or ms, and include 0 among possible values (i.e., a specific time offset may not be required). Such a time offset may be defined through at least one combination of methods defined as a UE capability to be reported by the UE to the base station, notified by the base station through at least one combination of upper layer signaling, MAC-CE signaling, or L1 signaling, or fixedly defined in the standard.

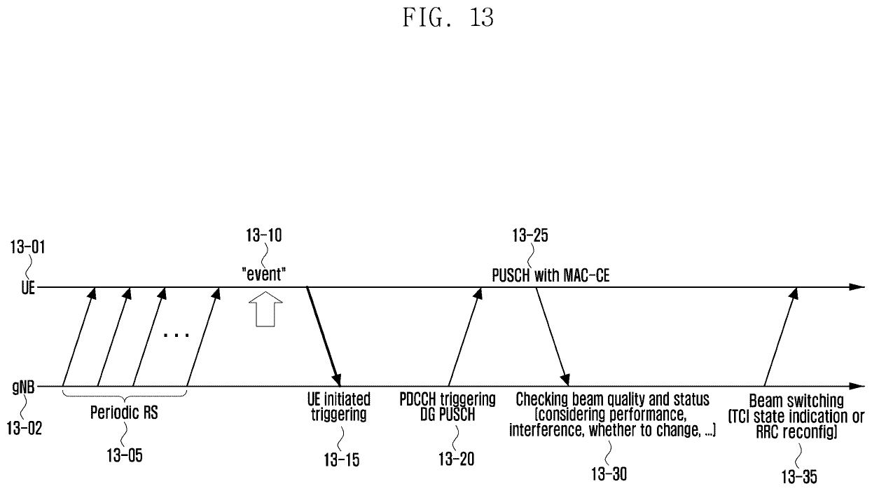

FIG. 13 illustrates an operation process of a UE and a base station for a CSI report initiated by a UE using a PUCCH resource based on a scheduling request according to an embodiment of the disclosure.

A UE 13-01 may receive a configuration of a set of periodic channel measurement reference signals from a base station 13-02 through upper layer signaling, and periodically receive the same to measure a reception beam performance (13-05). Thereafter, in the case that a specific event occurs in the UE (13-10), the UE may transmit a PUCCH resource requesting uplink data scheduling to the base station (13-15). In response thereto, the base station may transmit uplink data scheduling DCI to the UE (13-20), and the UE may transmit a PUSCH in response thereto, and include a MAC-CE that may include channel state information initiated therefrom in the corresponding PUSCH (13-25). In this case, in the case that information that may be included in the MAC-CE considers at least one combination of the above [Method 2-1] to [Method 2-5], the information may be information that may be considered in the corresponding method (e.g., in the case that the UE generates a MAC-CE based on [Method 2-1] and performs a channel state information report initiated therefrom in the base station, the UE may consider at least one combination of L1-RSRP, L1-SINR, channel measurement reference signal index, or performance difference value compared to the best reception beam performance as information to be included in the channel state information report.). Thereafter, in the case that the base station determines that beam switching is necessary for the UE (13-30), the base station may configure or instruct this to the UE (13-35).

In the case of considering the above-described [Method 3-3], because a process of reporting channel state information initiated from the UE may be relatively long, there may be an insufficient advantage in terms of a delay time. Further, because the UE uses an MAC-CE for reporting channel state information initiated therefrom, the UE may not know whether reception in the base station was successful, and because the processing for an MAC-CE may be transmitted to an upper layer of the base station, an additional delay time may occur compared to a method in which the channel state information report initiated from the UE is transmitted in the form of UCI.

### [Method 3-4]

For reporting channel state information initiated from the UE, the UE may receive a configuration of a pair of PUCCH resource and PUSCH transmission in which transmission is reserved. In this case, the UE may generate channel state information initiated therefrom in the form of UCI or MAC-CE, include the channel state information in a PUSCH, and transmit the channel state information to the base station. The UE may receive a configuration of a period and offset in units of a slot for the PUCCH resource and PUSCH transmission, and receive a configuration of PUSCH transmission-related parameters such as a time offset between the PUCCH resource and the PUCCH transmission, time and frequency resource assignment information for the PUSCH transmission, MCS (e.g., the lowest value), the number (e.g., 1) of MIMO layers, DMRS port (e.g., 0), and waveform (e.g., CP-OFDM). In another method, the UE may receive a configuration of a period and offset in units of a slot for the PUCCH resource, and receive a configuration of higher layer signaling related to the configured grant type 1 PUSCH transmission assuming PUSCH transmission based on a configured grant of a first type for PUSCH transmission, and consider a method of transmitting a PUSCH in a corresponding period only when the PUCCH resource has been transmitted before a PUSCH transmission period rather than transmitting a PUSCH in every period. Further, in the case that the specific event occurs, the UE may transmit a PUCCH resource in a closest period after a specific time offset from a time point of occurrence of the corresponding specific event. In this case, the specific time offset may be defined in units of a slot or ms, and include 0 among possible values (i.e., a specific time offset may not be required). Such a time offset may be defined through at least one combination of methods defined as a UE capability to be reported by the UE to the base station, notified by the base station through at least one combination of higher layer signaling, MAC-CE signaling, and L1 signaling, or fixedly defined in the standard.

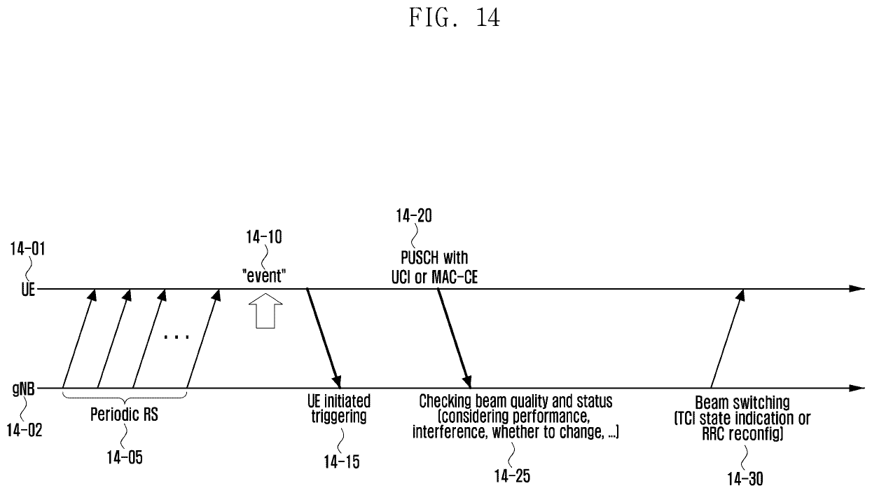

FIG. 14 illustrates an operation process of a UE and a base station for a CSI report initiated by a UE using a pair of reserved PUCCH resource and PUSCH transmission according to an embodiment of the disclosure.

A UE 14-01 may receive a configuration of a set of periodic channel measurement reference signals from a base station 14-02 through upper layer signaling, and periodically receive the same to measure a reception beam performance (14-05). Thereafter, in the case that a specific event occurs in the UE (14-10), the UE may transmit the PUCCH resource to the base station (14-15), then perform PUSCH transmission after a time offset between the PUCCH resource and PUSCH transmission configured to the UE (14-20), and include UCI or MAC-CE in the corresponding PUSCH. Thereafter, in the case that the base station determines that beam switching is necessary for the UE (14-25), the base station may configure or instruct this to the UE (14-30).

In the case of considering the above-described [Method 3-4], because a process of reporting channel state information initiated from the UE may be relatively shortened, there may be an advantage in terms of a delay time. However, the UE requires a reserved PUCCH resource and PUSCH transmission resource, and even if at least one of two channels is wrong upon blind decoding in the base station, decoding may need to be performed again.

### [Method 3-5]

The UE may receive a configuration of a reserved PUCCH resource or reserved PUSCH for reporting channel state information initiated therefrom. In this case, if the UE transmits channel state information initiated therefrom using a PUCCH resource, the UE may generate and transmit channel state information in a UCI format, and if the UE transmits channel state information based on PUSCH transmission, the UE may generate and transmit channel state information in a UCI or MAC-CE format.

In the case that the UE transmits a channel state information report initiated therefrom to the base station using a PUCCH resource, the base station may attempt blind decoding for different maximum UCI lengths for the corresponding PUCCH resource. In this case, assuming different maximum UCI lengths may be regarded as meaning that the UE responds to different events for each different maximum UCI length and reports channel state information initiated therefrom corresponding to the same, for the purpose of reporting individual information on one or more different events. In this case, the UE may receive a configuration of a period and offset in units of a slot for the corresponding PUCCH resource, and in the case that the specific event occurs, the UE may transmit a PUCCH resource at a closest period after a specific time offset from a time point of occurrence of the corresponding specific event. In this case, the specific time offset may be defined in units of a slot or ms, and include 0 among possible values (i.e., a specific time offset may not be required). Such a time offset may be defined through at least one combination of methods defined as a UE capability to be reported by the UE to the base station, notified by the base station through at least one combination of upper layer signaling, MAC-CE signaling, and L1 signaling, or fixedly defined in the standard.

In the case that the UE transmits a channel state information report initiated therefrom to the base station through PUSCH transmission, the UE may receive a configuration of upper layer signaling related to the configured grant type 1 PUSCH transmission assuming configured grant-based PUSCH transmission of the first type, and consider a method of transmitting a PUSCH in a corresponding period only in the case that the specific event occurs before a PUSCH transmission period rather than transmitting a PUSCH in every period. That is, in the case that the specific event occurs, the UE may perform PUSCH transmission in a closest period after a specific time offset from a time point of occurrence of the corresponding specific event. In this case, the specific time offset may be defined in units of a slot or ms, and include 0 among possible values (i.e., a specific time offset may not be required). Such a time offset may be defined through at least one combination of methods defined as a UE capability to be reported by the UE to the base station, notified by the base station through at least one combination of higher layer signaling, MAC-CE signaling, and L1 signaling, or fixedly defined in the standard.

For reporting channel state information initiated from the UE, the UE may be notified by the base station of one of the reserved PUCCH or reserved PUSCH transmission through at least one combination of upper layer signaling, MAC-CE signaling, and L1 signaling or may be fixedly defined in the standard.

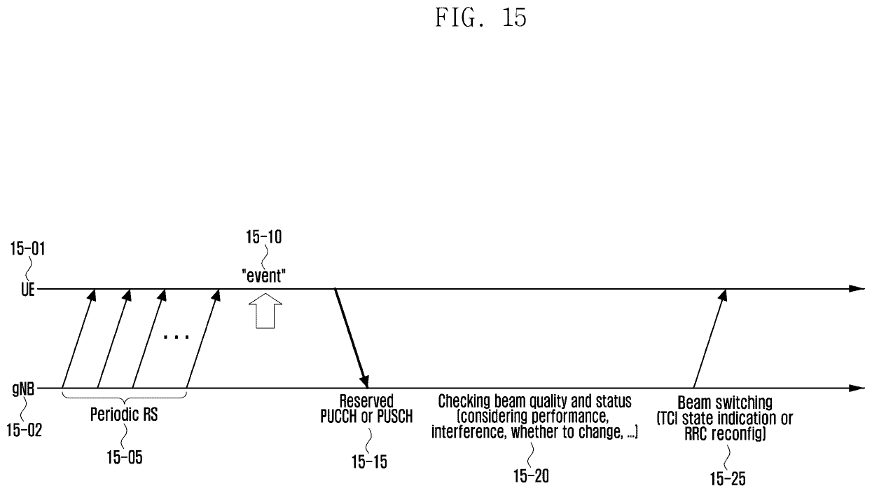

FIG. 15 illustrates an operation process of the UE and the base station for a CSI report initiated by the UE using a reserved PUCCH resource or reserved PUSCH transmission according to an embodiment of the disclosure.

A UE 15-01 may receive a configuration of a set of periodic channel measurement reference signals from a base station 15-02 through upper layer signaling, and periodically receive the same to measure a reception beam performance (15-05). Thereafter, in the case that a specific event occurs in the UE (15-10), the UE may report channel state information initiated therefrom through one of a reserved PUCCH resource or a reserved PUSCH transmission resource (15-15). Thereafter, in the case that the base station determines that beam switching is necessary for the UE (15-20), the base station may configure or instruct this to the UE (15-25).

In the case of considering the above-described [Method 3-5], because a process of reporting channel state information initiated from the UE may be relatively shortened, there may be an advantage in terms of a delay time. However, there may be a problem that the UE requires a reserved PUCCH resource or reserved PUSCH transmission resource, and in the case of a PUCCH resource, the base station requires one or more blind decoding for one PUCCH resource.

The UE may be notified by the base station of at least one combination of the above [Method 3-1] to [Method 3-5] through at least one combination of upper layer signaling, MAC-CE signaling, or L1 signaling, or may expect that at least one combination of the above [Method 3-1] to [Method 3-5] is fixedly defined in the standard. Additionally, in the case that the UE is notified by the base station of a combination of one or more specific methods through at least one combination of upper layer signaling, MAC-CE signaling, and L1 signaling, it may mean that the UE cannot support one or more specific other combinations of methods. For example, the UE may expect that for a channel state information reporting method and process initiated therefrom described above, the above [Method 3-2] is fixedly defined in the standard. As another example, the UE may be notified by the base station of the above [Method 3-1] through a combination of at least one of upper layer signaling, MAC-CE signaling, and L1 signaling, and in this case, it may be regarded that the UE has been notified by the base station that the above [Method 3-2] is not supported.

The UE may report to the base station as a UE capability as to whether it may support at least one combination of the above [Method 3-1] to [Method 3-5]. In this case, in the case that the UE reports to the base station as a UE capability that a combination of one or more specific methods may be supported, it may be regarded that the UE has reported that it cannot support one or more specific other combinations of methods. For example, the UE may report to the base station as to whether it may support the above [Method 3-1] or [Method 3-2]. As another example, the UE may report to the base station that it may support the above [Method 3-1], and such a UE capability report may mean that the UE cannot support [Method 3-2].

The above-described [Method 3-1] to [Method 3-5] considered periodic channel state information reporting as conventional channel state information reporting methods, but the UE may consider a semi-persistent channel state information reporting method and/or an aperiodic channel state information reporting method for a channel state information report initiated therefrom, and in the case of a channel measurement reference signal for this, not only a periodic reference signal but also semi-persistent and aperiodic reference signals may be considered.

For the above-described [Method 3-1] to [Method 3-5], the UE may define an arbitrary timer and perform channel state information reporting initiated therefrom according to each method and then not to perform channel state information reporting initiated therefrom during a certain time period. Thereby, frequent channel state information reporting from the UE may be prevented, and in the case of a method of requiring blind decoding in the base station, blind decoding may be prevented from being performed during a certain time.

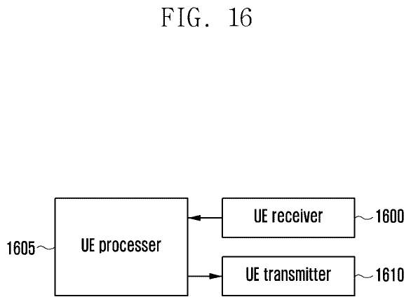

FIG. 16 illustrates a structure of a UE in a wireless communication system according to an embodiment of the disclosure.

With reference to FIG. 16, the UE may include a transceiver referring to a UE receiver 16-00 and a UE transmitter 16-10, a memory (not illustrated), and a UE processer 16-05 (or UE controller or processor). According to a communication method of the above-described UE, the UE transceivers 16-00 and 16-10, the memory, and the UE processer 16-05 may operate. However, the components of the UE are not limited to the examples described above. For example, the UE may include more or fewer components than the above-described components. Further, the transceiver, the memory, and the processor may be implemented in the form of a single chip.

The transceiver may transmit and receive a signal to and from the base station. Here, the signal may include control information and data. To this end, the transceiver may include an RF transmitter for up-converting and amplifying a frequency of a signal to be transmitted, and an RF receiver for low-noise amplifying the received signal and down-converting a frequency thereof. However, this is only an example of the transceiver, and the components of the transceiver are not limited to the RF transmitter and the RF receiver.

Further, the transceiver may receive a signal through a wireless channel, output the signal to the processor, and transmit the signal output from the processor through the wireless channel.

The memory may store programs and data necessary for an operation of the UE. Further, the memory may store control information or data included in signals transmitted and received by the UE. The memory may be composed of storage media such as a read only memory (ROM), a random an access memory (RAM), a hard disk, a compact disc-ROM (CD-ROM), and a digital versatile disc (DVD), or a combination of storage media. Further, there may be a plurality of memories.

Further, the processor may control a series of processes so that the UE may operate according to the above-described embodiment. For example, the processor may receive DCI composed of two layers and control components of the UE to simultaneously receive multiple PDSCHs. There may be a plurality of processors, and the processor may execute a program stored in the memory to perform a component control operation of the UE.

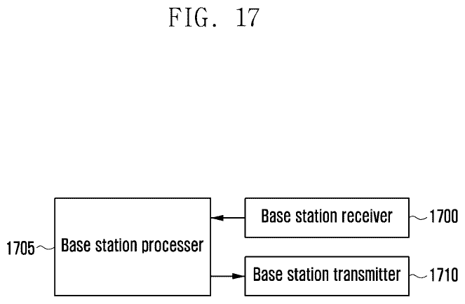

FIG. 17 illustrates a structure of a base station in a wireless communication system according to an embodiment of the disclosure.

With reference to FIG. 17, the base station may include a transceiver referring to a base station receiver 17-00 and a base station transmitter 17-10, a memory (not illustrated), and a base station processer 17-05 (or base station controller or processor). According to a communication method of the above-described base station, the base station transceivers 17-00 and 17-10, the memory, and the base station processer 17-05 may operate. However, the components of the base station are not limited to the above examples. For example, the base station may include more or fewer components than the above-described components. Further, the transceiver, the memory, and the processor may be implemented in the form of a single chip.

The transceiver may transmit and receive a signal to and from the UE. Here, the signal may include control information and data. To this end, the transceiver may include an RF transmitter for up-converting and amplifying a frequency of a signal to be transmitted, and an RF receiver for low-noise amplifying the received signal and down-converting a frequency thereof. However, this is only an example of the transceiver, and the components of the transceiver are not limited to the RF transmitter and the RF receiver.

Further, the transceiver may receive a signal through a wireless channel, output the signal to the processor, and transmit the signal output from the processor through the wireless channel.

The memory may store programs and data necessary for an operation of the base station. Further, the memory may store control information or data included in signals transmitted and received by the base station. The memory may be composed of storage media such as a ROM, a RAM, a hard disk, a CD-ROM, and a DVD, or a combination of storage media. Further, there may be multiple memories.

The processor may control a series of processes so that the base station may operate according to the above-described embodiment of the disclosure. For example, the processor may constitute two layers of DCI including allocation information on multiple PDSCHs and control each component of the base station so as to transmit them. There may be a plurality of processors, and the processor may execute a program stored in the memory to perform a component control operation of the base station.

Methods according to the embodiments described in the claims or specifications of the disclosure may be implemented in the form of hardware, software, or a combination of hardware and software.

In the case of being implemented in software, a computer readable storage medium storing one or more programs (software modules) may be provided. One or more programs stored in the computer readable storage medium are configured for execution by one or more processors in an electronic device. The one or more programs include instructions for causing an electronic device to execute methods according to embodiments described in a claim or specification of the disclosure.

Such programs (software modules, software) may be stored in a random access memory, a non-volatile memory including a flash memory, a read only memory (ROM), an electrically erasable programmable ROM (EEPROM), a magnetic disc storage device, a compact disc-ROM (CD-ROM), digital versatile discs (DVDs), any other form of optical storage device, or a magnetic cassette. Alternatively, the programs may be stored in a memory composed of a combination of some or all thereof. Further, each constitution memory may be included in the plural.

Further, the program may be stored in an attachable storage device that may access through a communication network such as the Internet, Intranet, local area network (LAN), wide LAN (WLAN), or storage area network (SAN), or a communication network composed of a combination thereof. Such a storage device may access to a device implementing an embodiment of the disclosure through an external port. Further, a separate storage device on a communication network may access to a device implementing the embodiment of the disclosure.

In the specific embodiments of the disclosure described above, elements included in the disclosure are expressed in the singular or plural according to the presented specific embodiments. However, the singular or plural expression is appropriately selected for a situation presented for convenience of description, and the disclosure is not limited to the singular or plural components, and even if a component is represented in the plural, it may be composed of the singular, or even if a component is represented in the singular, it may be composed of the plural.

Embodiments of the disclosure disclosed in this specification and drawings merely present specific examples in order to easily describe the technical contents of the disclosure and help the understanding of the disclosure, and they are not intended to limit the scope of the disclosure. That is, it will be apparent to those of ordinary skill in the art to which the disclosure pertains that other modifications based on the technical spirit of the disclosure may be implemented. Further, each of the above embodiments may be operated in combination with each other, as needed. For example, the base station and the UE may be operated by combining parts of an embodiment and another embodiment of the disclosure with each other. For example, the base station and the UE may be operated by combining parts of Embodiments 1 and 2 of the disclosure with each other. Further, although the above embodiments have been presented based on an FDD LTE system, other modifications based on the technical idea of the embodiment may be implemented in other systems such as a TDD LTE system, 5G or NR system.

In the drawings for describing the method of the disclosure, the order of description does not necessarily correspond to the order of execution, and the precedence relationship may be changed or may be executed in parallel.

Alternatively, the drawings illustrating a method of the disclosure may omit some components and include only some components within the scope that does not impair the essence of the disclosure.

Further, the method of the disclosure may be implemented in a combination of some or all of contents included in each embodiment within a range that does not impair the essence of the disclosure.

Various embodiments of the disclosure have been described above. The above description of the disclosure is for illustrative purposes, and the embodiments of the disclosure are not limited to the disclosed embodiments. A person skilled in the art to which the disclosure pertains will understand that the disclosure may be easily modified into another specific form without changing technical idea or essential features thereof. The scope of the disclosure is represented by the claims to be described later rather than the above detailed description, and all changes or modified forms derived from the meaning and scope of the claims and equivalent concepts thereof should be construed as being included in the scope of the disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a communication system, the method comprising:
transmitting, to a base station, a first uplink (UL) channel to request a resource for a second UL channel to carry a beam report;
receiving, from the base station, downlink control information (DCI) indicating the resource for the second UL channel; and
transmitting, to the base station, the second UL channel including the beam report.

2. The method of claim 1, wherein the first UL channel is transmitted based on an event occurring.

3. The method of claim 2, further comprising:
identifying a first layer-1 reference signal received power (L1-RSRP) of a first reference signal (RS) associated with a first beam, wherein the first RS is based on a reference RS of an indicated TCI state;
identifying a second L1-RSRP of a second RS associated with a second beam, wherein the second RS is based on a higher layer signaling; and
determining that the event occurs based on the second L1-RSRP being greater than or equal to the first L1-RSRP by a threshold.

4. The method of claim 1, wherein the first UL channel is a first physical uplink control channel (PUCCH), and
wherein the second UL channel is a second PUCCH or a physical uplink shared channel (PUSCH).

5. The method of claim 4, further comprising:
receiving first information of a resource for the first PUCCH and second information of a resource for a third PUCCH for scheduling request (SR); and
transmitting the first PUCCH in the resource for the first PUCCH based on the first information and the third PUCCH in the resource for the third PUCCH based on the second information.

6. A method performed by a base station in a communication system, the method comprising:
receiving, from a user equipment (UE), a first uplink (UL) channel to request a resource for a second UL channel to carry a beam report;
transmitting, to the UE, downlink control information (DCI) indicating the resource for the second UL channel; and
receiving, from the UE, the second UL channel including the beam report.

7. The method of claim 6, wherein the first UL channel is received based on an event occurring.

8. The method of claim 7, wherein the event occurs based on a second layer 1 reference signal received power (L1-RSRP) being greater than or equal to a first L1-RSRP by a threshold,
wherein the first L1-RSRP is an L1-RSRP of a first reference signal (RS) associated with a first beam, the first RS being based on a reference RS of an indicated TCI state, and
wherein the second L1-RSRP is an L1-RSRP of a second RS associated with a second beam, the second RS being based on a higher layer signaling.

9. The method of claim 6, wherein the first UL channel is a first physical uplink control channel (PUCCH), and
wherein the second UL channel is a second PUCCH or a physical uplink shared channel (PUSCH).

10. The method of claim 9, further comprising:
transmitting first information of a resource for the first PUCCH and second information of a resource for a third PUCCH for scheduling request (SR); and
receiving the first PUCCH in the resource for the first PUCCH based on the first information and the third PUCCH in the resource for the third PUCCH based on the second information.

11. A user equipment (UE) in a communication system, the UE comprising:
a transceiver; and
a controller operably coupled to the transceiver, the controller configured to:
transmit, to a base station, a first uplink (UL) channel to request a resource for a second UL channel to carry a beam report,
receive, from the base station, downlink control information (DCI) indicating the resource for the second UL channel, and
transmit, to the base station, the second UL channel including the beam report.

12. The UE of claim 11, wherein the first UL channel is transmitted based on an event occurring.

13. The UE of claim 12, wherein the controller is further configured to:
identify a first layer-1 reference signal received power (L1-RSRP) of a first reference signal (RS) associated with a first beam, wherein the first RS is based on a reference RS of an indicated TCI state;
identify a second L1-RSRP of a second RS associated with a second beam, wherein the second RS is based on a higher layer signaling; and
determine that the event occurs based on the second L1-RSRP being greater than or equal to the first L1-RSRP by a threshold.

14. The UE of claim 11, wherein the first UL channel is a first physical uplink control channel (PUCCH), and
wherein the second UL channel is a second PUCCH or a physical uplink shared channel (PUSCH).

15. The UE of claim 14, wherein the controller is further configured to:
receive first information of a resource for the first PUCCH and second information of a resource for a third PUCCH for scheduling request (SR); and
transmit the first PUCCH in the resource for the first PUCCH based on the first information and the third PUCCH in the resource for the third PUCCH based on the second information.

16. A base station in a communication system, the base station comprising:
a transceiver; and
a controller operably coupled to the transceiver, the controller configured to:
receive, from a user equipment (UE), a first uplink (UL) channel to request a resource for a second UL channel to carry a beam report,
transmit, to the UE, downlink control information (DCI) indicating the resource for the second UL channel, and
receive, from the UE, the second UL channel including the beam report.

17. The base station of claim 16, wherein the first UL channel is received based on an event occurring.

18. The base station of claim 17, wherein the event occurs based on a second layer 1 reference signal received power (L1-RSRP) being greater than or equal to a first L1-RSRP by a threshold,
wherein the first L1-RSRP is an L1-RSRP of a first reference signal (RS) associated with a first beam, the first RS being based on a reference RS of an indicated TCI state, and
wherein the second L1-RSRP is an L1-RSRP of a second RS associated with a second beam, the second RS being based on a higher layer signaling.

19. The base station of claim 16, wherein the first UL channel is a first physical uplink control channel (PUCCH), and
wherein the second UL channel is a second PUCCH or a physical uplink shared channel (PUSCH).

20. The base station of claim 19, wherein the controller is further configured to:
transmit first information of a resource for the first PUCCH and second information of a resource for a third PUCCH for scheduling request (SR); and
receive the first PUCCH in the resource for the first PUCCH based on the first information and the third PUCCH in the resource for the third PUCCH based on the second information.
